(19) United States
(12) Patent Application Publication
(10) Pub. No.: US 2008/0242560 A1
(43) Pub. Date: Oct. 2, 2008

(54) METHODS FOR GENERATING AMPLIFIED NUCLEIC ACID ARRAYS

(76) Inventors: Kevin L. GUNDERSON, Encinitas, CA (US); Frank Steemers, Encinitas, CA (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/943,554

(22) Filed: Nov. 20, 2007

Related U.S. Application Data
(60) Provisional application No. 60/860,712, filed on Nov. 21, 2006.
(60) Provisional application No. 60/861,304, filed on Nov. 27, 2006.
(60) Provisional application No. 60/878,792, filed on Jan. 5, 2007.

(51) Int. Cl. C40B 50/06

(52) U.S. Cl. 506/26

(57) ABSTRACT

The present invention relates to methods for generating an array of amplified nucleic acid sequences. The methods can utilize amplicons that form nucleic acid balls that can be arrayed on a solid support. The invention additionally provides methods for obtaining targeted nucleic acid sequences.

This application claims the benefit of priority of U.S. Provisional application Ser. Nos. 60/860,712, filed Nov. 21, 2006, 60/861,304, filed Nov. 27, 2006, and 60/878,792, filed Jan. 5, 2007, the entire contents of which are incorporated herein by reference.

### BACKGROUND OF THE INVENTION

The present invention relates generally to genomics analysis, and more specifically to methods for highthroughput genomics analysis.

The task of cataloguing human genetic variation and correlating this variation with susceptibility to disease is daunting and expensive. A single genome sequence has a price tag of approximately $10-20 million. A drastic reduction in this cost is imperative for advancing the understanding of health and disease. The near term goal in genomics analysis is to resequence the human genome at a cost 3-4 orders of magnitude less, or about $100,000 dollars. The ultimate goal is to reduce this cost to $1000 dollars per genome. A reduction in sequencing costs to less than $100,000 per genome will require a number of technical advances in the field. Fortunately, the same basic principles of readout parallelization and sample multiplexing that proved so powerful for gene expression and SNP genotyping analysis are also being successfully applied to large-scale sequencing. Technical advances required for the $100,000 genome analysis, or less, include: (1) library generation; (2) highly-parallel clonal amplification and analysis; (3) development of robust cycle sequencing biochemistry; (4) development of ultrafast imaging technology; and (5) development of algorithms for sequence assembly from short reads.

The ability to specify the content of the DNA library in a targeted manner is extremely useful for a number of applications. In particular, the ability to resequence all exons in the cancer genome would greatly facilitate the discovery of new cancer genes. The comprehensive resequencing of cancer genomes is a major objective of the Cancer Genome Atlas Project (cancergenome.nih.gov/index.asp) and would greatly benefit from a reduction in sequencing price. Given the near term objective of the $100,000 genome, it should be feasible to resequence all approximately 250,000 exons in the genome for about $1000 per sample. Unfortunately, there is no good method for creating a targeted library of the 250,000 exons from the genome. The approach of single-plex PCR for each exon is clearly cost prohibitive. As such, parallelization of the sample preparation is of paramount importance in reducing sequencing costs.

In addition to library generation, the creation of clonal amplifications in a highly-parallel manner is also essential to cost-effective sequencing. Sequencing is generally performed on clonal populations of DNA molecules traditionally prepared from plasmids grown from picking individual bacterial colonies. In the human genome project, each clone was individually picked, grown-up, and the DNA extracted or amplified out of the clone. In recent years, there have been a number of innovations to enable highly-parallelized analysis of DNA clones particularly using array-based approaches. In the simplest approach, the library can be analyzed at the single molecule level which by its very nature is clonal. The major advantage of single molecule sequencing is that cyclic sequencing can occur asynchronously since each molecule is read out individually. In contrast, analysis of clonal amplifications requires near quantitative completion of each sequencing cycle, otherwise background noise progressively grows with each ensuing cycle severely limiting read length. As such, clonal analysis places a bigger burden on the robustness of the sequencing biochemistry and may potentially limit read lengths.

Thus, there exists a need to develop methods to improve genomics analysis and provide more cost effective methods for sequence analysis. The present invention satisfies this need and provides related advantages as well.

### SUMMARY OF INVENTION

The present invention relates to methods for generating an array of amplified nucleic acid sequences. The methods can utilize amplicons that form nucleic acid balls that can be arrayed on a solid support. The invention additionally provides methods for obtaining targeted nucleic acid sequences.

### BRIEF DESCRIPTION OF THE DRAWINGS

FIG. 1 shows a schematic diagram of an exemplary method to create a DNA library. Two alternatives are shown, one with two different common primers (A and B) attached to separate ends of the nucleic acid molecule. These second alternative shows a nucleic acid molecule with a single common primer attached to one end.

FIGS. 2A-2C show different modes of circularization. FIG. 2A shows circularizing with a single stranded DNA ligase. FIG. 2B shows splint ligation of a single stranded DNA. The splint ligation allows ligation with a double stranded DNA ligase, thereby generating a single stranded circular DNA. FIG. 2C shows ligation of a double stranded DNA molecule.

FIG. 3 shows an exemplary method to generate an array of amplified nucleic acid molecules. DNA “balls” are created by rolling circle amplification (RCA). The patterned substrate can be created via wells or patterned regions of binding molecules.

FIGS. 4A-4F show an exemplary method for generation of libraries of clonal sequences on beads. FIG. 4A shows fragmentation of nucleic acid sequences such as genomic DNA. FIG. 4B shows ligation of primers A and B onto the ends of the fragmented nucleic acid sequences. FIG. 4C shows dispersal of the nucleic acid fragments with primers into oil-in-water emulsions containing beads with primers complementary to at least one of the primers attached to the nucleic acid fragments. FIG. 4D shows the results of amplification of the nucleic acids on the beads. FIG. 4E shows a bead with amplified nucleic acid sequences, which is distributed into wells on an array (image from Fan et al., Nat. Rev. Genet. 7:632-644 (2006), which is incorporated herein by reference).

FIG. 5 shows exemplary cycle sequencing formats. Sequencing by Synthesis (SBS) (left panel), and Sequencing by Ligation (SBL) (adapted from Church, “Genome for all” Scientific American January (2006).

FIG. 6 shows exemplary creation of BeadArray™s (Illumina, San Diego Calif.). Two formats for BeadArray™s are shown. FIG. 6A shows fiber bundle-based array matrix, and FIG. 6C shows microelectronic mechanical systems (MEMs) patterned slides called BeadChip™s. FIG. 6B shows assembly of bead arrays. Bead pools are randomly assembled into substrates containing 3 μm diameter wells formed through etching of optical fiber bundles or MEMS patterning of slides. Scanning electron micrographs are shown of an unassembled and an assembled array containing one bead per well. The current packing density of beads is approximately 50,000 μm².

FIG. 7 shows Arrays of DNA balls. In FIG. 7A, DNA balls are generated via rolling circle amplification (RCA) of circular targets. The average size of the DNA balls is approximately 1 μm and contains 1000-10,000 copies of the original circle (Jarvius et al., Nat. Methods 3:725-727 (2006), which is incorporated herein by reference). In FIG. 7B, a substrate patterned with an affinity reagent such as streptavidin is created through MEMs technology. The feature size of the patch of affinity reagent, for example, streptavidin, is generally kept smaller than the “diameter” of the DNA ball. FIG. 7C shows random self-assembly of DNA balls labeled with an affinity ligand, for example, biotin, onto a patterned slide. The two color clonal system is used as a model system to optimize RCA and assembly of particles onto a slide substrate.

FIG. 8 shows a model system for digital DNA balls. Three different oligonucleotides (approximately 60-90 mers) are circularized with single stranded DNA ligase such as CircLigase™ (Epicentre, Madison Wis.). Both oligos contain a universal priming site denoted by U1. The internal sequence of the green circle is different from the red circle allowing the two products to be differentiated using a two color hybridization assay using a Cy3-labeled complement to the “green” circle and a Cy5-labeled complement to the “red” circle. The third circle (grey) is designed to contain degenerate sequence to mimic complexity. This system can be used to evaluate the clonality of the process of DNA compaction into DNA balls and assembly of the DNA balls onto a patterned array.

FIG. 9 shows compaction of T4 DNA. FIG. 9A shows that a long DNA (166,000 bases, 57 μm contour length) can be compacted at elevated alcohol concentrations as seen with tert-butanol (tert-ButOH) (Mikhailenko et al., Biomacromolecules 1:597-603 (2000), which is incorporated herein by reference). Dilution of the tert-ButOH reverses the compaction DNA. FIG. 9B shows that long DNA can be compacted by exposure to spermine (SPM⁴⁺) (Baigl and Yoshikawa, Biophys. J. 88:3486-3493 (2005), which is incorporated herein by reference). The DNA is compacted into “balls” of approximately 0.7 μm diameter.

FIG. 10 shows solid-phase digital bridge PCR on beads. A bead is created with two populations of common universal primers, A and B. In a digital fashion, a target library is annealed to the beads such that the beads are in excess and, on average, only a single library element is hybridized per bead. After initial target annealing and one round of extension, the beads undergo a bridging PCR reaction as described, for example, in U.S. Pat. No. 5,641,658. The amplification grows on the solid-phase, starting with the initial seed of the library element. After bridge PCR, the 3′ terminus of the clonal amplicons can be biotinylated to aid in subsequent array-based enrichment and assembly. Alternatively, biotin can be incorporated during the bridge PCR amplification step. Only the clonal amplicon beads are biotinylated and will be assembled into patterned regions of streptavidin on the slide (Bridging PCR image from Promega).

FIG. 11 shows optimization of slide substrate for assembly of DNA balls and beads. Slides with features (patterned wells or streptavidin (SA) patterned regions) of various depth or size are tested for their ability to capture a single clonal object per feature. FIG. 11A shows capture of clonal DNA balls. FIG. 11B shows capture of clonal DNA beads.

FIG. 12 shows the flexibility of multi-sample layout using BeadChip™s (slides) (Illumina) and the modular gasketing approach. FIG. 12A shows a table of feature density using various center-to-center spacing between features (assumed to be approximately 1 μm in size). FIG. 12B shows that single sample mode allows densities of over 200 million features per slide. FIG. 12C shows that the multi-sample format allows libraries of DNA balls to be individually loaded into 12 different sections of a multi-sample slide format. FIG. 12D shows the resultant multi-sample slide after loading of DNA ball libraries. This slide can be processed through cycle sequencing as in the single sample slide.

FIG. 13 shows creation of emulsions. In FIG. 13A, homogenizing emulsions are created through shear forces. In FIG. 13B, membrane emulsions are created by extrusion of aqueous phase through a membrane into a flow of oil. This creates homogenous emulsions. FIG. 13C shows example of size homogeneity of compartments from emulsion polymerization.

FIG. 14 shows BEAMing-Up on Beads (Figure taken from Li et al., Nat. Methods 3:95-97 (2006), which is incorporated herein by reference). which is incorporated herein by reference). FIG. 14A shows a schematic of the procedure. In step 1, DNA samples are amplified by PCR. In step 2, water-in-oil emulsions are formed in which single DNA molecules within each aqueous compartment are amplified and bound to beads (brown circles). In step 3, a circularizable probe is hybridized to sequences on the beads. A 1-20 base pair gap is filled in by a polymerase and then the ends are ligated. In step 4, sequences to be queried on the beads are amplified through RCA. In step 5, fluorescently labeled dideoxynucleotide terminators (red and black circles) are used to distinguish beads containing sequences that diverge at positions of interest. In step 6, beads are analyzed by flow cytometry. FIG. 14B shows RCA on beads. RCA is performed for specific periods of time on beads produced from amplicons and the beads hybridized with a fluorescein-labeled probe and photographed using a fluorescence microscope.

FIG. 15 shows generation of uniform insert libraries and circularization. FIG. 15A shows generation of EcoP15I libraries with a 27 base insert. FIG. 15B shows circularization of library elements.

FIG. 16 shows hybridization-extension capture enrichment of target loci. DNA is fragmented and rendered single stranded (ssDNA). The 3′ termini can be blocked during fragmentation by DNAseII, depurination-fragmentation, or 3′ incorporation of ddNTPs with terminal deoxynucleotide terminal (TdT) transferase. Capture probes are annealed to the ssDNA, excess primers removed, primer extended with biotin nucleotides, purified, and pulled-down on streptavidin beads. The enriched strands are eluted off with heat or alkaline treatment.

FIG. 17 shows locus-specific cleavage and amplification. FIG. 17A shows that locus-specific restriction sites can be created by engineering a TypeIIS restriction enzyme consensus sequence into a hairpin region of a locus-specific oligonucleotide as described, for example, by Szybalski, Gene 40:169-73 (1985). FIG. 17B shows that, using this approach, a selected region of the genome can be excised, circularized with a single stranded DNA ligase such as CircLigase™, and amplified with Phi29 multiple displacement amplification (MDA) to generate DNA greatly enriched in the regions of interest. Standard libraries can be made from this enriched fraction.

FIG. 18 shows targeted amplification with locus-specific hyperbranched RCA (hRCA). DNA such as genomic DNA (gDNA) is randomly fragmented to a desired size of a few hundred bases. The DNA is denatured and circularized with a single stranded DNA ligase such as CircLigase™. These circles are amplified using a locus specific hyperbranched RCA reaction. The design of the forward and reverse primers is similar to that of PCR.

FIG. 19 shows random-primer and locus-specific labeling of DNA with universal sequences. FIG. 19A shows random-primed labeling (RPL) of gDNA. gDNA is labeled using a standard RPL protocol employing random N-mers (N=6-18) with universal priming tail (U1 sequence) and biotin label. FIG. 19B shows locus-specific primer extension on immobilized RPL product. The biotinylated RPL product is immobilized on a streptavidin solid-phase surface, and locus-specific primers (L1, L2, L3, etc) containing a second universal tail (U2) are annealed to the product. A washing step removes mis-annealed and excess primers. Primer extension extends the annealed primers through the U1 primer site creating a product with two universal tails that can be amplified by universal PCR. After extension, the product is eluted and spiked into a universal PCR reaction containing U1 and U2 primers.

FIG. 20 shows generation of a multiplex emulsion PCR reaction. In FIG. 20A, primer pairs are individually emulsified and mixed into a final grand emulsion. Under appropriate emulsification conditions, the compartments are stable and remain distinct, supporting highly-parallel single-plex PCR reactions. The gDNA is immobilized to beads and introduced into the “water-in-oil” emulsion and gently emulsified, distributing the beads into the individual emulsification compartments. As shown in FIG. 20B, a number of different methods exist for introducing reagents or modulating the composition of the aqueous compartments of an emulsification as described by Miller, et al. Nat. Methods 3:561-570 (2006). The methods include (1) temperature, (2) solubilization of substrate in oil phase and partitioning into aqueous phase, (3) fusion of nano-droplets to aqueous compartments, (4) modulation of pH through delivery of acetic acid, (5) photo-caged substrates premixed in aqueous compartments can be released by UV light.

FIG. 21 shows encapsulated primer pairs and emulsion PCR. Primer pairs are individually immobilized or encapsulated in/on separate beads or compartments. These beads/capsules are co-emulsified with target DNA (gDNA) in an emulsion PCR mix. The primers are released from the beads, or the capsules containing the primer pairs are dissolved in the emulsion. This approach effectively minimizes the number of primer pairs contained in any one aqueous emulsion compartment.

FIG. 22 shows targeted amplification using Bridge PCR. In FIG. 22A, primer pairs are separately immobilized to beads and later pooled. The beads are hybridized with fragmented denatured gDNA which are inoculated into a PCR reaction. As shown in FIG. 22B, solid-phase PCR amplifies a specific DNA locus on the bead surface according to the primer pair present.

FIG. 23 shows padlock probe enrichment of targeted regions (exons). An oligonucleotide probe is designed to anneal 5′ and 3′ of a region of interest, for example, an exon. A universal priming sequence (AB) separates the two locus-specific priming sites. Extension across the regions of interest (such as exonic regions) and ligation creates a circular product. This circular product can than be amplified using the common primer by RCA, hyperbranched RCA, PCR, and the like.

FIG. 24 shows generation of a mini-library. In FIG. 24A, a sequencing ladder using reversible terminators is generated by priming from a universal site on a library element. After generation of the ladder, the termination is reversed. In FIG. 24B, Mung bean or S1 nuclease is used to digest the ssDNA from the original library element. The resultant product is polished and ligated to the A adapter containing an EcoP15I site (or other type of IIS or III site). In FIG. 24C, EcoP15I digestion is used to create sequencing-sized inserts of 27 bases. In FIG. 24D, the mini-library is completed by ligation of the B adapter.

FIG. 25 shows clonal arrays of DNA balls. In FIG. 25A, high molecular weight RCA DNA with hybridized Cy3 detector probes was collapsed to submicron point objects (“balls”) by incubation with 12 mM spermidine in 100 mM HEPES buffer, pH 8.0. Biotin was incorporated into the DNA balls during the RCA step. In FIG. 25B, these biotinylated DNA balls were assembled onto BeadChip™s pre-loaded with streptavidin beads.

FIG. 26 shows design of solid phase bridge PCR beads. In FIG. 26A, two locus-specific PCR primers containing concatenated universal priming sequences are immobilized on “PCR” beads. A cleavable linker is created using a standard cleavage chemistry (disulfide, photocleavable group etc.), using a peptide cleaved by a specific protease or using restriction enzymes. In FIG. 26B, after an initial overnight hybridization of gDNA target to the PCR beads, the beads are washed and undergo a solid-phase PCR reaction as shown. FIG. 26C shows sequences used for the test system. Restriction enzyme sites for PstI and MfeI were incorporated into the upstream and downstream primers, respectively. As shown in FIG. 26D, the beads can be treated with a cleaving reagent that allows either strand to be retained on the bead or released into solution. Cleavage with restriction enzyme 1 (RE1) or protease I leaves one strand attached to the bead, and cleavage with restriction enzyme 2 (RE2) or protease 2 leaves the opposite strand attached to the bead. This process allows sequencing of either strand.

FIG. 27 shows a schematic of selector amplification and emulsion amplification. In FIG. 27A, genomic DNA is annealed to selector probes in solution or immobilized on streptavidin (SA) beads. If in solution, the selector probes are subsequently immobilized on SA beads. After annealing, overhanging gDNA annealed to selector probe is trimmed with a single-stranded nuclease. In FIG. 27B, the gDNA target is extended and ligated to form a gDNA circle. In FIG. 27C, the circularized gDNA is eluted from the immobilized selector probe. The eluted circular DNAs are emulsion amplified by whole genome amplification (WGA) (FIG. 27D) or PCR. (FIG. 27E).

FIG. 28 is a schematic showing the generation of a template primed for sequencing.

FIG. 29 shows three approaches to high-resolution microarray scanning.

FIG. 30 shows a schematic diagram of rolling circle amplification using a guide linker. The guide linker contains A's on the 5′ end and G's on the 3′ end that can hybridize to full length cDNA having a poly T tail at the 5′ end and a string of 3 or more C's at the 3′ end. The guide linker hybridizes to full length cDNA and circularizes the cDNA. A covalently closed circle is formed by ligation of the circularized cDNA using a splint ligation reaction. Rolling circle amplification (RCA) can be used to amplify the circularized cDNA using the guide linker as a primer.

FIG. 31 shows a solution-phase hybridization-extension enrichment technique that can be used for targeted enrichment.

FIG. 32 shows results of the solution-phase hybridization-extension enrichment technique described in Example V.

### DETAILED DESCRIPTION OF THE INVENTION

The present invention provides methods for generating an array of amplified nucleic acid sequences that can be used more efficiently for sequence analysis. The methods are based on clonally amplifying nucleic acid sequences, such as genomic sequences or other nucleic acids of interest, such that the amplified sequences can be conveniently used for sequence analysis. The present invention relates to methods to create arrays of clonal features on an array. Clonal arrays are important for the digital characterization of the clonal molecules such as in highly-parallel sequencing applications.

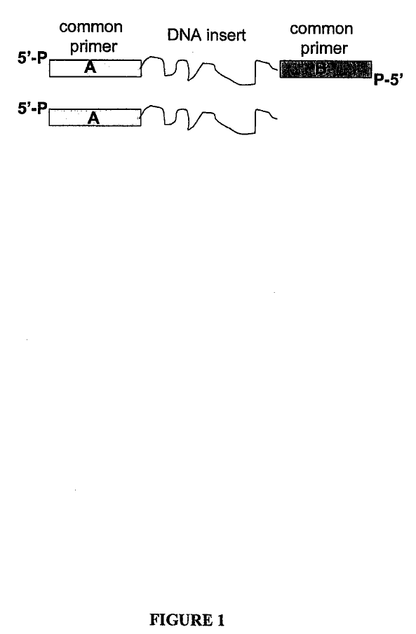

The methods of the invention can utilize the following steps. One step is to create a library of nucleic acid sequences, such as a DNA library, containing a common universal primer sequence. A common primer sequence can be introduced into genomic DNA by various methods, as appreciated by one skilled in the art and as disclosed herein in more detail. These include ligation using DNA or RNA ligase, randomly-primed polymerase extension, specifically-primed polymerase extension, and other such methods. For example, ligation can be carried out such that a nucleic acid having the primer sequence is added to the end of a genomic DNA using a ligase, or polymerase extension can be carried out such that a sequence added to the end the genomic DNA contains the primer sequence. The resultant product is a nucleic acid sequence, generally a DNA sequence, either double or single stranded, flanked by one or two common primers (see FIG. 1).

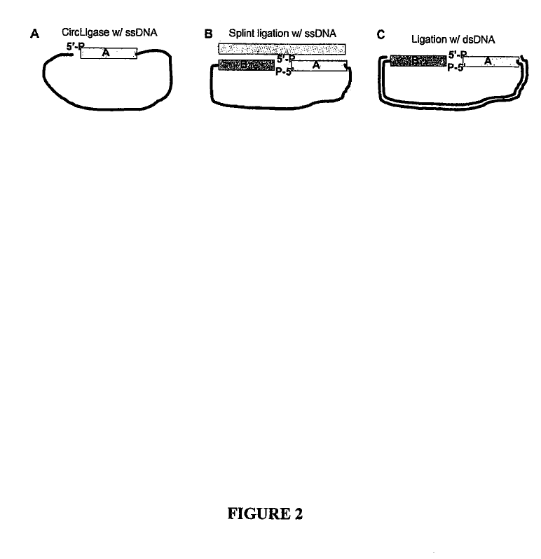

A second step can utilize circularization of the library members with an appropriate ligase, including single stranded or double stranded ligases. Once one or two common primers are added to the nucleic acid sequence, the sequence is circularized using either a single strand circular ligase or using a standard double strand DNA ligase, which can also be used to ligate a splint sequence overlapping the common primers (see FIG. 2).

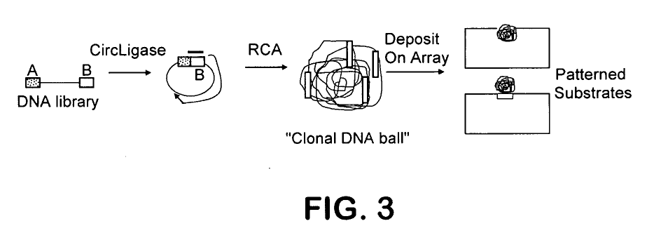

A third step can utilize rolling circle amplification (RCA) using a common primer. RCA can be used to amplify from a circle using a common primer. Standard methods of RCA are known in the art such as using Phi29 DNA polymerase (Shendure et al., Nature Rev. 5:335-344 (2004); Baner et al., Nucl. Acids Res. 26:5073-5078 (1998) and Furuqi et al., BMC Genomics 2:4 (2001), each of which is incorporated herein by reference). Other useful methods are described, for example, in U.S. Pat. No. 6,355,431, which is incorporated herein by reference. The product of amplification is a long tandem concatemer of circle sequence complements. This long sequence will collapse into a random coil configuration forming essentially a DNA ball when placed in a high salt buffer. These clonal DNA balls can then be manipulated and analyzed using a number of technology formats, as disclosed herein (see FIG. 3).

A fourth step can utilize arraying clonal DNA balls onto a surface. These DNA balls can be arrayed by assembly onto a patterned surface using a number of different approaches. In the first approach, the DNA balls can be randomly assembled into a patterned substrate such as a substrate used in the manufacture of a BeadChip™ (Illumina, San Diego Calif.). In a particular embodiment, the dimension of a well on an array substrate can be designed to match the dimension of the DNA ball to limit assembly to one DNA ball per well. Alternatively, an affinity agent such as a binding hapten, for example, biotin, can be incorporated into the DNA ball during RCA. An array can be patterned with a binding agent to the affinity agent, for example, streptavidin for binding to biotin, such that DNA balls are individually immobilized and isolated to defined regions of the array substrate. One simple method of patterning the substrate with binding reagents is to load an array such as a BeadChip™ with beads immobilized with the particular binding agent. For instance, in a particular embodiment, approximately 1 μm beads, for example having bound streptavidin, can be assembled onto an array such as a BeadChip™ having approximately 1 μm wells, thereby sterically limiting an assembly site to a single DNA ball. The beads such as streptavidin beads are optimally spaced to allow maximum information content per unit area. Thus, by matching the size of the bead or well to the size of the DNA ball, or perhaps making the bead or well slightly smaller, a single DNA ball can be made to assemble at each feature of the array.

There are a number of immediate applications envisioned for methods of the invention, including highly-parallel DNA sequencing methods used on “clonal” or “polony” arrays, detection of rare variants in a wildtype background, microbial pathogen detection, and the like. The methods of the invention using the approach utilizing “DNA balls” has many advantages over polony or emulsion PCR approaches. Advantages include simple clonal amplification, no enrichment needed, and avoiding having to use a limiting titration of a DNA library in the amplification reaction. Thus, it is an object of the invention to replace clonal arrays or polony arrays with an array of DNA balls in a highly parallel DNA sequencing method or other genetic analysis method.

In one embodiment, the invention provides a method for generating an array of amplified sample nucleic acid sequences. The method can include the steps of attaching at least one common primer comprising a first common priming site to a plurality of sample nucleic acid molecules; circularizing the sample nucleic acid molecules to generate a plurality of circularized nucleic acid molecules comprising one sample nucleic acid molecule of the plurality of sample nucleic acid molecules and the at least one common primer; amplifying the circularized nucleic acid molecules to generate amplicons, wherein each of the amplicons comprises multiple copies of a circularized nucleic acid molecule in the plurality of circularized nucleic acid nucleic acid molecules; and distributing the amplicons on an array, thereby generating an array of amplified sample nucleic acid sequences.

As used herein, “sample nucleic acid sequences” refer to nucleic acid sequences obtained from a sample that are desired to be analyzed. A nucleic acid sample that is amplified, sequenced or otherwise manipulated in a method disclosed herein can be, for example, DNA or RNA. Exemplary DNA species include, but are not limited to, genomic DNA (gDNA), mitochondrial DNA, and copy DNA (cDNA). One non-limiting example of a subset of genomic DNA is one particular chromosome or one region of a particular chromosome. Exemplary RNA species include, without limitation, messenger RNA (mRNA), transfer RNA (tRNA), or ribosomal RNA (rRNA). Further species of DNA or RNA include fragments or portions of the species listed above or amplified products derived from these species, fragments thereof or portions thereof. The methods described herein are applicable to the above species encompassing all or part of the complement present in a cell. For example, using methods described herein the sequence of a substantially complete genome can be determined or the sequence of a substantially complete targeted nucleic acid sequences such as mRNA or cDNA complement of a cell can be determined.

As used herein, a “common primer” refers to a primer that can be attached, for example, by ligation or other methods disclosed herein, to a nucleic acid sequence, particularly in a population of nucleic acid molecules, such that the same primer is attached to a plurality of different nucleic acid molecules. As used herein, a “plurality” refers to two or more. Such a primer is therefore “common” to the many different nucleic acid molecules to which it is attached. Such a common primer is particularly useful for analyzing multiple samples simultaneously, as disclosed herein. A common primer contains a “common priming site” to which an appropriate primer can bind to and which can be utilized as a priming site for synthesis of nucleic acid sequences complementary to the nucleic acid sequence attached to the common primer.

As used herein, “circularizing” or “circulized,” or grammatical variations thereof, when used in reference to a nucleic acid molecule, refers to the generation of a covalently closed circle of the nucleic acid molecule, with no free 5′ or 3′ end. Generally, circularization is accomplished by an intramolecular linking of the 5′ and 3′ ends of a nucleic acid molecule, for example, using a single stranded or double stranded ligase, depending on whether the nucleic acid molecule is single stranded or double stranded. Although this is generally accomplished by an intramolecular phosphodiester bond, it is understood that other methods of generating a covalently closed circle can be used, for example, using nucleic acid hybrids such as DNA/RNA hybrids that are linked, optionally through a phosphodiester bond between the two types of molecules, covalent linking of modified nucleotides on one or both ends of a nucleic acid molecule, the use of peptide nucleic acid (PNA) in which the linkage occurs through a peptide bond or covalent crosslinking of a peptide to a nucleic acid molecule. Although generally performed using an enzymatic reaction such as a ligase, it is understood that chemical ligation or crosslinking of appropriately modified ends of a nucleic acid molecule can also be used. Preferably, the product of a chemical ligation or crosslinking of a sample nucleic acid is capable of serving as a template for rolling circle amplification to create a concatamer amplicon containing multiple copies of the sample nucleic acid sequence. Any of the above and other methods for generating a covalently closed circular nucleic acid molecule can be used so long as the 5′ and 3′ ends are not free and so that subsequent desired reactions, such as rolling circle amplification, can be carried out with the circularized nucleic acid molecule.

As used herein, an “amplicon” refers to a nucleic acid that has been synthesized using an amplification technique. Thus, an amplicon is the nucleic acid product of an amplification reaction.

In general, the circularized nucleic acids comprise a length in the range of 30 to 2000 nucleotides. The size length of the sample nucleic acid molecule can be varied, as desired, for a particular application. Generally, for a sequencing reaction, the length of the template region to be sequenced corresponds to the read length of the sequencing method used. For example, if the sequencing method can read no more than about 100 bases per fragment, then the sample nucleic molecules can be designed to fall in a range of about 100 or fewer bases. The template region can be slightly longer than the sequencing read length if desired, for example, no more than about 5% or 10% of the sequencing read length. One skilled in the art can use a variety of well known methods to generate sample nucleic acid molecules of a desired size, as disclosed herein.

A method for generating an array of amplified nucleic acid sequences can further include the step of attaching at least one second common primer comprising a second common priming site to the plurality of sample nucleic acid molecules, thereby attaching a first common primer and a second common primer to a sample nucleic acid molecule of the plurality of sample nucleic acid molecules. In a particular embodiment, the first common primer and the second common primer can be attached to respective ends of each nucleic acid in the plurality of sample nucleic acid molecules by ligation.

In embodiments that include ligation of a first double stranded nucleic acid end to a second double stranded nucleic acid end, the ends to be ligated can be blunt or can have complementary single stranded overhangs. The use of complementary overhangs generally provides an added measure of specificity over blunt end methods because conditions can be used in which non-complementary sequences will not ligate. Further specificity can be attained by partially filling in one overhang end to make it complementary to another end. This fill in method can be used to disfavor unwanted ligation between nucleic acids in a sample that were generated with the same restriction enzyme.

An amplicon typically contains multiple copies of the circularized nucleic acid molecule of the corresponding sample nucleic acid. That is, each amplicon contains multiple copies of a single sample nucleic acid molecule, which was circularized. The number of copies can be varied by appropriate modification of the amplification reaction including, for example, varying the number of amplification cycles run, using polymerases of varying processivity in the amplification reaction and/or varying the length of time that the amplification reaction is run, as well as modification of other conditions known in the art to influence amplification yield. Generally, the number of copies of a nucleic acid in an amplicon is at least 100, 200, 500, 1000, 2000, 3000, 4000, 5000, 6000, 7000, 8000, 9000 and 10,000 copies, and can be varied depending on the particular application. As disclosed herein, one particular form of an amplicon is as a nucleic acid “ball” having desired dimensions. The number of copies of the nucleic acid molecule can therefore provide a desired size of a nucleic acid “ball” or a sufficient number of copies for efficient subsequent analysis of the amplicon, for example, sequencing.

As disclosed herein, a variety of methods can be used to circularize a nucleic acid molecule. A particularly useful method is to enzymatically circularize the nucleic acid molecule, for example, using a ligase. Exemplary ligases include a single stranded DNA ligase, such as CircLigase™ (Epicentre), a double stranded DNA ligase and an RNA ligase, which can be selected based on the type of nucleic acid molecule to be circularized, for example, single or double stranded DNA or RNA. A splint ligation reaction to circularize the sample nucleic acid molecules can also be used (see FIG. 1).

In a particularly useful embodiment, amplicons are generated by rolling circle amplification (RCA), which can be used to generate amplicons having multiple copies of a nucleic acid sequence and which can be used to create nucleic acid “balls,” as disclosed herein. It will be understood that these “balls” need not be perfectly spherical and can include other globular or packed conformations. In a particular embodiment, RCA is primed using the at least one common primer attached to the sample nucleic acid molecule.

As disclosed herein, the amplicons can be compacted prior to distribution on a substrate, such as an array. Methods of compacting amplicons are known in the art (for example, as described by Bloomfield, Curr. Opin. Struct. Biol. 6(3): 334-41 (1996)) and disclosed herein. For example, an alcohol or polyamine such as spermine or spermidine can be used. A compacted nucleic acid will have a structure that is more densely packed than the structure of the nucleic acid in the absence of a compacting agent or compacting condition and the structure will typically resemble a ball or globule. The generation of such compacted nucleic acid balls are useful for distribution at discrete locations on an array, as discussed herein in more detail. Various methods can be used to generate balls of a desired size, for example, using various compacting techniques and/or varying the number of copies in an amplicon. Generally, the compacted amplicons have an average diameter or width ranging from about 0.1 μm to about 5 μm, for example, about 0.1 μm, about 0.2 μm, about 0.5 μm, about 1 μm, 2 μm, about 3 μm, about 4 μm and about 5 μm.

If desired, the amplicons can be opened after distribution on the array. As used herein, an amplicon or DNA ball that is “opened” is one that has been treated to allow access of reagents for subsequent reactions. For example, the methods of the invention can be particularly useful for parallel sequence analysis of multiple nucleic acid molecules distributed on an array. In such a case, the amplicons distributed on the array need to be accessible to reagents such as primers, nucleotides, buffers and enzymes such as polymerases or ligases as used in a particular sequencing method, so that a sequencing reaction can be carried out. Thus, a compacted amplicon that is inaccessible or partially accessible due to being in the form of a DNA ball or other compacted structure can be rendered more accessible by “opening” the compacted amplicon. Methods for “opening” nucleic acid molecules are well known, as disclosed herein, and include removal of compacting agents. Such an “opening” of an amplicon is analogous to, although not limited to the same mechanism as, the melting of regions of chromatin for expression of a particular region of a chromosome. It is understood that such methods of “opening” a compacted nucleic acid molecule need not result in a detectably different size of the compacted amplicon, only that the amplicon be rendered more accessible to reagents for a subsequent reaction.

The methods of the invention can utilize an array having a plurality of discrete binding sites for the amplicons. As disclosed herein, various types of a patterned substrate or beads can be used to capture an amplicon, particularly a nucleic acid ball. These include the patterning of an affinity reagent on a slide surface, the patterning of microwells on a slide surface (as with BeadChip™s, Illumina), the patterning of a slide surface with microwells containing an affinity ligand coating the interior of the well, and the like.

Affinity binding of a nucleic acid ball on an array can be used advantageously to improve the efficiency and utilization of a given sized array. For example, clonal nucleic acid balls or amplified nucleic acid molecules on beads can be directly enriched during assembly on the patterned array such as a slide. Typically, the product of an emulsion PCR or Bridge PCR reaction includes a majority of blank beads (no clonal nucleic acid molecule attached) and a minority of clonal beads. An array can be formed by attaching the product to a substrate such that the beads, both blank and clonal, are distributed on the substrate. Blank beads waste space on the array, and their removal would create more efficient use of limited array space. The beads with amplified nucleic acid molecules can either be enriched for in a separate step prior to assembly on the array, or they can be enriched during assembly on the array. Enrichment can be accomplished by differentially labeling the clonal beads versus the blank beads with an affinity ligand, such as biotin. For example, nucleotides having an affinity ligand can be included in an amplification reaction such that the ligand is incorporated into amplicons, allowing selection of those beads or amplicons that have incorporated the affinity ligand, thereby excluding, for example, a “blank” bead where no amplicons are present. If an array substrate having a streptavidin coated surface is used and biotinylated nucleotides are used in the amplification reaction then only the biotinylated beads will adhere to the affinity regions on the array, effectively enriching for clonal beads. This labeling can be accomplished in a number of ways, but a straightforward approach is to label the 3′ terminus of the clone on the bead by hybridizing a universal complement to the 3′ end of the clone and extending with a biotinylated nucleotide. Alternatively, a biotinylated adapter can be ligated to the 3′ end of the clone.

In a method of the invention, a discrete site of an array can be configured to retain no more than a single amplicon. Such a configuration can include size limitations of a well on a substrate that is sufficient to accommodate a particular sized amplicon such as a nucleic acid ball but too small to accommodate more than one nucleic acid ball. Additionally or alternatively, a configuration can be used that provides limited access to an affinity ligand at a discrete site on an array. By having discrete binding sites, particularly using affinity binding sites, as disclosed herein, more efficient use and a higher density of amplicons can be distributed on the array. For example, the density on the array can range from about 10,000 to about 4,000,000 amplicons per square mm, for example, 10,000, 40,000, 100,000, 250,000, 1,000,000, and 4,000,000 amplicons per square mm. It is understood that lower density or higher density distribution of amplicons on an array can be used so long as the density is useful for a particular application of the method.

In particular embodiments, discrete sites can be present on an array surface in a regular pattern. As a result, amplicons will generally be attached to the array surface at expected locations and intervals. In contrast, attachment of amplicons to a uniform surface, lacking discrete sites, will typically result in a surface in which amplicons are attached at irregular intervals. A fraction of the irregularly spaced amplicons will reside too close to each other to be distinguished when the surface of the array is scanned or detected. Features that are too close to distinguish may cause detection errors if signals from the two sites are not recognized as having separate origins. Even if the overlap in signals is recognized it may not be possible to separate the signals in which case the features will have to be ignored despite occupying valuable space on the array. Furthermore, an array of features that occur at expected intervals will typically be easier to scan or detect than an array having irregularly spaced features due to the ability to reference a predictable pattern during image registration and analysis processes.

Thus, the arrays can be configured such that a single amplicon is distributed at a discrete binding site of the plurality of discrete binding sites on the array. The amplicons can further comprise an affinity ligand, which can be used to bind to a discrete binding site on an array, as discussed above and disclosed herein. Such amplicons can thus be bound to the array using the affinity ligand on the amplicon. A particularly useful affinity ligand is biotin, and a useful discrete binding site on the array can be streptavidin.

Alternatively, a discrete binding site on an array can be a nucleic acid sequence complementary to at least one of the common primers attached to the amplicon. In such a case, the amplicons can be attached to the array by hybridization of the at least one common primer to the complementary nucleic acid sequence on the array. It can be particularly useful to covalently crosslink the hybridized sequences so that subsequent steps that include denaturation of double stranded nucleic acid molecules can be used while still retaining the amplicons attached to the surface. A variety of crosslinking methods can be used so long as the crosslinking does not inhibit subsequent desired reactions with the attached nucleic acid molecules, for example, sequencing. A particularly useful method of crosslinking utilizes psoralen crosslinking between thymidine residues in an AT base pair located in the hybrid.

The methods for generating an array of amplified sample nucleic acid sequences is particularly useful for sequencing, particularly for parallel sequencing of multiple sample nucleic acid molecules. Thus, such a method can further include the step of sequencing one or more amplicons distributed on an array. The invention therefore provides a method for sequencing a sample nucleic acid sequence. The method can include the steps of attaching at least one common primer comprising a first common priming site to a plurality of sample nucleic acid molecules; circularizing the sample nucleic acid molecules to generate a plurality of circularized nucleic acid molecules comprising one sample nucleic acid molecule of the plurality of sample nucleic acid molecules and the at least one common primer; amplifying the circularized nucleic acid molecules to generate amplicons, wherein each of the amplicons comprises multiple copies of a circularized nucleic acid molecule in the plurality of circularized nucleic acid molecules; and distributing the amplicons on an array, thereby generating an array of amplified sample nucleic acid sequences; and sequencing one or more amplicons distributed on the array. Any of a variety of sequencing methods can be used, as disclosed herein, including, but not limited to sequencing by synthesis (SBS), sequencing by ligation, sequencing by hybridization, pyrosequencing and the like.

The invention also provides various methods for obtaining a targeted nucleic acid sequence. The invention thus provides a method for targeting a nucleic acid molecule or obtaining a targeted sample nucleic acid molecule. Such methods include, but are not limited to, obtaining a targeted nucleic acid molecule using hybridization-extension capture enrichment; using targeted restriction sites, for example, using a Type IIS restriction enzyme site such as a FokI restriction enzyme site; using locus-specific hyperbranched rolling circle amplification; using random-locus-specific primer amplification; using multiplex emulsion PCR; using multiplex bridge PCR; using padlock probe amplification; and using mini-libraries from targeted libraries, as disclosed herein. In particular embodiment, the invention provides methods of obtaining targeted nucleic acids using whole genome targeted representation, solid-phase bridge PCR, Type IIS restriction enzyme targeted digestion, selector probes, or solid phase amplification, which can further include direct sequencing on beads (see Example III).

The methods of obtaining targeted nucleic acid molecules can be advantageously combined with other methods disclosed herein to generate an array of amplified nucleic acid sequences to efficiently analyze a desired sub set of nucleic acid sequences in a larger set, such as a portion of the sequences present in a genomic DNA from a particular organism or individual. Thus, in another embodiment, the invention provides a method for generating an array of amplified targeted nucleic acid sequences. The method can include the steps of attaching at least one common primer comprising a first common priming site to a plurality of targeted nucleic acid molecules; circularizing the targeted nucleic acid molecules to generate a plurality of circularized nucleic acid molecules comprising one targeted nucleic acid molecule of the plurality of targeted nucleic acid molecules and the at least one common primer; amplifying the circularized nucleic acid molecules to generate amplicons, wherein each of the amplicons comprises multiple copies of a circularized nucleic acid molecule in the plurality of circularized nucleic acid molecules; and distributing the amplicons on an array, thereby generating an array of amplified targeted nucleic acid sequences.

Any of a variety of desired target nucleic acid sequences can be utilized, including but not limited to exons, or nucleic acid sequences complementary thereto; cDNA sequences, or nucleic acid sequences complementary thereto; untranslated regions (UTRs) or nucleic acids complementary thereto; promoter and/or enhancer regions, or nucleic acid sequences complementary thereto; evolutionary conserved regions (ECRs), or nucleic acid sequences complementary thereto; transcribed genomic regions, or nucleic acid sequences complementary thereto. About 5% of the genome is evolutionarily conserved and ˜1.5% of this is in genes including exons and promoter regions, the function of the remaining 3.5% conserved regions is unknown but probably plays a role in gene regulation. Any of a variety of methods can be used to obtain targeted nucleic acid sequences, as disclosed herein. Such methods include, but are not limited to, obtaining a targeted nucleic acid molecule using hybridization-extension capture enrichment; using targeted restriction sites, for example, using an oligonucleotide engineered with a hairpin having a Type IIS restriction enzyme site such as a FokI restriction enzyme site and a locus-specific region; using locus-specific hyperbranched rolling circle amplification; using random-locus-specific primer amplification; using multiplex emulsion PCR; using multiplex bridge PCR; using padlock probe amplification; and using mini-libraries from targeted libraries, as disclosed herein.

Such a method of generating an array of targeted nucleic acid sequences can further include sequencing the amplicons containing targeted nucleic acid sequences. The invention thus provides a method of sequencing a targeted nucleic acid molecule, as disclosed herein.

The methods of the invention can be used for a scalable array-based, highly-parallel DNA sequencing platform. There are three major bottlenecks in highly-parallel sequencing platforms. These bottlenecks include (1) generation of targeted sequencing libraries, for example, the ability to sequence all approximately 250,000 human exons rather than entire genome; (2) non-optimal feature packing on the array due to the nature of constructing clonal arrays; and (3) limited read lengths due to inefficient incorporation and extension from modified nucleotides. Great cost savings ($1000 vs. $100,000) can be achieved if the most highly-informative 1% of the human genome, for example, exons, promoters, conserved regions, and the like, is resequenced in a targeted fashion rather than the entire genome. Further reductions in cost can be achieved by maximizing the number of features per unit area on an array. The present invention relates to optimally packed clonal arrays, which are assembled using clonal DNA balls, the product of rolling circle amplification, onto a patterned array such as a slide surface. In addition to packing optimization, the simplicity of generating DNA balls greatly improves upon the current methods of generating clonal features.

A major bottleneck in array-based sequencing is the number of images that need to be collected. Optimal information packing can be achieved with clones regularly spaced with a minimum of “dark space”. The invention relates to the development of ordered clonal arrays of DNA balls generated by rolling circle amplification. This approach circumvents many issues with random clonal arrays such as the irregular spacing of clones, the presence of “blank” clones, and complicated procedures in generating the clones such as with emulsion PCR-based approaches. One useful aspect is that methods of the invention can be used to resequence the human genome at 10× coverage for both strands, generating a total of about 120 billion bases. This can be accomplished on a set of approximately 24 slides generating almost 5 billion sequence reads of approximately 25 bases in length in about 4-5 days read time per instrument. In another exemplary format a set of approximately 12 slides can be used to generate almost 1 billion sequence reads of approximately 35-50 bases in length in about 4-5 days read time per instrument. The methods of the invention can also be used for resequencing of targeted regions of the genome. The arrays can be used in a modular format that allows assembly of clones from a single sample across an entire slide or alternatively to assemble clones from many different samples on a single slide. In a particular embodiment, a simple one tube assay can be used to generate clones representing all of the approximately 250,000 exons in the human genome.

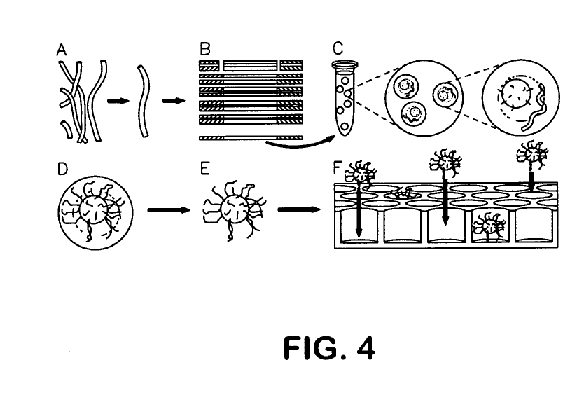

A sequencing library can consist of nucleic acid inserts, for example, DNA inserts, which can be of a defined size range, flanked by universal priming sequences (see FIGS. 4A and 4B). It is understood that, although exemplified as DNA samples, any nucleic acid sample, including RNA, can be used to generate a library. A relatively simple library to create is a shotgun library of random nucleic acid inserts such as DNA inserts created by random fragmentation of the original DNA sample. DNA can be fragmented, blunt-ended, and adapter ligated (Margulies et al., Nature 437:376-380 (2005); Shendure et al., Science 309:1728-1732. (2005), each of which is incorporated herein by reference). Two key parameters of such a library are the average insert size (25-1000 bases) and the representation (ideally uniform). The optimal insert size depends on the method of clonal amplification and the requisite read length in sequencing. Other types of useful libraries include libraries of signature tags and libraries of targeted regions of DNA.

Useful methods for clonal amplification from single molecules include rolling circle amplification (RCA) (Lizardi et al., Nat. Genet. 19:225-232 (1998), which is incorporated herein by reference), bridge PCR (Adams and Kron, Method for Performing Amplification of Nucleic Acid with Two Primers Bound to a Single Solid Support, Mosaic Technologies, Inc. (Winter Hill, Mass.); Whitehead Institute for Biomedical Research, Cambridge, Mass., (1997); Adessi et al., Nucl. Acids Res. 28:E87 (2000); Pemov et al., Nucl. Acids Res. 33:e11 (2005); or U.S. Pat. No. 5,641,658, each of which is incorporated herein by reference), polony generation (Mitra et al., Proc. Natl. Acad. Sci. USA 100:5926-5931 (2003); Mitra et al., Anal. Biochem. 320:55-65 (2003), each of which is incorporated herein by reference), and clonal amplification on beads using emulsions (Dressman et al., Proc. Natl. Acad. Sci. USA 100:8817-8822 (2003), which is incorporated herein by reference) or ligation to bead-based adapter libraries (Brenner et al., Nat. Biotechnol. 18:630-634 (2000); Brenner et al., Proc. Natl. Acad. Sci. USA 97:1665-1670 (2000)); Reinartz, et al., Brief Funct. Genomic Proteomic 1:95-104 (2002), each of which is incorporated herein by reference). The enhanced signal-to-noise ratio provided by clonal amplification more than outweighs the disadvantages of the cyclic sequencing requirement.

Currently, two of the most successful approaches to generation of clonal arrays is emulsion PCR on beads (BEAMing) (Agencourt, Beverly Mass.; 454 Life Sciences, Branford Conn.), and the use of polonies originally described by Mitra et al. (Nucleic Acids Res. 27:e34 (1999)) and currently implemented, using bridge amplification, in a commercial sequencing platform from Solexa (Hayward Calif.) (Adams and Kron, Method for Performing Amplification of Nucleic Acid with Two Primers Bound to a Single Solid Support, Mosaic Technologies, Inc. (Winter Hill, Mass.); Whitehead Institute for Biomedical Research, Cambridge, Mass., (1997); Dressman et al., Proc. Natl. Acad. Sci. USA 100:8817-8822 (2003); Mitra and Church, Nucleic Acids Res. 27:e34 (1999)). In general, cloning on beads has a number of advantages over polonies, including defined feature size, easier manipulation, ability to enrich, higher amplification, and more choice of surface chemistries. Polonies, in contrast, are easier to create, but feature size and density is less controllable. Over amplification of polonies can lead to “spreading”, whereas the restricted topology of the bead limits this effect.

For emulsion PCR, an emulsion PCR reaction is created by vigorously shaking or stirring a “water in oil” mix to generate millions of micron-sized aqueous compartments (FIGS. 4C and 4D). The DNA library is mixed in a limiting dilution either with the beads prior to emulsification or directly into the emulsion mix. The combination of compartment size and limiting dilution of beads and target molecules is used to generate compartments containing, on average, just one DNA molecule and bead (at the optimal dilution many compartments will have beads without any target) To facilitate amplification efficiency, both an upstream (low concentration, matches primer sequence on bead) and downstream PCR primers (high concentration) are included in the reaction mix. Depending on the size of the aqueous compartments generated during the emulsification step, up to 3×10⁹ individual PCR reactions per μl can be conducted simultaneously in the same tube. Essentially each little compartment in the emulsion forms a micro PCR reactor. The average size of a compartment in an emulsion ranges from sub-micron in diameter to over a 100 microns, depending on the emulsification conditions. The bead can contain a common primer sequence complementary to the sequences in the library, and the PCR mix contains free common primers to boost the growth of the clone on the bead during PCR. The process of limiting dilution of library elements in the emulsion PCR reaction generates a large population of beads without any clone and a minority of clonal beads. Generally, enrichment for clonal beads is performed before assembly onto a slide surface to maximize the information content on the array.

The use of emulsion PCR to generate “clonal beads” generally is accompanied by an enrichment step since the limiting dilution of library molecules creates a minority of beads (approximately 10-20%) populated with a clone. Over 80% of the beads are null and, if assembled onto an array, would lead to inefficient collection of information during imaging (over 80% of the beads would be blank). Given that a bottleneck to ultrafast sequencing lies in inefficient imaging of clones, it is imperative to created arrays of clones with maximal information content. However, the use of beads allows easy enrichment by affinity “panning” for clonal beads. After enrichment, only beads with amplicons are assembled into the bead array for analysis. During cycle sequencing and imaging, maximum information collection is achieved since all beads are positives. Polonies grown on beads (BEAMing, beads, emulsions, amplification and magnetics) have several advantages over polonies grown on planar surfaces. In the planar approach, individual molecules are seeded at an appropriately low density to ensure physical separation of the clonal growths. This spacing requirement decreases the effective array information density leading to inefficient imaging—most pixels record blank space. In contrast, the use of bead polonies allows more flexibility in design of the amplification reaction and post-amplification enrichment. It will be understood that methods exemplified herein with respect to polonies and clonal beads can also be carried out using DNA balls or other amplicons.

Polonies are generated by some form of solid-phase amplification by primers attached to a surface (Adams and Kron, Method for Performing Amplification of Nucleic Acid with Two Primers Bound to a Single Solid Support, Mosaic Technologies, Inc. (Winter Hill, Mass.); Whitehead Institute for Biomedical Research, Cambridge, Mass., (1997); Adessi et al., Nucl. Acids Res. 28:E87 (2000); Mitra and Church, Nucleic Acids Res. 27:e34 (1999)). Solexa employs solid-phase bridge PCR using a pair of PCR primers immobilized to a slide surface. Repeated cycles of denaturation and polymerase extension lead to amplification of the target molecule on the solid phase surface. Bridge amplification, with its immobilized primers, can be performed with thermocycling or isothermally by physically exposing the surface to alternating cycles of denaturation and extension.

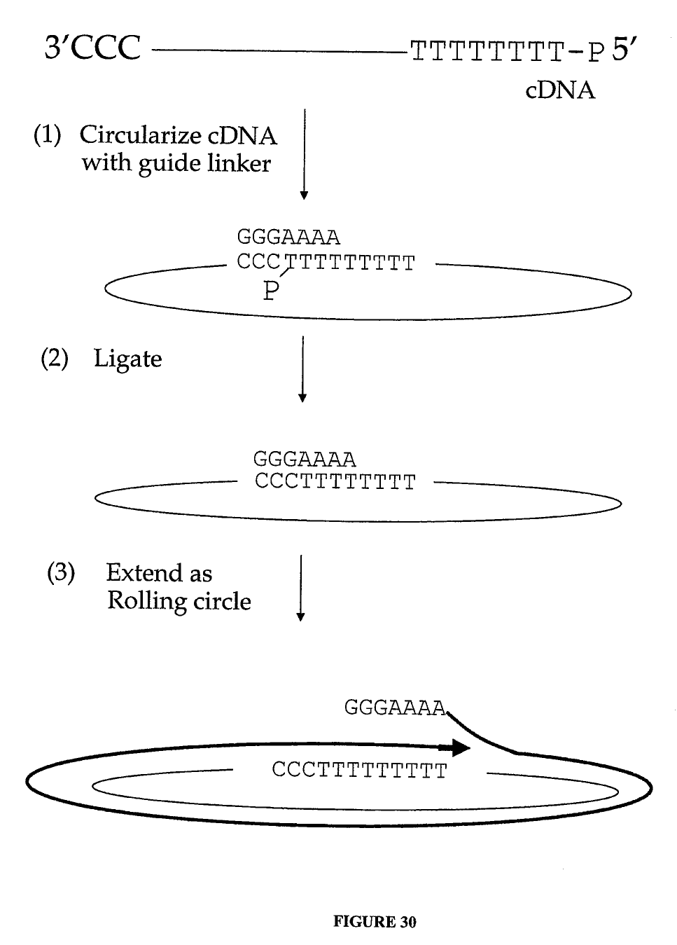

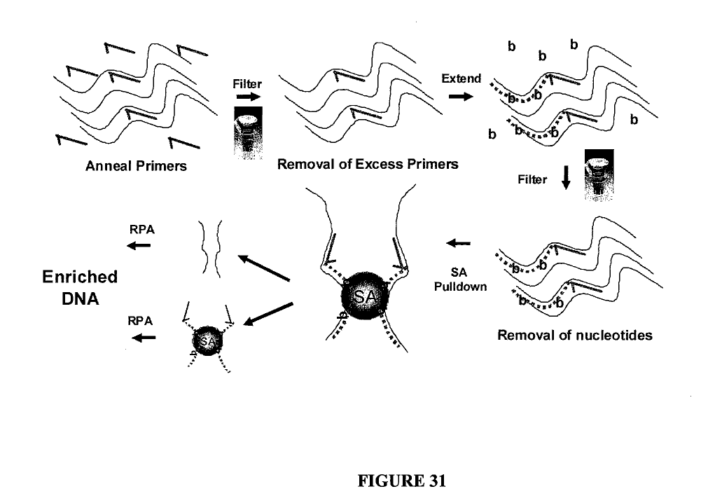

Yet another method for clonal amplification includes RCA using a guide linker (see Example IV). Beginning with a pool of mRNA, cDNA is generated such that a string of 3 or more C's is added to the 3′ end of the cDNA. The cDNA also has a poly T string complementary to the poly A tail of the corresponding mRNA. Once such cDNAs are synthesized, an exemplary method such as that shown schematically in FIG. 30 can be performed. Briefly, in step (1), cDNA is circularized using a guide linker with the sequence GGGAAAA or other sequences containing at least 3 G's and 3 A's within the guide linker, with the G's 5′ to the A's, generally on the 5′ and 3′ ends, respectively. The guide linker brings the two ends of each cDNA together due to the poly A tail at the 3′ end of the mRNA, which is reverse transcribed into a poly T string at the 5′ end of the cDNA, and a run of 3 or 4 C's added to the 3′ end in an untemplated fashion by reverse transcriptase during the generation of cDNA. As used herein, a “guide linker” is a nucleic acid sequence having sequences complementary to the 5′ and 3′ ends of a target nucleic acid sequence such as a cDNA such that hybridization to the target nucleic acid brings the 5′ and 3′ ends of the target nucleic acid molecule into sufficient proximity for a ligation reaction to be performed to generate a covalently closed circle of the target nucleic acid. Generally, a guide linker has the complementary sequences on the respective ends of the guide linker, as shown in FIG. 30, although it is understood that the complementary sequences need not be on the ends but can be internal sequences on the guide linker. Although exemplified in FIG. 30 with 3 G's and 4 A's, it is understood that a guide linker can contain a run of 4 or more G's instead of three as shown, and can have 3 or more A's, as desired. It is further understood that a guide linker contains a minimum of 2 consecutive G's and 2 consecutive A's. Further, although the guide linker generally contains only G's contiguous with A's, it is understood that intervening sequence can be included of any nucleotides, including G's and A's, if desired, so long as a sufficient number of G's and A's are on the respective ends of the guide linker to allow sufficient hybridization to the cDNA and circularization. Thus, a guide linker can contain 2 or more, 3 or more, 4 or more 5 or more, 6 or more, 7 or more 8 or more, 9 or more, 10 or more, or even higher numbers of consecutive G's and A's, independently, such as 2 G's and 5 A's, 4 G's and 7 A's, and the like.

In step (2) as shown in FIG. 30, the cDNA circle is covalently closed with a suitable ligase such as DNA ligase. In step (3), the covalently closed single stranded circular cDNA is extended with a suitable polymerase such as DNA polymerase. If desired, labeled nucleotides can be incorporated, thereby labeling the amplified DNA. The extension reaction is performed in a rolling circle, allowing incorporation of many labels into each transcript, which serves as a linear amplification of signal.

A key advantage of the method is the use of a guide linker, which serves both to select full-length cDNAs from a population via the 3° C. tails on full length cDNAs, thereby improving cDNA pool quality. The guide linker also acts as a primer for rolling circle replication. The technique is also useful since it amplifies in a linear fashion, which results in less distortion of mRNA profiles than exponential amplification techniques such as those using PCR, as described by Eberwine et al., Biotechniques 20:584-591 (1996)). The method can be used to amplify eukaryotic transcripts containing a poly A tail. The products of such an amplification can be used on microarrays or other genomic analysis, as disclosed herein.

Thus, the invention provides a method of amplifying full length cDNA. The method can include the steps of generating cDNA by reverse transcription of mRNA, wherein at least 3 cytosines are incorporated onto the 3′ end of the cDNA; contacting the cDNA with a guide linker comprising at least 3 guanosines on the 5′ end and at least 3 adenines on the 3′ end, under conditions allowing hybridization of the guide linker to the cDNA, thereby circularizing the cDNA; ligating the circularized cDNA to form a covalently closed circle; and generating a complementary sequence by rolling circle amplification. Such an RCA reaction contains suitable buffers, nucleotides, optionally including labeled nucleotides, and appropriate enzymes such as DNA polymerase. Methods of performing RCA are well known to those skilled in the art, as described herein. The amplified cDNA using guide linkers for selection of full length cDNA can be used, for example, to generate DNA balls, as described herein. Thus, such amplified cDNA can be utilized in other methods of the invention utilizing amplified cDNA, as disclosed herein.

The invention additionally provides a method for generating an array of amplified cDNA sequences. The method can include the steps of generating cDNA molecules from a plurality of mRNA molecules under conditions whereby at least 3 cytosines are incorporated onto the 3′ end of the cDNA molecules; hybridizing the cDNA molecules with a guide linker, wherein the guide linker comprises at least 3 consecutive guanosines and 3 consecutive adenines and hybridizes to the ends of the cDNA molecules, thereby generating circularized cDNA molecules; ligating the circularized cDNA molecules; amplifying the circularized cDNA molecules to generate amplicons, wherein each of the amplicons comprises multiple copies of a circularized cDNA molecule in the plurality of circularized cDNA molecules; and distributing the amplicons on an array, thereby generating an array of amplified sample cDNA sequences. In one embodiment, the guide linker can be used to prime amplification of the circularized cDNA. The method can further include the embodiments described herein relating to methods of generating an array of amplified nucleic acid sequences. In the method using a guide linker, the C's on the 3′ end and the T's on the 5′ end of the cDNA are analogous to and function similar to first and second common primers that bring the ends of the sample nucleic acid molecule together to circularize the nucleic acid molecule in a splint ligation. The use of a guide linker provides not only the advantage of selecting full length cDNA over cDNA fragments, but also allows selection of full length cDNA over other nucleic acids. Thus, full length cDNA can be specifically amplified from a sample having other nucleic acid impurities such that full length cDNA is selectively added to an array over other impurities.

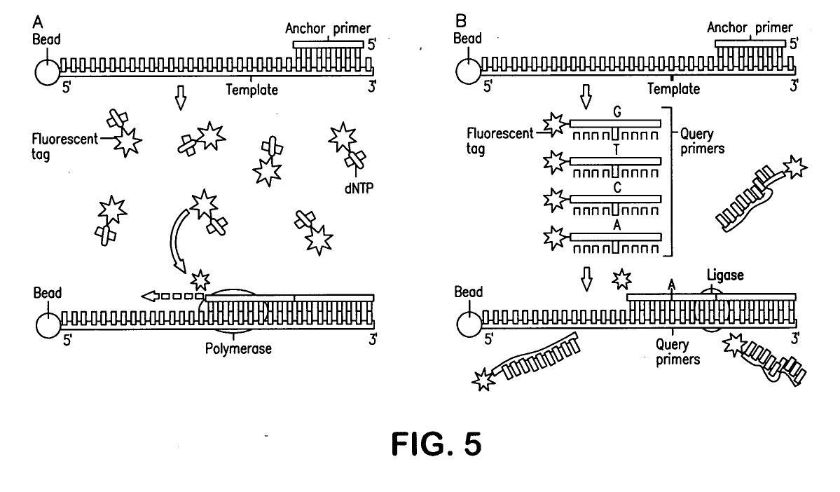

After an array of clonal features is created, the array can be subjected to cycle sequencing consisting of repeated rounds of sequencing biochemistry interspersed by imaging. Several formats of cycle sequencing have been described in the literature, and include sequencing-by-synthesis (SBS), sequencing-by-ligation (SBL), and sequencing-by-hybridization (SBH) (see FIG. 5). One of the most useful forms of cycle sequencing is SBS, in which the sequence of the polony insert or amplicons is read by repeated rounds of polymerase-based nucleotide insertion and fluorescent/chemiluminescent readout. SBS has two formats: (1) stepwise nucleotide addition (SNA) employing cycles of dNTP incorporation and imaging, and (2) cyclic reversible termination (CRT) employing cycles of incorporation of reversible terminators, imaging, and deprotection.

The SNA approach to cycle sequencing has been described by at least three different groups. In one commercial implementation from 454 Lifesciences, (Branford, Conn.) and Roche Diagnostics (Basel, Switzerland), cyclic pyrosequencing from assembled clonal beads has been used to sequence entire microbial genomes (Margulies et al., Nature 437:376-380 (2005), which is incorporated herein by reference). This approach provides high accuracy and throughput, although there are a number of technical issues that can be improved to more efficiently scale the approach to sequencing of the human genome. For instance, the current size of the clonal beads, approximately 35 μm, limits the array density. The bead size should preferably be scaled down by at least a factor of 10 for improved efficiency in sequencing of the human genome. Secondly, most SNA approaches have difficulty effectively sequencing through homopolymeric runs of bases. Thirdly, SNA typically requires almost four-fold more cycles than CRT if each base type is added separately, whereas in four-color CRT all four nucleotides (A, C, G, and T) can be added simultaneously. Other examples of SNA in the literature include the methods described in combination with polony amplification by Mitra et al., supra, 2003. Cyclic addition of cleavable fluorescently-labeled dNTPs was used to sequence the polony clones. After each base addition and imaging step, fluorescent labels were cleaved by disulfide reduction. In a third approach described by Braslavsky et al., single target molecules were immobilized onto a glass microscope slide at a sparse density and performed cycle sequencing by basewise addition of Bodipy-labeled dNTPs (Braslavsky et al., Proc. Natl. Acad. Sci. USA 100:3960-3964 (2003), which is incorporated herein by reference). After imaging, the fluorescence was destroyed by photobleaching. Similar manipulations can be used to determine the sequence of a sample nucleic acid in accordance with the methods set forth herein.

In CRT, cycle sequencing is accomplished by stepwise addition of reversible terminator nucleotides containing a cleavable or photobleachable dye label. This approach is being commercialized by Solexa (www.solexa.com), and is also described in WO 91/06678, which is incorporated herein by reference. The availability of fluorescently-labeled terminators in which both the termination can be reversed and the fluorescent label cleaved is important to facilitating efficient CRT. Polymerases can also be co-engineered to efficiently incorporate and extend from these modified nucleotides. In particular embodiments, reversible terminators/cleavable fluors can include fluor linked to the ribose moiety via a 3′ ester linkage (Metzker, Genome Res. 15:1767-1776 (2005), which is incorporated herein by reference). Although this modification greatly attenuates its incorporation by standard sequencing polymerases, it may be possible to engineer polymerases to more efficiently incorporate and extend from these modified nucleotides. Other approaches have separated the terminator chemistry from the cleavage of the fluorescence label (Ruparel et al., Proc Natl Acad Sci USA 102: 5932-7 (2005)). Ruparel et al described the development of reversible terminators that used a small 3′ allyl group to block extension, but could easily be deblocked by a short treatment with a palladium catalyst. The fluorophore was attached to the base via a photocleavable linker that could easily be cleaved by a 30 second exposure to long wavelength UV light. Thus, both disulfide reduction or photocleavage can be used as a cleavable linker. Another approach to reversible termination is the use of natural termination that ensues after placement of a bulky dye on a dNTP. The presence of a charged bulky dye on the dNTP can act as an effective terminator through steric and/or electrostatic hindrance. The presence of one incorporation event prevents further incorporations unless the dye is removed. Cleavage of the dye removes the fluor and effectively reverses the termination (www.genovoxx.de). In general, all of the CRT approaches described above have been reported to provide read lengths of 20-30 bases, which is in contrast the pyrosequencing-based SNA approach with reported read lengths over 100 bases using methods commercially available from 454 Lifesciences (Branford, Conn.) and Roche Diagnostics (Basel, Switzerland).

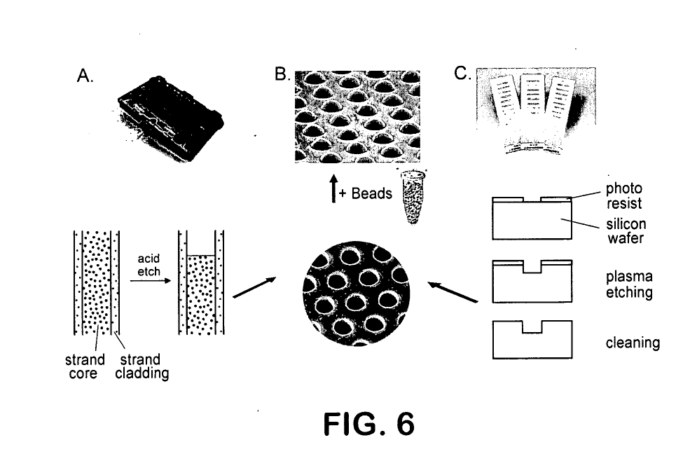

An example of an array platform is the BeadArray™ platform commercially available from Illumina Inc. (San Diego, Calif.) and consisting of a highly miniaturized array of beads in wells using 3 μm beads in wells spaced from 5-6 μm center to center in a hexagonal grid. This translates into a packing density of over 50,000 array elements per square millimeter—approximately 400 times the information density of a typical spotted microarray with 100 μm spacing. Each derivatized bead has several hundred thousand copies of a particular oligonucleotide covalently attached. Bead libraries are prepared by conjugation of oligonucleotides to silica beads, followed by quantitative pooling together of the individual bead types. The preparation of a bead library and assembly into an array are illustrated in FIG. 6. After self-assembly of the beads into the array, the arrays are decoded to determine the identity of each bead on the array (Gunderson et al., Genome Res. 14:870-877 (2004), which is incorporated herein by reference). This and similar systems can be used to array nucleic acid molecules in methods of the invention.

To create substrates capable of holding millions of beads, Illumina has developed a high-density microelectronic mechanical systems (MEMS)-patterned slide, termed a BeadChip™, that holds over 13 million randomly-assembled beads. The advantage of the BeadChip™ is that it uses MEMS patterning technology to provide higher feature density and more design flexibility than fiber bundles. The current BeadChip™s are designed with up to 12 sectional “stripes,” each holding over 1.1 million beads for a combined total of over 13 million beads. For the highly-parallel sequencing applications described herein, the BeadChip™ can be redesigned with one large contiguous region of beads. Furthermore the bead diameter can be reduced from 3 μm to approximately 1 μm, and the center-to-center spacing reduced to about 2.0 μm. This should increase the effective density to over 200 million beads per slide. This and similar systems can be used to array nucleic acid molecules in methods of the invention.

A system such as Illumina's BeadChip™ processing platform can be used as a highly-automated platform for whole genome genotyping or targeteted nucleic acid analysis. All assay steps from sample preparation to post-hybridization processing steps including washing, blocking, primer extension, and multi-stage signal amplification can be automated. In addition, an integrated Laboratory Information Management System (LIMS)-tracking system with the process automation can be used. Automation can be achieved with a robot and automated array slide processing. A system employing a capillary gap flow cell for fluidics manipulation can be used. The use of a capillary gap flow cell greatly simplifies reagent addition and removal. In one example, the capillary gap is created by a 70 μm spacer, and retains reagent within the gap by capillary action. The automated system can be designed to allow a reagent to be quickly washed out and replaced with a second reagent through addition of the second reagent to a reservoir and allowing gravity flow to wash out the first reagent. The reservoir empties and the second reagent is retained within the capillary gap. The chambers can be temperature controlled, allowing precise temperature control of all extension and staining steps. Finally, a robot can be used to perform all reagent transfer steps including pipetting of wash solutions, blocking mixes, extension reagents, and staining reagents. Additionally formulation of frozen/aliquoted “single use” reagents can be used to greatly improve ease of use, robustness and reproducibility.

Bead-based primer extension assays and array-based enzymatic assays can be used. An exemplary assay can use an array-based allele-specific primer extension (ASPE), such as the Infinium™ I assay (Illumina). Another exemplary assay uses an array-based single base extension (SBE) assay such as the Infinium™ II assay. In addition, commercial genotyping assays using an extension-ligation biochemistry on streptavidin bead surfaces can also be used. These and other useful assays for genetic analysis can be carried out as described, for example, in US 2003/0215821; US 2003/0108900 or US 2005/0181394, each of which is incorporated herein by reference.

For image processing, algorithms can be used for quickly processing and extracting array images (Galinsky, Bioinformatics 19:1824-1831 (2003), which is incorporated herein by reference). An array such as BeadArray™ can contain square sections or blocks of different intensity spots packed in lattice or grid. Algorithms can be used to automatically identify or index each individual spot (spot indexing) in the block as well as each block in the whole slide (block indexing). The algorithm can be used to overcome the orthogonal and non-orthogonal transformations and even non-linear distortions of a slide.

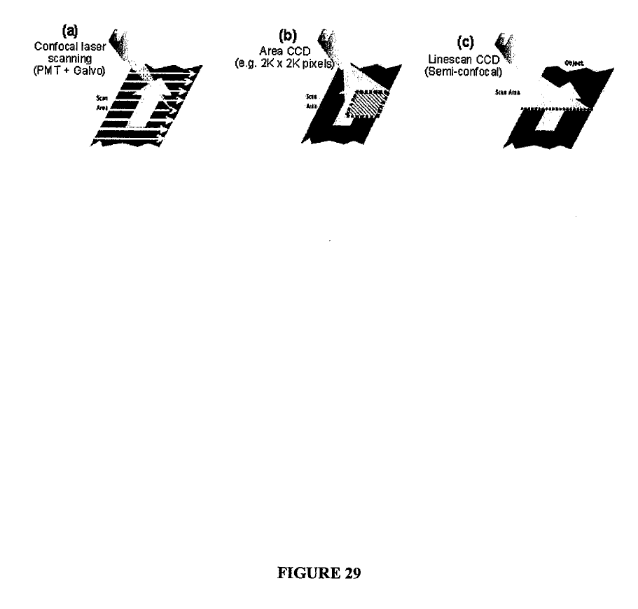

All commercial microarray scanners today are one of two types: laser confocal photomultiplier tube (PMT) based scanners, or area charge-coupled device (CCD) imagers (see FIGS. 29A and 29B). For example, the commercially available BeadArray™ Reader (Illumina) is based on a confocal scanner approach, having taken into consideration the specific requirements for throughput, limit of detection, and dynamic range necessary for gene expression and genotyping applications. For higher throughput applications, confocal scanners become limited by the high raster rates required of the mechanical galvo. Imagers based on two dimensional area CCDs have only slightly higher limit of detection, but can have much higher pixel throughputs because of their ability to image a large number of pixels in parallel. Area CCD scanners are not confocal, and therefore suffer higher inter-pixel crosstalk, which impacts resolution and minimum resolvable feature size. Moreover, throughput for area CCD scanners is ultimately limited by the maximum amount of light that can be obtained from a lamp source, and also the mechanical step motion required between each image. For very high throughputs, the mechanical step motion becomes a significant contributor to the overhead time, and becomes even worse for high resolution applications as the number of images per given area scales as the square of the required resolution.

During the manufacture of BeadChip™s (Illumina), multiple imaging stages are taken at various stages in the decoding process, placing high demands on imaging throughput much like the demand for ultra-fast sequencing. In addition, as features are miniaturized, high resolution, high sensitivity imaging is also desired. A line scan CCD scanner can be used for high-throughput decoding. This approach combines the strengths of both of the above two approaches, laser-based scanning with a line scan CCD. In contrast to an area CCD, a line scan CCD typically has a large number of pixels only in one axis (see FIG. 29C). Line scanning has a significant advantage in that readout is performed in a continuous motion. The overheads of mechanical step motion and pixel readout associated with area CCDs are not factors for line scanning, and the duty cycle for imaging is high. A laser line generator can be used as an excitation source, rather than a lamp, so that optical power is not a limitation. In addition, by careful matching of the laser line width to the width of the CCD, semi-confocal imaging can be achieved, which brings significant advantages in inter-pixel crosstalk reduction and improvement of limit of detection. This design can be utilized for both building manufacturing decode scanners and in sequencing applications. Exemplary line scan CCD cameras that can be used include those described in the U.S. patent application entitled “CONFOCAL IMAGING METHODS AND APPARATUS,” filed on Nov. 21, 2006, and claiming priority to U.S. Ser. No. 11/286,309, each of which is incorporated herein by reference.

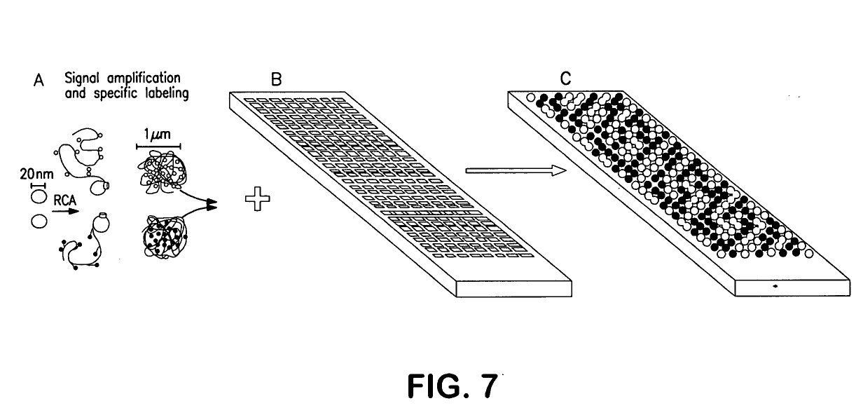

Most proposed cyclic sequencing platforms employ some form of array analysis of solid-phase clonal amplicons. These clonal amplicons have been generated on a solid phase using either bridge PCR on a slide surface (Solexa) or cloning on beads via BEAMing (Agencourt and 454 Lifesciences). As disclosed herein, an alternate strategy useful in methods of the invention is to employ “DNA balls,” which represent clonal amplifications of small circular nucleic acid library elements. Generally small (approximately 20 nm) circles are amplified by annealing a common primer and using rolling circle amplification (RCA) to created 100's to 1000's of contiguous tandem copies of the original circle. This long clonal amplicon naturally adopts a random-coil configuration in a high-salt solution and is termed a “DNA ball”. As disclosed herein, these DNA balls are assembled onto a planar substrate for subsequent cycle sequencing reactions (see FIG. 7). Optimized assembly of DNA balls on a slide into an array allows maximization of the information content per unit area of the slide. This can be accomplished by attaching the DNA balls to discrete locations pre-patterned onto a slide, as disclosed herein. Densities of greater than 160,000 objects per can be easily achieved using approximately 1 μm clonal objects at a 2.5 μm center-to-center spacing.

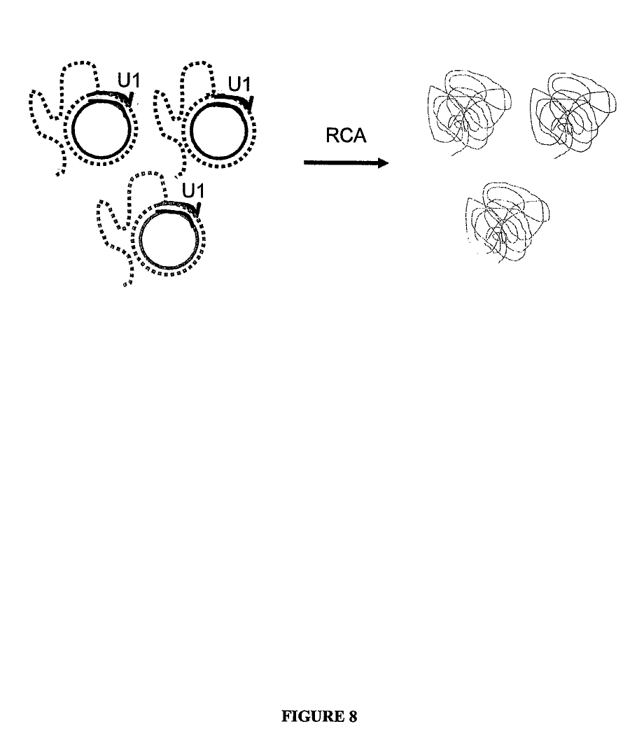

As disclosed herein, a model system can be used for optimization of arrays of DNA balls. One model system employs a set of three circles all sharing a common priming sequence (see FIG. 8). The DNA balls can be biotin labeled during the RCA amplification step. Fluorescently-labeled complements to the internal sequence of the circle can be used to probe the products of RCA. If two clonal DNA balls co-localize on a DNA array, both fluorescent signals, for example, green and red signals, should co-localize. Discrete fluorescent spots indicates a feature having distinct clonality on the array.

Rolling circle amplification (RCA) conditions can be varied to create DNA balls having desired characteristics. An important characteristic of DNA balls is the number of tandom replications of the circle. In general, more replications generate more signal. Another characteristic of the DNA balls is the variance in number of copies. Generally, the DNA balls are uniform in size for a particular array format. Key RCA parameters such as polymerase concentration, nucleotide concentration, presence of single stranded binding protein, salt concentration, controlling processivity, incubation time, and temperature can be varied for a desired application. Amplification of cDNA using a guide linker, as described herein and in Example IV, can be utilized to select for full length cDNA, as desired.

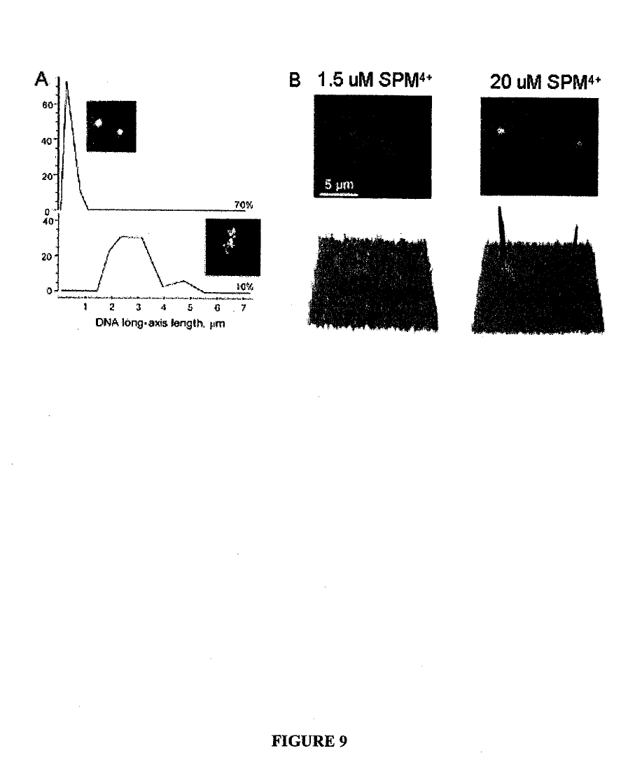

The compaction of the DNA balls can be varied. In order to assemble DNA balls onto an array, the RCA product can be compacted into a stable DNA ball. Various reagents have been used in the literature to collapse DNA including quaternary ammonium salts, alcohol, polyamines, and the like (FIG. 9) (Mikhailenko et al., Biomacromolecules 1:597-603 (2000); Baigl and Yoshikawa, Biophys. J. 88:3486-3493 (2005), each of which is incorporated herein by reference). These and other reagents can be present at various concentrations for their ability to collapse DNA to different degrees. Once collapsed, the DNA balls are clonally assembled onto the array. Assembly can occur under any of a variety of buffer and salt conditions to favor assembly of only one DNA ball per site. After compaction and assembly, the DNA ball on the array can be “loosened-up” by removing the compacting reagents. The “loosening up” allows better access of reagents for subsequent reactions, such as sequencing, and therefore more efficient reactions.

Clonal beads can be generated, for example, by solid-phase bridge PCR employing a pair of immobilized upstream and downstream primers flanking a region of interest in a DNA target or library element. Repeated cycles of denaturation and polymerase extension lead to amplification of the target molecule on the solid phase surface (Adams et al., U.S. Pat. No. 5,641,658; Adessi et al., Nucleic Acids Res. 28:E87 (2000), each of which is incorporated herein by reference; Promega, Madison Wis.). Bridge amplification, with its immobilized primers, has an advantage over solution phase PCR in that bridge amplification can be performed isothermally by physically exposing the surface to alternating cycles of denaturation and extension. Solexa currently employs isothermal bridge amplification to generate polonies on its slide surface for sequencing applications. Bridge PCR can also be used on the slide surface instead of isothermal amplification.

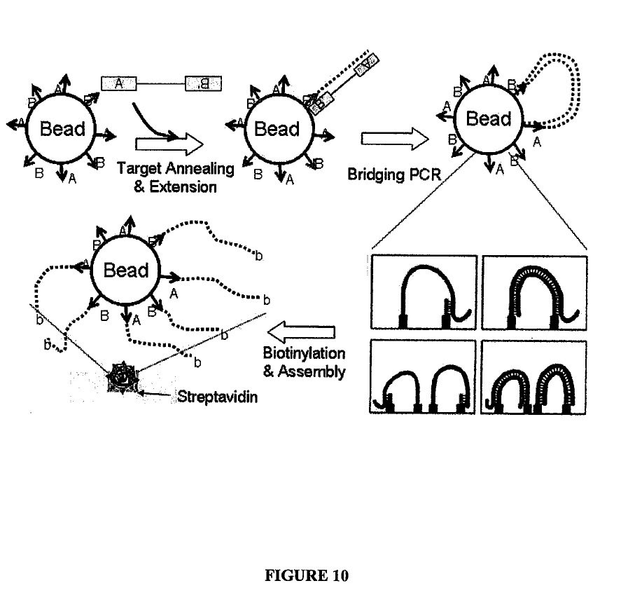

Replacement of bridge PCR on slide surfaces with bridge PCR on beads has many advantages (FIG. 10). First of all, the use of bead arrays greatly increases the feature density since clonal beads can be enriched for and maximally packed on a bead array. Secondly, the size of the clonal bead is fixed by the bead size, in contrast to polony growth on slides, which is unconstrained and dependent on both the number of amplification cycles and the length of the target amplicon. Thirdly, the level of amplification on beads can be greatly increased since polony growth is limited by the topology of the bead surface and there is no risk of growing overly large polonies if extra PCR cycles are employed.

Another advantage of beads is that it also replaces the careful titration and seeding of library elements on a slide surface with simple mixing of beads in stoichiometric excess over library elements. The stoichiometric excess of beads ensures that only a single library element is seeded on a bead. After bridge amplification, only a minority of beads contain clonal amplifications; the majority of beads will be blank. The clonal beads can be enriched by hybridization enrichment or by specific labeling of the nucleic acids, for example, by biotinylation at the 3′ terminus of the amplified clonal sequences. This 3′ biotinylation can be accomplished by hybridizing a complement to the universal sequence and extending with a biotinylated nucleotide or alternately by ligating a biotinylated adapter. Biotinylation by incorporation of biotinylated nucleotides during amplification can also be used. Several key parameters can be varied to optimize bridge PCR on beads. These key parameters include surface chemistry, linker length, and probe density.

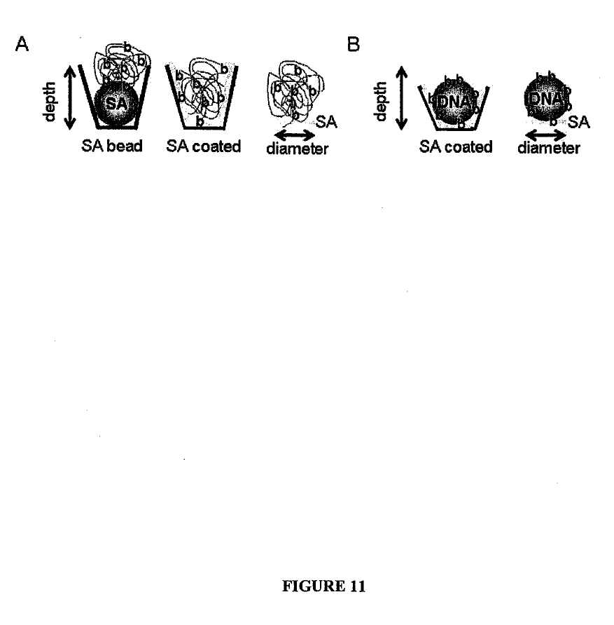

A substrate such as a slide can be modified for assembly of DNA balls into an array. For example, the DNA balls can be captured on an array surface patterned with discrete zones of an affinity binding reagent (see FIG. 11). In a relatively simple implementation, a streptavidin-biotin system can be used. The arrays are patterned with regions of streptavidin (“feature”), and the DNA balls are captured on the array via a biotin tag incorporated during RCA, for example, via biotin-labeled nucleotides. Two exemplary types of patterned substrates can be used. The first substrate employs an array such as BeadChips™ loaded w/streptavidin beads. The diameter of the wells/beads and the depth of the well can be optimized. A second type of substrate consists of photolithographically-patterned regions containing streptavidin derivitization (Chrisey et al., Nucl. Acids Res. 24:3040-3047 (1996); Sabanayagam et al., Nucl. Acids Res. 28:E33 (2000), each of which is incorporated herein by reference). These regions of derivitization can be wells or patches on the surface. The size of the feature can be selected such that only a single clonal DNA ball is immobilized per feature. If the feature is made small enough, the steric and charge hindrance imposed by the immobilization of one ball will keep other balls from immobilizing to that same feature. With suitable photolithographic mask design, all sizes can be tested simultaneously on a single slide substrate. Various concentrations of different salts (including various DNA condensing quaternary salts) can be tested for their ability to deliver only single discrete clonal DNA balls to the array features.

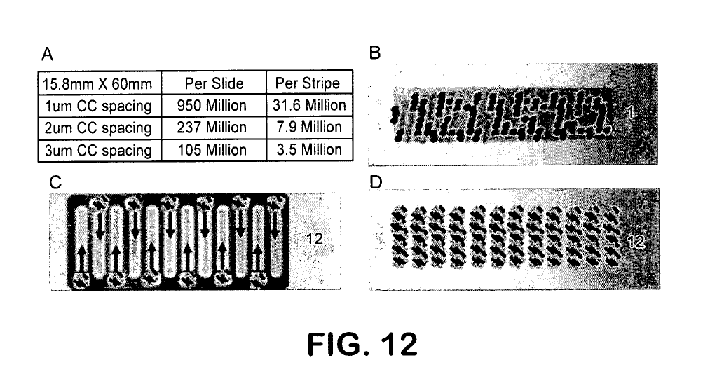

One major strength of technology such as Illumina's BeadChip™ technology is its modularity using gasketing technology. A single sample can be processed across an entire BeadChip™, or alternatively many samples can be processed across a single BeadChip™ by using a gasket to allow different samples to be applied to different regions of the BeadChip™ (see FIG. 12). This same gasketing technology can be used to subdivide the arrays for sequencing into individual chambers for creation of the clonal arrays. After the clonal arrays are created, the entire array can be processed as a unit through the cycle sequencing. The advantage of sample modularity, especially for targeted resequencing, optimal use of the array substrate can be utilized. For instance, the depth of resequencing will vary between applications. In some cases, deep resequencing (10,000× coverage) is necessary to find a rare variant (“needle in a haystack”), in other cases a 10× coverage of gDNA from a blood sample is sufficient. Modularity in format allows an easy tradeoff between library complexity and representation with sample number.

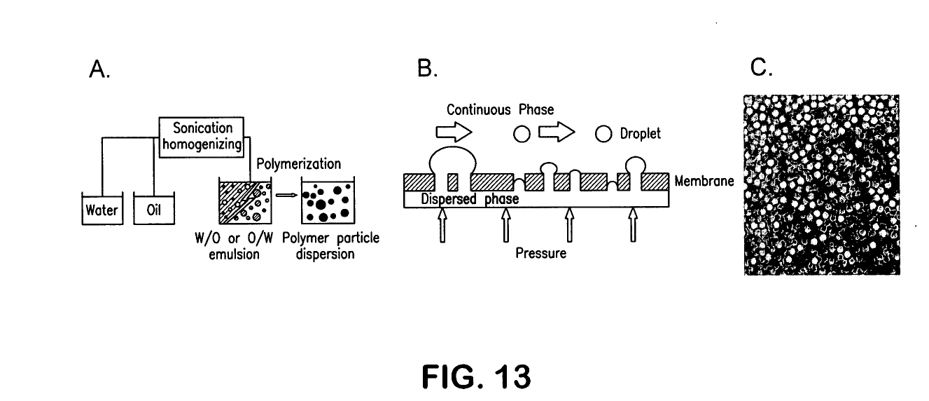

Emulsion PCR is one method that can be used to create homogenous DNA balls. A water-in-oil (w/o) emulsion can be created simply by rapidly stirring a surfactant-laced water-in oil-mixture. The rapid stirring induces shear forces which break-up the water droplets into small compartments. The drawback of shear-induced emulsions is that the droplets vary enormously in size by as much as an order of magnitude. This large compartment size heterogeneity leads to difficulty in achieving molecule distributions of single molecules per compartment. A mono-disperse emulsion can be created through a technique called cross-flow emulsification (Peng and Williams, Trans. IChemE 76(Part A):894 (1998); Williams et al., Trans. IChemE 76(Part A):902-910 (1998), each of which is incorporated herein by reference). The basic idea is to squeeze water through lots of tiny holes in a membrane into a passing stream of oil. Water droplets are formed as the water leaves the holes, and are carried off by the passing oil (FIG. 13). Emulsification of an RCA reaction can be used to limit the amount of reagent available to any individual clonal RCA reaction, leading to more uniformly sized DNA amplicons. Moreover, if there are any interactions in RCA of a complex library, separating the circular clones into individual compartments can minimize any ill effects. Even if two or three circles are in the same compartment, it is unlikely that they will have enough homology to interact in any way.

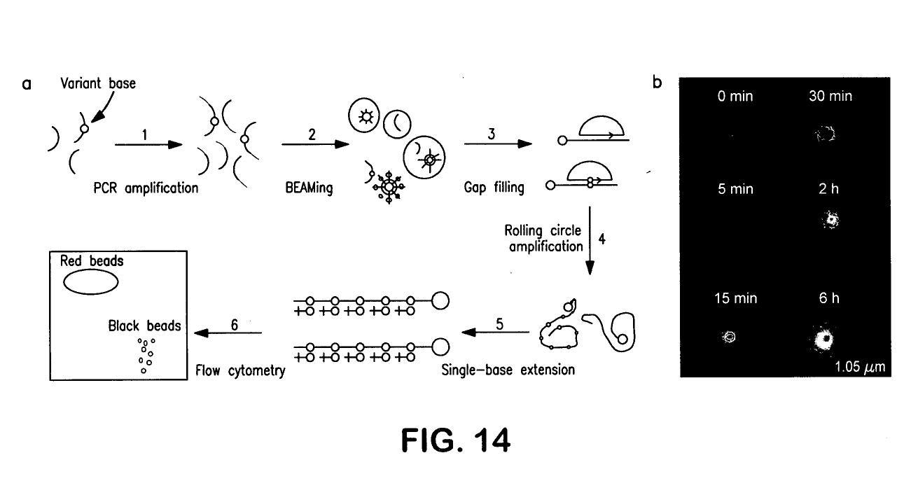

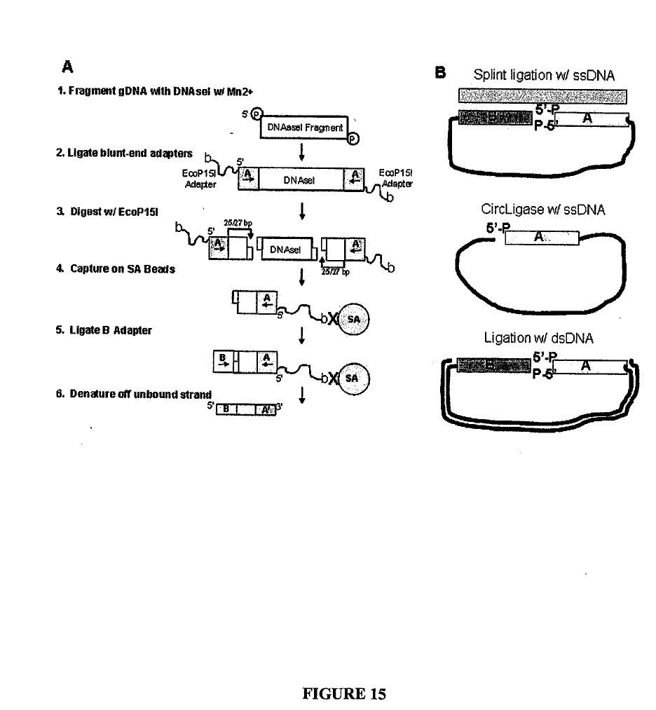

RCA can be used to increase signal on beads. Solid-phase amplification is known to be less efficient than solution-based methods. Solid-phase PCR using either Bridge Amplification or emulsion PCR often generates beads that have a low detectable signal. In a recent paper by Li et al., they describe the application of RCA (BEAMing-Up) to clonal beads created by BEAMing (Li et al., Nat. Methods 3:95-97 (2006), which is incorporated herein by reference). A similar approach can be evaluated to increase the signal on beads generated by a bridge amplification approach (FIG. 14).

The invention also relates to methods of using targeted nucleic acid sequences. For example, shotgun and targeted genomic and cDNA libraries can be made to be compatible with clonal analysis by cycle sequencing approaches, as disclosed herein.

Clonal resequencing typically starts with construction of a DNA library. The manner in which this library is constructed governs the final complexity of the library. The complexity can range from shotgun libraries of the entire genome to libraries generated from a targeted region (or regions) in the genome. Much of the usefulness of inexpensive resequencing will be to perform targeted resequencing of defined genomic or cDNA regions. The ability to inexpensively resequence all 250,000 exons in the human genome for $1000 is a goal directed to making a great contribution to understanding the role of human variation and mutation in disease. This will benefit from development of multiplexed approaches to genome analysis (Fan et al., Nat. Rev. Genet. 7:632-644 (2006)).

In addition to random fragmentation of DNA, libraries can be created from regions of DNA by random sampling such as with restriction enzymes. One example is SAGE tag libraries generated by restriction digestion of cDNA with a combination of type II and type IIS enzymes (Velculescu et al., Science 270:484-487 (1995)). Additionally, SAGE-like libraries can be created from genomic DNA; these signature tag libraries have been used in digital karyotyping (Wang et al., Proc. Natl. Acad. Sci. USA 99:16156-16161 (2002)).

EcoP15I shotgun libraries from gDNA can be generated. In designing the library, the insert size should be compatible with the downstream clonal amplification and subsequent cycle sequencing reaction. Some methods of clonal amplification such as BEAMing using emulsion PCR have an optimal insert size for efficient amplification (Shendure et al., Science 309:1728-1732 (2005), which is incorporated herein by reference). In general, shorter inserts have better amplification yields, especially on a solid phase. Therefore the maximum read length on the cycle sequencing biochemistry can be taken into consideration. If one is using cyclic reversible terminators, the read lengths are about 25-50 bases. In such a case, a useful insert size is about 25-50 bases.

Libraries with short inserts can be generated using the typeIII restriction enzyme, EcoP15I, in a procedure similar to the construction of SuperSAGE libraries (Matsumura et al., Cell Microbiol 7: 11-8 (2005)). EcoP15I is a Type III restriction enzyme that cleaves 27 bases from its recognition sequence into nascent sequence. If EcoP15I is incorporated into an adapter, it can be ligated onto the ends of DNA fragments and 27 bases from each end of the fragment can be sampled for the library. Genomic DNA can be randomly fragmented into blunt-ended products using DNaseI in combination with Mn²⁺. Ligation of EcoP15I adapters to the fragmented gDNA, subsequent EcoP15I digestion, and ligation with a second adapter sequence creates a gDNA library flanked by a universal primer with uniformly sized 27 bp inserts (see FIG. 15).

Targeted libraries can be generated. A number of different approaches for creating these targeted libraries can be used, as described below. Most of the approaches require synthesis of 1-2 query oligonucleotides per locus (region). In order to query 10,000's-100,000's of sites, at least that many oligonucleotides are required.

One method to evaluate the quality of “targeted assays” is to use a 33,000 locus BeadChip™ (Illumina) employing the Infinium™ (Illumina) assay as readout. Targeted amplification or enrichment assays are designed to a 1000-3000 loci subset of the 33,000 SNP loci. After performing the targeted assay, the enriched DNA along with validation controls are spiked into a background of salmon sperm DNA at approximately a one-to-one stoichiometry and processed through the Infinium™ assay (whole genome amplification, hybridization, and extension/staining). The validation control loci (approximately 100), selected from the 33,000 SNPs and excluding the targeted assays, are individually PCR amplified from gDNA. The length of the validation controls are matched to size of the products of the targeted amplification assay. A comparison of the normalized intensity of the targeted assays to the validation controls indicates the degree to which the targeted amplification was successful. Intensity is normalized by comparing the assay and validation locus intensity to the locus intensity when the complete gDNA is processed through the Infinium™ assay.

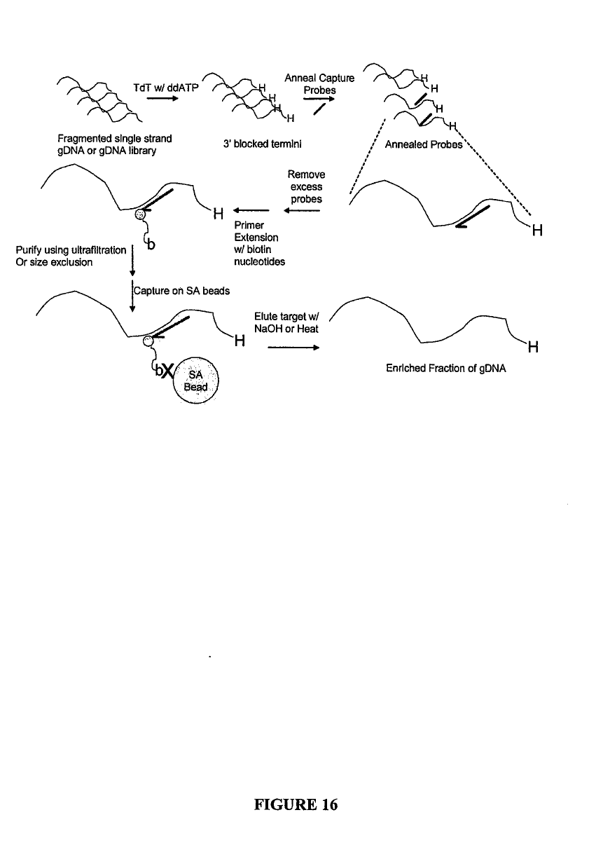

For hybridization-extension capture enrichment, a combination of hybridization pull-out and primer extension can be used to derive single base resolution in the complexity of the entire genome, and a similar approach can be used to enrich for sequences of interest in the genome (see FIG. 16). Genomic DNA can be fragmented to some pre-determined average size which determines the persistence length of the enriched fraction. Hybridization capture probes of approximately 25 to 100 bases in length, such as those that are 50 bases in length, can be designed to regions of interest in the genome. These probes can then be stringently annealed to the genomic DNA. Excess probes can be removed by ultrafiltration or size exclusion. The annealed probes can be used as primers in a polymerase extension step using biotin-labeled ddNTPs or dNTPs. Only those probes that are correctly annealed will extend, and this contributes greatly to the overall discrimination of the assay. After extension, the free nucleotides can be removed by ultrafiltration or size exclusion. The annealed primer-target duplexes can be pulled down onto streptavidin beads, and the enriched targets eluted from the solid-phase. This enriched fraction can now be used to generate a library. If desired, the labeled and extended strand bound to streptavidin beads need not be eluted and instead can be used directly in a whole genome amplification reaction from which sequencing libraries can be constructed.

Alternatively to the order exemplified above, the library can be generated first, and enrichment of library elements can occur afterwards. Creating the library upfront can be beneficial since the gDNA is double stranded. After enrichment and elution, the library elements will be single stranded. Furthermore, if the library is constructed upfront, Cot-1DNA can be used for blocking non-specific interactions, and since it doesn't have universal primer sites, it will not be amplified in later steps. This approach can also be used to enrich for gDNA species having desired loci prior to bisulfite conversion in methylation analysis.

As set forth above, particular embodiments of hybridization-extension capture enrichment can be carried out using nucleotide analogs having blocking groups, such as ddNTPs that can be added to a primer by a polymerase but are blocked from further extension due to a hydrogen at the 3′ position which acts as a blocking group. Blocking groups include any moiety on a nucleotide that prevents further extension examples of which are set forth in further detail below. For example, nucleotide analogs having reversible blocking groups are particularly useful in hybridization-extension capture methods because they can be selectively added to particular primer-template hybrids in a complex mixture, then removed for subsequent analysis of those particular primer-template hybrids.

Often conditions that are well suited for extension of primers, especially to obtain long replicates of a template, can be relatively permissive in allowing some amount of extension from primers that are not perfectly complementary to their templates. In situations where mixtures of primer-template hybrids are present, mismatched primers can be excluded from participating in extension reactions by addition of blocking groups. In a particular embodiment the mixture is first treated with nucleotide analogs having reversible blocking groups under conditions of high extension fidelity. Under high extension fidelity conditions mismatched primers will not be efficiently extended and perfectly matched primers will be selectively extended. The mixture can then be treated with a second nucleotide that also has a blocking group but this time under extension conditions that have lower fidelity such that mismatched primers are blocked by incorporation of the second nucleotide. The mixture which now contains both primers having the reversible blocking group and primers having the other blocking group can be treated to remove the reversible blocking group. The deblocking conditions are selected such that most or all of the reversible blocking groups are removed while the other blocking groups are not removed at all or at least not to any substantial degree. This mixture can then be treated under extension conditions for obtaining long replicates and the correctly matched primers that were deblocked will be selectively extended over mismatched primers which remain blocked to extension.

The deblocking conditions can be selected according to the particular blocking group being used in accordance with the description below. The set of probes used in the blocking/deblocking method can be primers that are specific for a desired subset of sequence targets in a complex sample, such as a genomic DNA sample. In this way, the methods can be used to produce a targeted library. The library can be used as set forth herein, for example, to produce an array of nucleic acids that is useful for analysis of the targeted regions of the genome of interest.

Accordingly, the invention includes a method of making a targeted genomic DNA library. The method can include the steps of (a) providing a genomic DNA sample including a plurality of annealed capture probes having different sequences that are complementary to different target regions of the genomic DNA sample; (b) sequentially treating the annealed capture probes with nucleotide analogs having reversible blocking groups under a first polymerase extension condition and then treating the annealed capture probes with nucleotide analogs having second blocking groups under a second condition, thereby producing a modified probe set having reversible blocking groups on a first plurality of the annealed capture probes and second blocking groups on a second plurality of the annealed capture probes, wherein the first polymerase extension condition has higher extension fidelity than the second polymerase extension condition; and (c) removing the reversible blocking groups from the modified probe set and then adding at least one nucleotide to deblocked probes of the modified probe set, thereby forming a plurality of different extension products having the target regions. The method can further be used to make an array by utilizing the additional step of (d) attaching the different extension products to an array. Whether or not the extension products are attached to an array or other solid-phase surface, the extension products can be selectively amplified, over non extended products, to produce an enriched fraction of the genomic DNA sample.

Polymerase extension fidelity refers to accuracy of nucleic acid replication including, for example, the degree to which perfectly matched primers are extended compared to primers having mismatches or the degree to which the nucleotides incorporated into a replicated nucleic acid are complementary to the template strand used in replication. Fidelity can be influenced by any number of conditions. A relative increase in fidelity can be favored, for example, by decreased polymerase concentration, decreased nucleotide concentration and any number of conditions, which are known for particular polymerases as described by various commercial suppliers of the polymerases, or which can be routinely determined using standard polymerase extension assays. Additionally, different stringency conditions can be used as described, for example, in Sambrook et al., Molecular Cloning: A Laboratory Manual, 3rd edition, Cold Spring Harbor Laboratory, New York (2001) or in Ausubel et al., Current Protocols in Molecular Biology, John Wiley and Sons, Baltimore, Md. (1998). For example, high stringency conditions will favor increased fidelity of extension, whereas reduced stringency will permit lower fidelity extension to occur.

A nucleotide can be added to an annealed probe using a template directed agent such as a polymerase as set forth above. In particular embodiments, a nucleotide can be added to an annealed probe using a non-template directed enzyme such as a terminal deoxynucleotide terminal (TdT) transferase. For example, a method of the invention can include a step of sequentially treating an annealed capture probes with nucleotide analogs having reversible blocking groups under a first extension condition in which a polymerase is used and then treating the annealed capture probes with nucleotide analogs having second blocking groups under a second condition in which a TdT is used, thereby producing a modified probe set having reversible blocking groups on a first plurality of the annealed capture probes and second blocking groups on a second plurality of the annealed capture probes, wherein the first polymerase extension condition has higher extension fidelity than the second polymerase extension condition.

One or more nucleotides that are added to deblocked probes in a method of the invention can include a secondary label such that one or more extension products that are produced in the method will include at least one nucleotide comprising the secondary label. In such embodiments, the method can further include a step of isolating the plurality of different extension products via the secondary label using methods set forth elsewhere herein. In particular embodiments, the extension product can be isolated prior to attaching the different extension products to an array. In this way original template strands and other components from replication steps can be removed, for example by washing, to increase the purity of the extension product library that is attached to the array.

Another useful method for increasing the purity of a library of extension products that is to be attached to an array or otherwise evaluated is to incorporate a nucleotide analog that is resistant to nuclease activity. For example, nucleotide analogs having thio-linkages in place of the hydroxyl-linkages that are found in native nucleotides are resistant to digestion by nucleases. A reaction product mixture having a native template and thio-containing replicate can be treated with a nuclease to remove the template strand leaving an isolated replicate for subsequent manipulation and analysis. Alternatively or additionally, a template strand can include exogenous bases such as uracil, 8-hydroxyguanine, or bases other than adenine, cytosine, thymine and guanine. Selective degradation of the templates due to the presence of the exogenous bases will also render the replicated strands purified for subsequent use. For example, templates containing uracil can be cleaved by uracil DNA glycosylase (UDG) which removes the uracil base, followed by heating or chemical methods which cleave the abasic site. Similarly, templates having 8-hydroxyguanine can be cleaved by 8-hydroxyguanine DNA glycosylase (FPG protein). Other exemplary exogenous bases and methods for their degradation that can be used are described in US 2005/0181394, which is incorporated herein by reference.

In particular embodiments the products of a hybridization-extension capture method can be circularized using methods set forth herein to produce a plurality of different circularized nucleic acid molecules. The circularized molecules can be replicated, for example, by rolling circle amplification, compacted to form DNA balls, attached to one or more solid-phase surfaces, and/or detected using methods set forth herein. In particular embodiments the circularized products are sequenced or evaluated for polymorphisms, for example, in a genotyping detection method.

The genomic DNA sample used in a hybridization extension enrichment method can be provided in any of a variety of states as set forth herein. For example, the gDNA can be a native genome, fragmented genome or amplified product of a native genome. In embodiments that use fragments of gDNA or amplicons thereof the species can be linear or circularized.

Whole genome amplification or labeling can be used to transform a nucleic acid sample into a library with universal priming sites suitable for polony or cluster amplification and sequencing. This can be accomplished by utilizing a bipartite random primer in which the 5′ bases contain two concatenated universal priming sequencing separated by a cleavable base or bases and followed by a 3′ random priming sequence (n=5-16 bases). The cleavable base/bases could be an exogenous bases such as uracil cleavable by an exogenous base cleaving agent such as uracil DNA glycosylase, or could be a restriction enzyme motif cleavable by a restriction enzyme. After the whole genome amplification or random primer amplification/labeling reaction, the product can be circularized by a single stranded or double stranded ligation reaction. For single stranded ligation, the product can be denatured and then circularized with a single stranded ligase such as CircLigase. For double stranded ligation, single stranded endonucleases such as mung bean nuclease or S1 nuclease can be used to create blunt-ended products as substrates for double stranded DNA ligases (i.e. T4 DNA ligase, E. coli DNA ligase, etc.). The DNA is titrated in the ligation reaction to favor intramolecular circular ligation rather than intermolecular ligation. After circularization, the product is linearized by digesting the cleavable base/bases. The linearized library can be size-selected by standard methods such as gel analysis, HPLC, capillary electrophoresis, or the like. After size selection, the library can be amplified with a limited number of PCR cycles or directly used in a polony/cluster-mediated sequencing reaction.

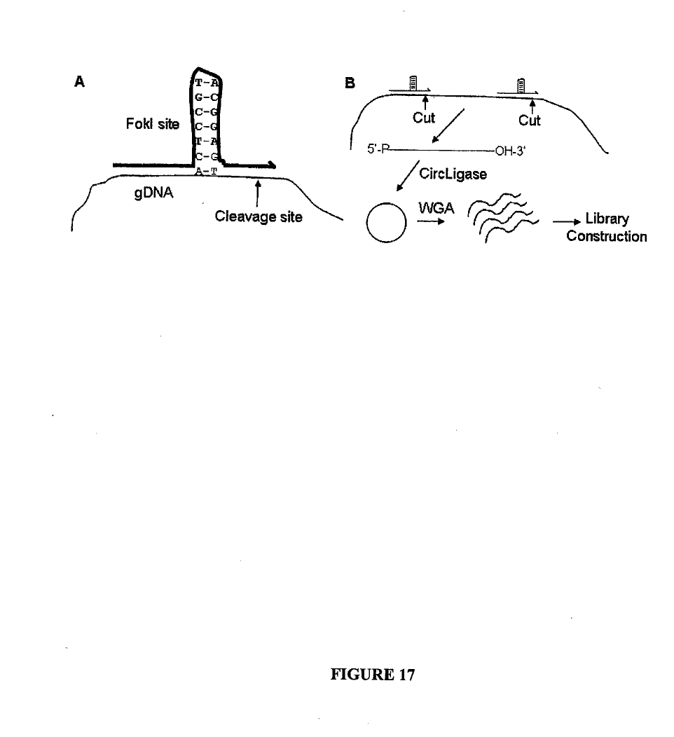

The generation of targeted restriction sites using engineered locus-specific oligos w/hairpins containing a typeIIS (or type III) restriction site can also be used to select for targeted sequences. Site-directed cleavage reagents can be constructed by incorporation of TypeIIS restriction enzyme sites into locus-specific oligonucleotides (see FIG. 17) (Szybalski, Gene 40:169-173 (1985); Kim et al., Science 240:504-506 (1988); Kim et al., J. Mol. Biol. 258:638-649 (1996); Podhajska and. Szybalski, Gene 40:175-182 (1985), each of which is incorporated herein by reference). In the example shown, a FokI site is engineered into a hairpin region of a locus-specific oligonucleotide. Two such locus-specific oligonucleotides positioned within a few hundred bases of each other allow the region to be selectively excised and amplified. A single stranded DNA ligase such as CircLigase™ (Epicentre; Madison Wis.) to circularize the excised elements and Phi29 multiple displacement amplification (whole genome amplification, WGA) can be used to amplify these excised elements once circularized.

Several parameters can be varied to alter the properties of the assay including: (1) different typeIIS enzymes can be used such as FokI, MmeI (approximately 18 base reach), EcoP15I (typeIII) and the like, (2) the position of hairpin internally or at the 5′ end of the oligonucleotide can be altered, (3) length of excised region can be changed, (4) for the size and location of the loop in the hairpin can be varied, (5) the length of the primer sequence can be varied, and the like.

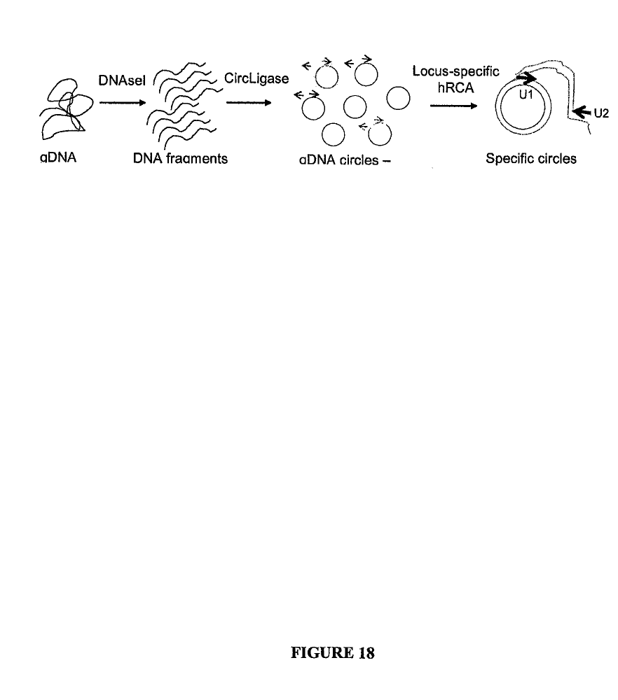

Locus-specific hyperbranched RCA can also be used for targeting nucleic acid sequences (see FIG. 18). Genomic DNA can be fragmented with DNAseI to generate fragments 50-1000 bases long, these fragments can be circularized with a single stranded ligase such as CircLigase™, and then amplified in a locus-specific hyperbranched RCA reaction. Two primers can be designed for each locus, one anneals directly to the locus-circle of interest, and the other primer is complementary to the RCA product being displaced from the circle. The combination of these two primers generates exponential amplification of the desired locus. Primer-primer interactions aren't an issue as in PCR since only circularized targets generate exponential amplification. There is no exponential amplification of primer-dimer artifacts. To further limit any ectopic interactions, the hRCA reaction can be performed in an emulsion as described above.

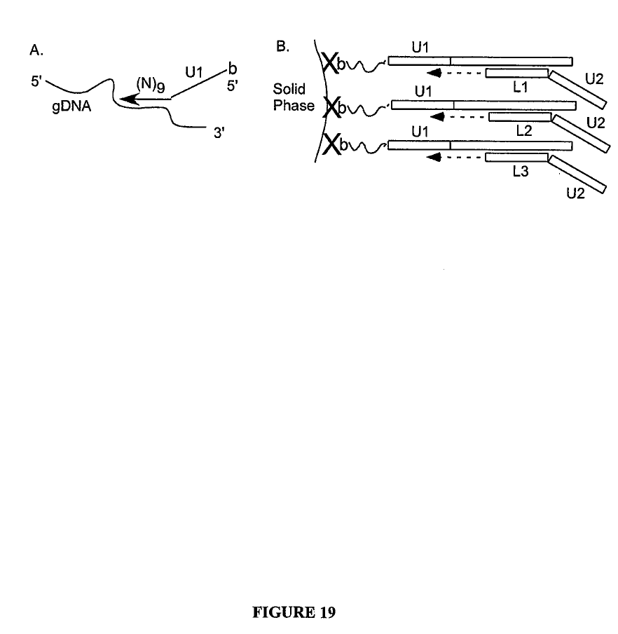

Random-locus-specific primer amplification can also be used for targeting nucleic acid sequences. For example, two-step process including random primer amplification followed by specific priming can be used. This can be accomplished by utilizing random-primed labeling (RPL) of genomic DNA to both amplify the DNA and add a universal primer sequence with a capturable moiety, such as biotin, to the ends of the DNA fragments (see FIG. 19). The labeled RPL product can be captured on a solid-phase surface and stringently hybridized with locus-specific primers containing a second universal primer sequence. Excess primers can then be washed away. A primer extension reaction can be used to extend the 2nd set of primers through the site of the 1st universal primer. This product can be eluted off the solid-phase surface and spiked into a universal PCR reaction employing two universal primers, U1 and U2 as shown in FIG. 16.

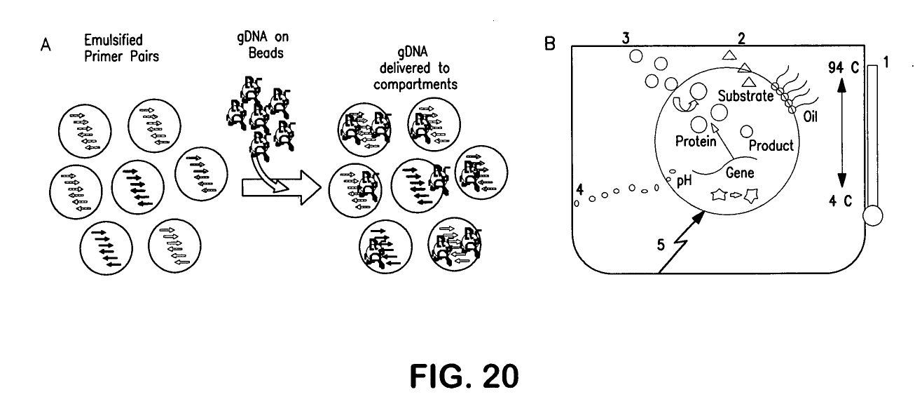

Multiplex emulsion PCR can also be used for targeting nucleic acid sequences. Single-plex PCR is relatively robust and reliable. Unfortunately, the ability to multiplex PCR is limited by primer-primer interactions which grow as the second power of the multiplex level. In general, most successful multiplex PCR reactions are kept under 100-plex, and even under 25-plex. To circumvent primer-primer interactions, primer pairs are separated into individual compartments in an emulsion PCR reaction (FIG. 20A). In order to accomplish this, each primer set is individually emulsified and then later all the emulsions are mixed together to form one grand master mix. This master emulsion mix can be stored frozen and thawed just before use. The gDNA can be introduced into the aqueous compartments in a number of ways. One method is to capture gDNA on beads and introduce the beads into the emulsion, which distribute into the aqueous compartments. The gDNA on a bead represents many copies of the full genome, allowing every compartment to generate a suitable amplicon. Alternatively to introducing gDNA on beads, gDNA can be bound to quaternary ammonium alkyl compounds and rendered soluble in the organic or oil phase (FIG. 20B). After equilibrium is reached, the DNA will partition into the aqueous compartments.

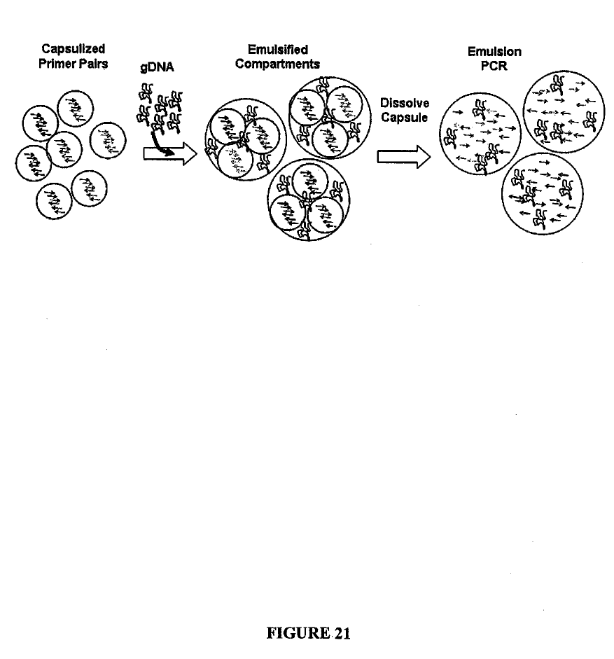

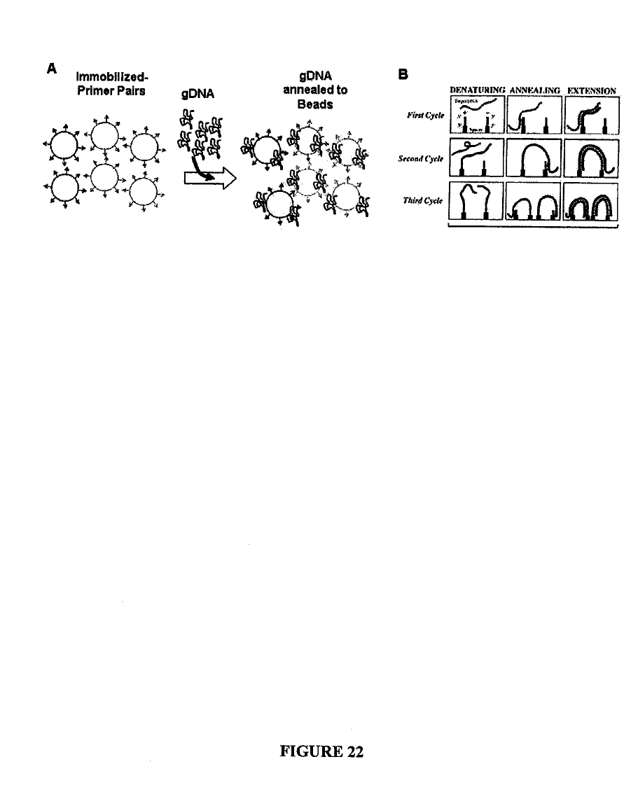

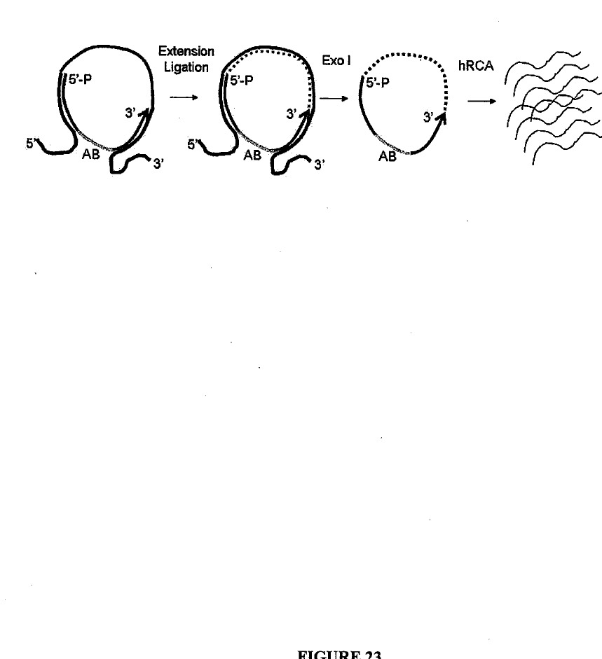

As described above, primer-dimer interactions can prevent large-scale multiplexing in PCR. Another method to eliminate primer-dimer interactions is to physically separate primer pairs on beads or in separate capsules and form an emulsion from these encapsulated primer pairs (see FIG. 21). The encapsulated or immobilized primer pairs are released in the emulsified compartments before the commencement of the PCR reaction. The size of the emulsion compartments and number of encapsulated beads per compartment can be varied to optimize for a particular application. Emulsification limits the number of primer pairs in any one compartment, thereby minimizing primer-dimer artifacts and artifacts due to interactions between different amplicon sequences.

Another method to eliminate primer-dimer interactions is to perform solid-phase PCR using primer pairs physically separated on beads as a multiplex bridge PCR reaction (FIG. 22)(Adams et al., U.S. Pat. No. 5,641,658). Each primer set can be individually co-immobilized and then later all the beads are mixed together to form one grand master mix. This master bead mix can be inoculated into the PCR mix along with all the other PCR components and target DNA. Key parameters in the solid-phase amplification reaction can be varied, including but not limited to linker length between the primer and beads. After amplification, the library elements can be cleaved from the beads and processed as a standard library for generation of clonal arrays.

Another method to target nucleic acid molecules is to use padlock probe amplification. Ligation of padlock probes has been shown to provide highly-specific locus detection. Padlock probes are used to amplify targeted regions in the genome such as exons. The padlock probe can be designed such that its 5′ and 3′ terminal sequences hybridize to regions flanking the “exon”. An extension-ligation step (approximately 150 bases for the average size intron) is used to fill-in the exon gap and ligate the 5′ terminus to the 3′ terminus. The resultant circle can be amplified with RCA, hyperbranched RCA or PCR using the A and B universal priming sequences in the padlock probe, as exemplified in FIG. 23.

Another method for targeting nucleic acid sequences utilizes multiplex libraries targeting large contiguous genomic regions. Whole genome association studies requires follow-up with both fine mapping SNP genotyping and ultimately sequencing a large number of samples in regions surrounding significant SNP markers. Given that the average linkage disequilibrium (LD) of the genome is about 30 kb, this implies that for each significant SNP marker, 30 kb upstream and downstream of the marker will need to be sequenced (approximately 60 kb in total). Furthermore, the association study can return a dozen or more significant SNPs in certain cases. Validation of these SNPs in an orthogonal case-control study can be used to filter out some of the false positives. Nonetheless, a large number of regions and samples can potentially be targets for sequencing.

Multiplex long range PCR can be used in conjunction with emulsion PCR, as described herein. This approach is particularly attractive since primer-interactions are kept to a minimum while supporting standard solution phase PCR. Long range PCR is most successful when amplifying fragments from 5 kb to 10 kb in length. A 60 kb region requires about a dozen primer pairs, and combined with a dozen regions may result in a long range multiplex reaction of 100-200 fold. The method can be optimized to increase to even higher multiplex levels. Ideally, a warehouse of 30,000 oligo pools, each covering approximately 100 kb of contiguous genomic sequence, can be mixed and matched at will to generate customized sequencing assays.

Targeted library generation can also be applied to bisulfite converted gDNA. Bisulfite sequencing is a common method for analysis of the methylation status of CpG sites in the genome. The ability to bisulfite resequence targeted regions of the genome such as CpG islands, promoter regions, and evolutionarily conserved regions is important in understanding methylation and the epigenome. Specific amplification of loci, for example, using PCR, after bisulfite conversion is challenging since the genome is much more repetitive due to the conversion of all C's in the genome to T's except methylated CpG sites. The targeted amplification approach can be performed on bisulfite converted DNA. The methods can be used to show feasibility of targeted amplification from regions of the bisulfite genome.

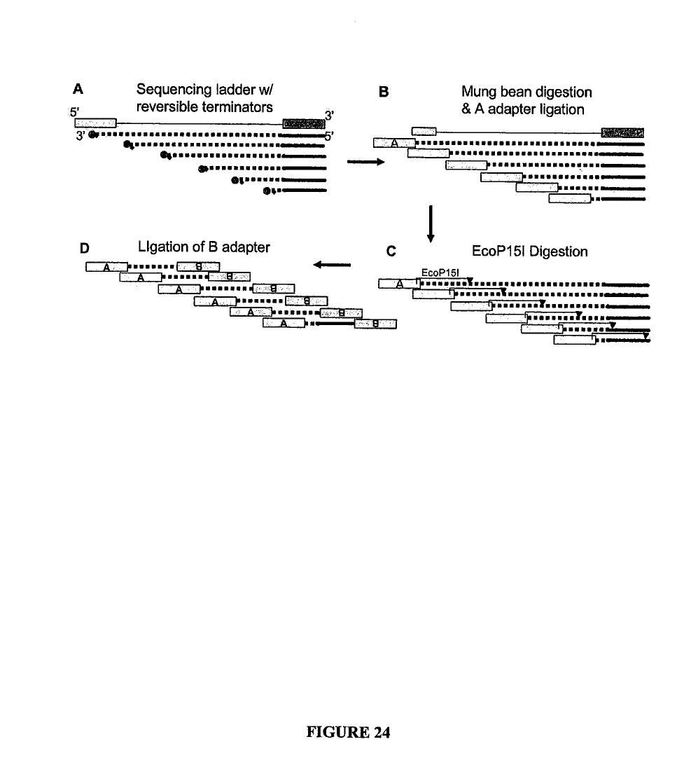

Many of the described approaches to targeted amplification generate products with inserts greater than 150 bases. Current cyclic reversible terminator (CRT) sequencing approaches achieve read lengths of 25-50 bases. There exists a mismatch between the insert size of the generated library and the ability to read the entire distance. This can in part be circumvented by sequencing from both ends of the insert using the universal flanking primers. Nonetheless, in some cases long range PCR may be used to generate inserts of 5-10 kb in size. A method to convert these longer insert containing targeted libraries into libraries with smaller average insert size would benefit CRT approaches. As disclosed herein, “mini-libraries” can be generated by creating a ladder of fragment lengths using a “Sanger”-like sequencing reaction except that the terminators are replaced with reversible terminators. After creation of the sequencing ladder, the termination is reversed, and a universal adapter is ligated onto the 3′ end. This allows creation of a “mini-library” with uniform sequence representation throughout the length of the original library element (see FIG. 24). If desired, the mini-libraries can be formatted for paired end reads by circularizing the elements before cleavage with EcoP15I.

Additionally, “in situ” array-based methods of creating large oligonucleotide pools can be used. For a fixed set of targeted oligos such as for a 250,000 exon library, a large number of oligonucleotides can be synthesized. However, this is not cost-effective unless the cost of the oligo pool can be amortized over the entire amount of oligos generated in the synthesis run. To be more economically feasible for analysis of small sample sets, large numbers of oligos are generated in relatively small quantities and cost effectively. One approach is to synthesize oligos en masse on arrays, cleave the oligos from the array, and amplify using an enzymatic technique such as PCR or hRCA (Tian et al., Nature 432:1050-1054 (2004)). Oligo pools can be synthesized in sets of approximately 4000 oligos per pool. Locus-specific sequence will be flanked by universal priming sites with built-in TypeIIS restriction sites. After PCR or hRCA amplification, the 3′ terminus of the locus-specific sequences are exposed by cleavage with a typeIIS or typeIII enzyme.

As used herein, a “nucleoside” refers to a nucleic acid component that comprises a base or basic group, for example, comprising at least one homocyclic ring, at least one heterocyclic ring, at least one aryl group, and/or the like, covalently linked to a sugar moiety such as a ribose sugar, a derivative of a sugar moiety, or a functional equivalent of a sugar moiety, for example, an analog, such as carbocyclic ring. For example, when a nucleoside includes a sugar moiety, the base is typically linked to a 1′-position of that sugar moiety. A base can be naturally occurring, for example, a purine base, such as adenine (A) or guanine (G), a pyrimidine base, such as thymine (T), cytosine (C), or uracil (U)), or can be non-naturally occurring, for example, a 7-deazapurine base, a pyrazolo[3,4-d]pyrimidine base, a propynyl-dN base, or other analogs or derivatives as disclosed herein or are well known in the art. Exemplary nucleo sides include ribonucleosides, deoxyribonucleosides, dideoxyribonucleosides, carbocyclic nucleosides, and the like. Other examples of nucleotides include those having analog structures set forth herein in regard to oligonucleotide primers.

A “nucleotide” refers to an ester of a nucleoside, for example, a phosphate ester of a nucleoside. For example, a nucleotide can include 1, 2, 3, or more phosphate groups covalently linked to a 5′ position of a sugar moiety of the nucleoside. As used herein, an “extendible nucleotide” refers to a nucleotide to which at least one other nucleotide can be added or covalently bonded, for example, in a reaction catalyzed by a nucleotide incorporating catalyst once the extendible nucleotide is incorporated into a nucleotide polymer. Examples of extendible nucleotides include deoxyribonucleotides and ribonucleotides. An extendible nucleotide is typically extended by adding another nucleotide at a 3′-hydroxyl position of the sugar moiety of the extendible nucleotide. A nucleotide can be a triphosphate form (NTP) such as a deoxyribonucleotide triphosphate (dNTP), dideoxyribonucleotide triphosphate (ddNTP) or ribonucleotide triphosphate (rNTP). Other examples of nucleotides include those having analog structures set forth herein in regard to oligonucleotide primers.

In general, an amplification method used in the invention can be carried out using at least one primer nucleic acid that hybridizes to a template nucleic acid to form a hybridization complex, nucleoside triphosphates (NTPs such as rNTPs or dNTPs) and a polymerase which modifies the primer by reacting the NTPs with the 3′ hydroxyl of the primer, thereby replicating at least a portion of the template. For example, PCR based methods generally utilize a DNA template, two primers, dNTPs and a DNA polymerase. A primer or NTP used in an amplification method can have a reversible blocking group on a 2′, 3′ or 4′ hydroxyl, a peptide linked label or a combination thereof. Other amplification methods that can benefit from use of such a primer or NTP include those set forth elsewhere herein, for example, in the context of preparing templates for sequencing and other analytical methods.

A primer used in a method of the invention can have any of a variety of compositions or sizes, so long as it has the ability to hybridize to a template nucleic acid with sequence specificity and can participate in replication of the template. For example, a primer can be a nucleic acid having a native structure or an analog thereof. A nucleic acid with a native structure generally has a backbone containing phosphodiester bonds and can be, for example, deoxyribonucleic acid or ribonucleic acid. An analog structure can have an alternate backbone including, without limitation, phosphoramide (see, for example, Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 91986)), phosphorothioate (see, for example, Mag et al., Nucleic Acids Res. 19:1437 (1991); and U.S. Pat. No. 5,644,048), phosphorodithioate (see, for example, Briu et al., J. Am. Chem. Soc. 11 1:2321 (1989), O-methylphosphoroamidite linkages (see, for example, Eckstein, Oligonucleotides and Analogues: A Practical Approach, Oxford University Press), and peptide nucleic acid backbones and linkages (see, for example, Egholm, J. Am. Chem. Soc. 114:1895 (1992); Meier et al., Chem. Int. Ed. Engl. 31:1008 (1992); Nielsen, Nature, 365:566 (1993); Carlsson et al., Nature 380:207 (1996)). Other analog structures include those with positive backbones (see, for example, Denpcy et al., Proc. Natl. Acad. Sci. USA 92:6097 (1995); non-ionic backbones (see, for example, U.S. Pat. Nos. 5,386,023, 5,637,684, 5,602,240, 5,216,141 and 4,469,863; Kiedrowshi et al., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including, for example, those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Analog structures containing one or more carbocyclic sugars are also useful in the methods and are described, for example, in Jenkins et al., Chem. Soc. Rev. (1995) pp 169-176. Several other analog structures that are useful in the invention are described in Rawls, C & E News Jun. 2, 1997 page 35. The aforementioned analog structures can be included in a nucleoside or nucleotide that is further modified to include a reversible blocking group on a 2′, 3′ or 4′ hydroxyl, a peptide linked label, or a combination thereof.

A further example of a nucleic acid with an analog structure that is useful in the invention is a peptide nucleic acid (PNA). The backbone of a PNA is substantially non-ionic under neutral conditions, in contrast to the highly charged phosphodiester backbone of naturally occurring nucleic acids. This provides two non-limiting advantages. First, the PNA backbone exhibits improved hybridization kinetics. Secondly, PNAs have larger changes in the melting temperature (Tm) for mismatched versus perfectly matched basepairs. DNA and RNA typically exhibit a 2-4° C. drop in Tm for an internal mismatch. With the non-ionic PNA backbone, the drop is closer to 7-9° C. This can provide for better sequence discrimination. Similarly, due to their non-ionic nature, hybridization of the bases attached to these backbones is relatively insensitive to salt concentration. A PNA or monomer unit used to synthesize PNA can include a base having a peptide linked label. In such cases, an enzyme used to cleave the peptide linker will generally be unreactive toward the PNA backbone.

A nucleic acid useful in the invention can contain a non-natural sugar moiety in the backbone. Exemplary sugar modifications include but are not limited to 2′ modifications such as addition of halogen, alkyl, substituted alkyl, SH, SCH₃, OCN, Cl, Br, CN, CF₃, OCF₃, SO₂CH₃, OSO₂, SO₃, CH₃, ONO₂, NO₂, N₃, NH₂, substituted silyl, and the like. Similar modifications can also be made at other positions on the sugar, particularly the 3′ position of the sugar on the 3′ terminal nucleotide or in 2′-5′ linked oligonucleotides and the 5′ position of 5′ terminal nucleotide. Nucleic acids, nucleoside analogs or nucleotide analogs having sugar modifications can be further modified to include a reversible blocking group, peptide linked label or both. In those embodiments where the above-described 2′ modifications are present, the base can have a peptide linked label.

A nucleic acid used in the invention can also include native or non-native bases. In this regard a native deoxyribonucleic acid can have one or more bases selected from the group consisting of adenine, thymine, cytosine or guanine and a ribonucleic acid can have one or more bases selected from the group consisting of uracil, adenine, cytosine or guanine. Exemplary non-native bases that can be included in a nucleic acid, whether having a native backbone or analog structure, include, without limitation, inosine, xathanine, hypoxathanine, isocytosine, isoguanine, 5-methylcytosine, 5-hydroxymethyl cytosine, 2-aminoadenine, 6-methyl adenine, 6-methyl guanine, 2-propyl guanine, 2-propyl adenine, 2-thioLiracil, 2-thiothymine, 2-thiocytosine, 15-halouracil, 15-halocytosine, 5-propynyl uracil, 5-propynyl cytosine, 6-azo uracil, 6-azo cytosine, 6-azo thymine, 5-uracil, 4-thiouracil, 8-halo adenine or guanine, 8-amino adenine or guanine, 8-thiol adenine or guanine, 8-thioalkyl adenine or guanine, 8-hydroxyl adenine or guanine, 5-halo substituted uracil or cytosine, 7-methylguanine, 7-methyladenine, 8-azaguanine, 8-azaadenine, 7-deazaguanine, 7-deazaadenine, 3-deazaguanine, 3-deazaadenine or the like. A particular embodiment can utilize isocytosine and isoguanine in a nucleic acid in order to reduce non-specific hybridization, as generally described in U.S. Pat. No. 5,681,702.

A non-native base used in a nucleic acid of the invention can have universal base pairing activity, wherein it is capable of base pairing with any other naturally occurring base. Exemplary bases having universal base pairing activity include 3-nitropyrrole and 5-nitroindole. Other bases that can be used include those that have base pairing activity with a subset of the naturally occurring bases such as inosine, which basepairs with cytosine, adenine or uracil. Non-native bases can be modified to include a peptide linked label. The peptide can be attached to the base using methods exemplified herein with regard to native bases. Those skilled in the art will know or be able to determine appropriate methods for attaching peptides based on the reactivities of these bases. Alternatively or additionally, oligonucleotides, nucleotides or nucleosides including the above-described non-native bases can further include reversible blocking groups on the 2′, 3′ or 4′ hydroxyl of the sugar moiety.

A nucleic acid having a modified or analog structure can be used, for example, to facilitate the addition of labels, analytical detection or to increase the stability or half-life of the molecule under amplification conditions or other conditions used in accordance with the invention. As will be appreciated by those skilled in the art, one or more of the above-described nucleic acids, nucleosides or nucleotides can be used for example, as a mixture including molecules with native or analog structures. In addition, a nucleic acid primer used in the invention can have a structure desired for a particular amplification technique or analytical method used in the invention, as desired. Exemplary analytical methods and amplification methods that can benefit from the nucleic acids, nucleosides or nucleotides of the invention are set forth below.

Nucleic acid sequencing has become an important technology with widespread applications, including mutation detection, whole genome sequencing, exon sequencing, mRNA or cDNA sequencing, alternate transcript profiling, rare variant detection, and clone counting, including digital gene expression (transcript counting) and rare variant detection. As disclosed herein, various amplification methods can be employed to generate larger quantities, particularly of limited nucleic acid samples, prior to sequencing. For example, the amplification methods can produce a targeted library of amplicons. The amplicons whether or not they are targeted amplicons can be in the form of DNA balls.

Two useful approaches for high throughput or rapid sequencing are sequencing by synthesis (SBS) and sequencing by ligation. Target nucleic acid of interest can be amplified, for example, using ePCR, as used by 454 Lifesciences (Branford, Conn.) and Roche Diagnostics (Basel, Switzerland). Nucleic acid such as genomic DNA or others of interest can be fragmented, dispersed in water/oil emulsions and diluted such that a single nucleic acid fragment is separated from others in an emulsion droplet. A bead, for example, containing multiple copies of a primer, can be used and amplification carried out such that each emulsion droplet serves as a reaction vessel for amplifying multiple copies of a single nucleic acid fragment. Other methods can be used, such as bridging PCR (Solexa), or polony amplification (Agencourt/Applied Biosystems).

For sequencing by ligation, labeled nucleic acid fragments are hybridized and identified to determine the sequence of a target nucleic acid molecule. For sequencing by synthesis (SBS), labeled nucleotides are used to determine the sequence of a target nucleic acid molecule. An SBS approach is shown schematically in FIG. 5A. A target nucleic acid molecule is hybridized with a primer and incubated in the presence of a polymerase and a labeled nucleotide containing a blocking group. The primer is extended such that the nucleotide is incorporated. The presence of the blocking group permits only one round of incorporation, that is, the incorporation of a single nucleotide. The presence of the label permits identification of the incorporated nucleotide. Either single bases can be added or, alternatively, all four bases can be added simultaneously, particularly when each base is associated with a distinguishable label. After identifying the incorporated nucleotide by its corresponding label, both the label and the blocking group can be removed, thereby allowing a subsequent round of incorporation and identification. Thus, it is desirable to have conveniently cleavable linkers linking the label to the base, such as those disclosed herein, in particular peptide linkers. Additionally, it is advantageous to use a removable blocking group so that multiple rounds of identification can be performed, thereby permitting identification of at least a portion of the target nucleic acid sequence. The compositions and methods disclosed herein are particularly useful for such an SBS approach. In addition, the compositions and methods can be particularly useful for sequencing from an array, where multiple sequences can be “read” simultaneously from multiple positions on the array since each nucleotide at each position can be identified based on its identifiable label.

The oligonucleotides, nucleosides and nucleotides described herein can be particularly useful for nucleotide sequence characterization or sequence analysis. Reversible labeling, reversible termination or a combination thereof can allow accurate sequencing analysis to be efficiently performed. Methods for manual or automated sequencing are well known in the art and include, but are not limited to, Sanger sequencing, pyrosequencing, sequencing by hybridization, sequencing by ligation and the like. Sequencing methods can be preformed manually or using automated methods. Furthermore, the amplification methods set forth herein can be used to prepare nucleic acids for sequencing using commercially available methods such as automated Sanger sequencing (available from Applied Biosystems, Foster City Calif.) or pyrosequencing (available from 454 Lifesciences, Branford, Conn. and Roche Diagnostics, Basel, Switzerland); for sequencing by synthesis methods currently being developed by Solexa (Hayward, Calif.) or Helicos (Cambridge, Mass.) or sequencing by ligation methods being developed by Applied Biosystems in its Agencourt platform (see also Ronaghi et al., Science 281:363 (1998); Dressman et al., Proc. Natl. Acad. Sci. USA 100:8817-8822 (2003); Mitra et al., Proc. Natl. Acad. Sci. USA 100:55926-5931 (2003)).

A population of nucleic acids, such as DNA balls or other amplicons set forth herein, can be sequenced using methods in which a primer is hybridized to each nucleic acid such that the nucleic acids form templates and modification of the primer occurs in a template directed fashion. The modification can be detected to determine the sequence of the template. For example, the primers can be modified by extension using a polymerase and extension of the primers can be monitored under conditions that allow the identity and location of particular nucleotides to be determined. For example, extension can be monitored and sequence of the template nucleic acids determined using pyrosequencing which is described in further detail below, in US 2005/0130173; US 2006/0134633; U.S. Pat. No. 4,971,903; U.S. Pat. No. 6,258,568 and U.S. Pat. No. 6,210,891, each of which is incorporated herein by reference, and is also commercially available, see above. Extension can also be monitored according to addition of labeled nucleotide analogs by a polymerase, using methods described, for example, elsewhere herein and in U.S. Pat. No. 4,863,849; U.S. Pat. No. 5,302,509; U.S. Pat. No. 5,763,594; U.S. Pat. No. 5,798,210; U.S. Pat. No. 6,001,566; U.S. Pat. No. 6,664,079; US 2005/0037398; and U.S. Pat. No. 7,057,026, each of which is incorporated herein by reference. Polymerases useful in sequencing methods are typically polymerase enzymes derived from natural sources. It will be understood that polymerases can be modified to alter their specificity for modified nucleotides as described, for example, in WO/01/23411; U.S. Pat. No. 5,939,292; and WO 05/024010, each of which is incorporated herein by reference. Furthermore, polymerases need not be derived from biological systems. Polymerases that are useful in the invention include any agent capable of catalyzing extension of a nucleic acid primer in a manner directed by the sequence of a template to which the primer is hybridized. Typically polymerases will be protein enzymes isolated from biological systems.

A further modification of primers that can be used to determine the sequence of templates to which they are hybridized is ligation. Such methods are referred to as sequencing by ligation and are described, for example, in Shendure et al. Science 309:1728-1732 (2005); U.S. Pat. No. 5,599,675; and U.S. Pat. No. 5,750,341, each of which is incorporated herein by reference. It will be understood that primers need not be modified in order to determine the sequence of the template to which they are attached. For example, sequences of template nucleic acids can be determined using methods of sequencing by hybridization such as those described in U.S. Pat. No. 6,090,549; U.S. Pat. No. 6,401,267 and U.S. Pat. No. 6,620,584. It is understood that many of the uses of compositions of the present invention can be applied to both sequencing by synthesis (SBS) or single base extension (SBE), discussed in more detail below), since both utilize extension reactions that can incorporate a composition of the invention, including nucleotides with cleavable peptide linkers and/or blocking groups, either removable or not.

A DNA ball or other amplicons produced using methods set forth herein can be used in an extension assay. Extension assays are useful for detection of alleles, mutations or other nucleic acid features in an amplicon of interest. Extension assays are generally carried out by modifying the 3′ end of a first nucleic acid when hybridized to a second nucleic acid such as a DNA ball or other amplicon. The amplicon can act as a template directing the type of modification, for example, by base pairing interactions that occur during polymerase-based extension of the first nucleic acid to incorporate one or more nucleotide. Polymerase extension assays are particularly useful, for example, due to the relative high-fidelity of polymerases and their relative ease of implementation. Extension assays can be carried out to modify nucleic acid probes that have free 3′ ends, for example, when bound to a substrate such as an array. Exemplary approaches that can be used include, for example, allele-specific primer extension (ASPE), single base extension (SBE), or pyrosequencing and are described, for example, in US 2005/0181394, which is incorporated herein by reference. A nucleic acid, nucleotide or nucleoside having a reversible blocking group on a 2′, 3′ or 4′ hydroxyl, a peptide linked label or a combination thereof can be used in such methods. For example the nucleic acid, nucleotide or nucleoside can be included in the first nucleic acid or the second nucleic acid. Additionally or alternatively, the nucleic acid, nucleotide or nucleoside can be used to modify the free 3′ ends in the extension reactions.

In particular embodiments, single base extension (SBE) can be used for detection of a typable locus such as an allele, mutations or other nucleic acid features. The compositions of the present invention are useful in an SBE method, in particular, a nucleoside or nucleotide containing a peptide linker, allowing cleavage and removal of a label, and/or terminator blocking group, either removable or non-removable. Briefly, SBE utilizes an extension probe that hybridizes to a target genome fragment at a location that is proximal or adjacent to a detection position, the detection position being indicative of a particular typable locus. A polymerase can be used to extend the 3′ end of the probe with a nucleotide analog labeled with a detection label such as those described previously herein. Based on the fidelity of the enzyme, a nucleotide is only incorporated into the extension probe if it is complementary to the detection position in the target nucleic acid. If desired, the nucleotide can be derivatized such that no further extensions can occur, as disclosed herein using a blocking group, including reversible blocking groups, and thus only a single nucleotide is added. The presence of the labeled nucleotide in the extended probe can be detected for example, at a particular location in an array and the added nucleotide identified to determine the identity of the typable locus. SBE can be carried out under known conditions such as those described in U.S. patent application Ser. No. 09/425,633. A labeled nucleotide can be detected using methods such as those set forth above or described elsewhere such as Syvanen et al., Genomics 8:684-692 (1990); Syvanen et al., Human Mutation 3:172-179 (1994); U.S. Pat. Nos. 5,846,710 and 5,888,819; Pastinen et al., Genomics Res. 7(6):606-614 (1997).

ASPE is an extension assay that utilizes extension probes that differ in nucleotide composition at their 3′ end. An ASPE method can be performed using a nucleoside or nucleotide containing a cleavable linker, so that a label can be removed after a probe is detected. This allows further use of the probes or verification that the signal detected was due to the label that has now been removed. Briefly, ASPE can be carried out by hybridizing a sample nucleic acid, or amplicons derived therefrom, to an extension probe having a 3′ sequence portion that is complementary to a detection position and a 5′ portion that is complementary to a sequence that is adjacent to the detection position. Template directed modification of the 3′ portion of the probe, for example, by addition of a labeled nucleotide by a polymerase yields a labeled extension product, but only if the template includes the target sequence. The presence of such a labeled primer-extension product can then be detected, for example, based on its location in an array to indicate the presence of a particular allele.

In particular embodiments, ASPE can be carried out with multiple extension probes that have similar 5′ ends such that they anneal adjacent to the same detection position in a target nucleic acid but different 3′ ends, such that only probes having a 3′ end that complements the detection position are modified by a polymerase. A probe having a 3′ terminal base that is complementary to a particular detection position is referred to as a perfect match (PM) probe for the position, whereas probes that have a 3′ terminal mismatch base and are not capable of being extended in an ASPE reaction are mismatch (MM) probes for the position. The presence of the labeled nucleotide in the PM probe can be detected and the 3′ sequence of the probe determined to identify a particular allele at the detection position.

A sequence or allele present in an amplicon, such as a DNA ball. can be detected using a ligation assay such as oligonucleotide ligation amplification (OLA). Detection with OLA involves the template-dependent ligation of two smaller probes into a single long probe, using a target sequence in an amplicon as the template. In a particular embodiment, a single-stranded target sequence includes a first target domain and a second target domain, which are adjacent and contiguous. A first OLA probe and a second OLA probe can be hybridized to complementary sequences of the respective target domains. The two OLA probes are then covalently attached to each other to form a modified probe. In embodiments where the probes hybridize directly adjacent to each other, covalent linkage can occur via a ligase. One or both probes can include a nucleoside having a label such as a peptide linked label. Accordingly, the presence of the ligated product can be determined by detecting the label. In particular embodiments, the ligation probes can include priming sites configured to allow amplification of the ligated probe product using primers that hybridize to the priming sites, for example, in a PCR reaction.

Alternatively, the ligation probes can be used in an extension-ligation assay wherein hybridized probes are non-contiguous and one or more nucleotides are added along with one or more agents that join the probes via the added nucleotides. Furthermore, a ligation assay or extension-ligation assay can be carried out with a single padlock probe instead of two separate ligation probes. The ends of the padlock probe are designed to complement adjacent or proximal sequence regions in an amplicon or other template such that ligation or extension followed by ligation results in a circularized padlock probe. The probe can be amplified by rolling circle amplification. Exemplary conditions for ligation assays or extension-ligation assays using separate probes or ligation probes are described, for example, in U.S. Pat. No. 6,355,431 B1 and US 2003/0211489, each of which is incorporated herein by reference.

A ligation probe such as a padlock probe used in the invention can further include other features such as an adaptor sequence, restriction site for cleaving concatamers, a label sequence or a priming site for priming an amplification reaction as described, for example, in U.S. Pat. No. 6,355,431 B1.

In particular embodiments a nucleic acid, nucleoside or nucleotide useful in the invention can include a label. In particular embodiments, the label can be attached via a peptide linker. As used herein, a “label” refers to one or more atoms that can be specifically detected to indicate the presence of a substance to which the one or more atoms is attached. A label can be a primary label that is directly detectable or secondary label that can be indirectly detected, for example, via direct or indirect interaction with a primary label. Exemplary primary labels include, without limitation, an isotopic label such as a naturally non-abundant radioactive or heavy isotope, including but not limited to ¹⁴C, ¹²³I, ¹²⁴I, ¹²⁵I, ¹³¹I, ³²P, ³⁵S, and ³H; chromophore; luminophore; fluorophore; calorimetric agent; magnetic substance; electron-rich material such as a metal; electrochemiluminescent label such as Ru(bpy)32+; or moiety that can be detected based on a nuclear magnetic, paramagnetic, electrical, charge to mass, or thermal characteristic. Fluorophores that are useful in the invention include, for example, fluorescent lanthanide complexes, including those of Europium and Terbium, fluorescein, rhodamine, tetramethylrhodamine, eosin, erythrosin, coumarin, methyl-coumarins, pyrene, Malacite green, Cy3, Cy5, stilbene, Lucifer Yellow, Cascade Blue™, Texas Red, alexa dyes, phycoerythin, bodipy, and others known in the art such as those described in Haugland, Molecular Probes Handbook, (Eugene, Oreg.) 6th Edition; The Synthegen catalog (Houston, Tex.), Lakowicz, Principles of Fluorescence Spectroscopy, 2nd Ed., Plenum Press New York (1999), or WO 98/59066. Labels can also include enzymes such as horseradish peroxidase or alkaline phosphatase or particles such as magnetic particles or optically encoded nanoparticles.

Exemplary secondary labels are binding moieties. A binding moiety can be attached to a nucleic acid to allow detection or isolation of the nucleic acid via specific affinity for a receptor. Specific affinity between two binding partners is understood to mean preferential binding of one partner to another compared to binding of the partner to other components or contaminants in the system. Binding partners that are specifically bound typically remain bound under the detection or separation conditions described herein, including wash steps to remove non-specific binding. Depending upon the particular binding conditions used, the dissociation constants of the pair can be, for example, less than about 10⁻⁴, 10⁻⁵, 10⁻⁶, 10⁻⁸, 10⁻⁹, 10⁻¹⁰, 10⁻¹¹, or 10⁻¹² M⁻¹.

Exemplary pairs of binding moieties and receptors that can be used as labels in the invention include, without limitation, antigen and immunoglobulin or active fragments thereof, such as FAbs; immunoglobulin and immunoglobulin (or active fragments, respectively); avidin and biotin, or analogs thereof having specificity for avidin such as imino-biotin; streptavidin and biotin, or analogs thereof having specificity for streptavidin such as imino-biotin; carbohydrates and lectins; and other known proteins and their ligands. It will be understood that either partner in the above-described pairs can be attached to a nucleic acid and detected or isolated based on binding to the respective partner. It will be further understood that several moieties that can be attached to a nucleic acid can function as both primary and secondary labels in a method of the invention. For example, strepatvidin-phycoerythrin can be detected as a primary label due to fluorescence from the phycoerythrin moiety or it can be detected as a secondary label due to its affinity for anti-streptavidin antibodies, as set forth in further detail below in regard to signal amplification methods. The binding pairs set forth above can also be used to attach amplicons such as DNA balls to an array or to otherwise select for an amplicon of interest.

In a particular embodiment, the secondary label can be a chemically modifiable moiety. In this embodiment, labels having reactive functional groups can be incorporated into a nucleic acid, nucleoside or nucleotide. The functional group can be subsequently covalently reacted with a primary label. Suitable functional groups include, but are not limited to, amino groups, carboxy groups, maleimide groups, oxo groups and thiol groups.

As disclosed herein, a variety of fluorescent dyes are particularly useful labels in compositions and methods of the invention, including, but not limited to, FAM, Bodipy, TAMRA, Alexa, and the like. These and other suitable fluorescent moieties are well known to those skilled in the art (see Hermanson, Bioconjugate Techniques, pp. 297-364, Academic Press, San Diego (1996); Molecular Probes, Eugene Oreg.). Rhodamine derivatives include, for example, tetramethylrhodamine, rhodamine B, rhodamine 6G, sulforhodamine B, Texas Red (sulforhodamine 101), rhodamine 110, and derivatives thereof such as tetramethylrhodamine-5-(or 6), lissamine rhodamine B, and the like. Other suitable fluorophores include 7-nitrobenz-2-oxa-1,3-diazole (NBD).

Additional exemplary fluorophores include, for example, fluorescein and derivatives thereof. Other fluorophores include napthalenes such as dansyl (5-dimethylaminonapthalene-1-sulfonyl). Additional fluorophores include coumarin derivatives such as 7-amino-4-methylcoumarin-3-acetic acid (AMCA), 7-diethylamino-3-[(4′-(iodoacetyl)amino)phenyl]-4-methylcoumarin (DCIA), Alexa fluor dyes (Molecular Probes), and the like.

Other fluorophores include 4,4-difluoro-4-bora-3a,4a-diaza-s-indacene (BODIPY™) and derivatives thereof (Molecular Probes; Eugene Oreg.). Further fluorophores include pyrenes and sulfonated pyrenes such as Cascade Blue™ and derivatives thereof, including 8-methoxypyrene-1,3,6-trisulfonic acid, and the like. Additional fluorophores include pyridyloxazole derivatives and dapoxyl derivatives (Molecular Probes). Additional fluorophores include Lucifer Yellow (3,6-disulfonate-4-amino-naphthalimide) and derivatives thereof. CyDye™ fluorescent dyes (Amersham Pharmacia Biotech; Piscataway N.J.) can also be used. Energy transfer dyes can additionally be used such as those described in U.S. Pat. No. 7,015,000 or U.S. Pat. No. 6,573,047, each of which is incorporated herein by reference.

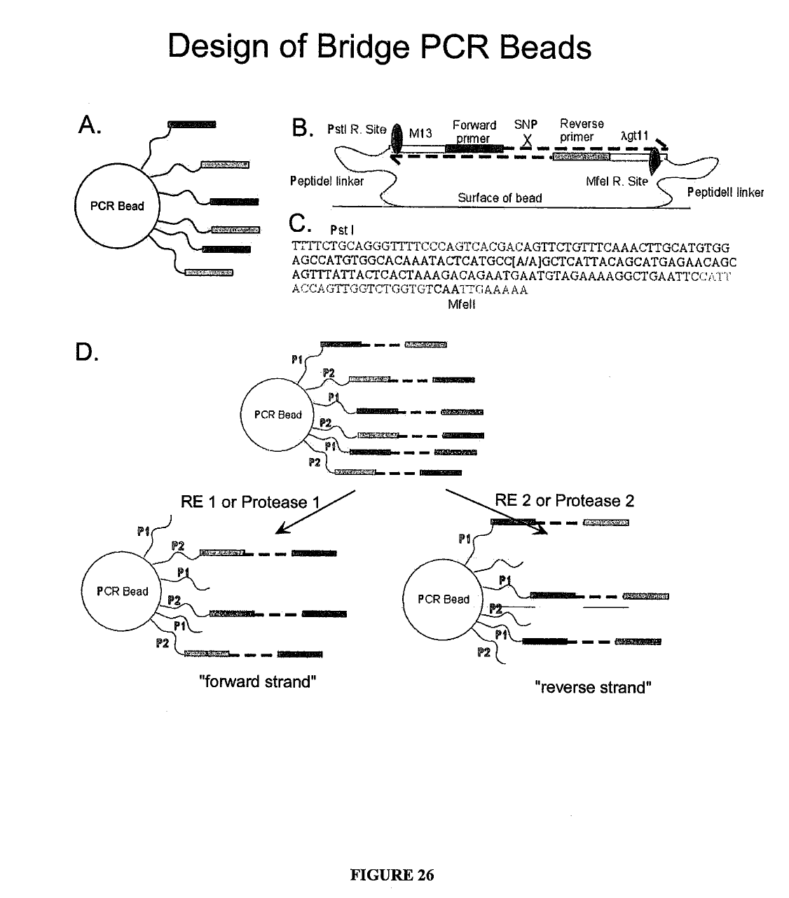

As disclosed herein, a nucleotide having a protease cleavable linker can be used, for example, to allow selective cleavage and removal from a solid support (see Example III and FIG. 26). As used herein, the term “protease” is intended to mean an agent that catalyzes the cleavage of peptide bonds in a protein or peptide. Some proteases are non-sequence specific proteases. Generally, for the methods disclosed herein, the protease has sequence specificity, splitting a peptide bond of a protein based on the presence of a particular amino acid sequence in the protein. A protease can be characterized according to the location in a protein where it cleaves, an endoprotease cleaving a protein between internal amino acids of an amino acid chain and an exoprotease cleaving a protein to remove an amino acid from the end of an amino acid chain. In the peptide linkers of the compositions herein, an endoprotease is used. A protease can be characterized according to mechanism of action, being identified, for example, as a serine protease, cysteine (thiol) protease, aspartic (acid) protease, metalloprotease or mixed protease depending on the principal amino acid participating in catalysis. A protease can also be classified based on the action pattern, examples of which include an aminopeptidase which cleaves an amino acid from the amino end of a protein, carboxypeptidase which cleaves an amino acid from the carboxyl end of a protein, dipeptidyl peptidase which cleaves two amino acids from an end of a protein, dipeptidase which splits a dipeptide and tripeptidase which cleaves an amino acid from a tripeptide. Typically, a protease is a protein enzyme. However, non-protein agents capable of catalyzing the cleavage of peptide bonds in a protein, especially in a sequence specific manner are also useful in the invention.

As used herein, the term “activity,” when used in reference to a protease, is intended to mean binding of the protease to a protease substrate or hydrolysis of the protease substrate or both. The activity can be indicated, for example, as binding specificity, catalytic activity or a combination thereof. The activity of a protease can be identified qualitatively or quantitatively in accordance with the compositions and methods disclosed herein. Exemplary qualitative measures of protease activity include, without limitation, identification of a substrate cleaved in the presence of the protease, identification of a change in substrate cleavage due to presence of another agent such as an inhibitor or activator, identification of an amino acid sequence that is recognized by the protease, identification of the composition of a substrate recognized by the protease or identification of the composition of a proteolytic product produced by the protease. Activity can be quantitatively expressed as units per milligram of enzyme (specific activity) or as molecules of substrate transformed per minute per molecule of enzyme (molecular activity). The conventional unit of enzyme activity is the International Unit (IU), equal to one micromole of substrate transformed per minute. A proposed coherent Systeme Internationale (SI) unit is the katal (kat), equal to one mole of substrate transformed per second.

As used herein the term, “protease substrate” is intended to mean a molecule that can be cleaved by a protease. A protease substrate is typically a protein, protein moiety or peptide having an amino acid sequence that is recognized by a protease. A protease can recognize the amino acid sequence of a protease substrate due to the specific sequence of side chains or due to properties generic to proteins. A protease substrate can also be a protein mimetic or non-protein molecule that is capable of being cleaved or otherwise covalently modified by a protease.

Exemplary proteases, corresponding peptide substrates and commercial source are shown in Table 1.

TABLE 1
Proteases and their cleavage preferences.

| | Peptide (cleavage site | |
|---|---|---|
| Protease | indicated with dash) | Company |
| Thrombin | LVPR-GS | Amersham, Novagen, |
| | | Sigma, Roche |
| Factor Xa | IEGR-X | Amersham, NEB, Roche |
| Enterokinase | DDDDK-X | NEB, Novagen, Roche |
| TEV protease | ENLYFQ-G | Invitrogen |
| PreScission | LEVLFQ-GP | Amersham |
| HRV 3C Protease | LEVLFQ-GP | Novagen |
| Trypsin | R-X, K-X | |
| Endoproteinase Asp-N | X-D | |
| Chymotrypsin | Y-X, F-X, W-X | |
| Endoproteinase Glu-C | E-X | |
| Endoproteinase Arg-C | R-X | |
| Endoproteinase Lys-C | K-X | |

Protease cleavable linkers used in the invention are generally peptides. Peptide synthesis can be carried out using standard solid phase or solution phase chemistry, as desired. Methods for peptide synthesis are well known to those skilled in the art (Fodor et. al., Science 251:767 (1991); Gallop et al., J. Med. Chem. 37:1233-1251 (1994); Gordon et al., J. Med. Chem. 37:1385-1401 (1994)). It is understood that a peptide linker can be synthesized and then added to the NTP as a peptide or can be synthesized by sequentially adding amino acids and then a dye.

As used herein, the term “solid support” is intended to mean a substrate and includes any material that can serve as a solid or semi-solid foundation for attachment of capture probes, amplicons, DNA balls, other nucleic acids and/or other polymers, including biopolymers. A solid support of the invention is modified, for example, or can be modified to accommodate attachment of nucleic acids by a variety of methods well known to those skilled in the art. Exemplary types of materials comprising solid supports include glass, modified glass, functionalized glass, inorganic glasses, microspheres, including inert and/or magnetic particles, plastics, polysaccharides, nylon, nitrocellulose, ceramics, resins, silica, silica-based materials, carbon, metals, an optical fiber or optical fiber bundles, a variety of polymers other than those exemplified above and multiwell microtier plates. Specific types of exemplary plastics include acrylics, polystyrene, copolymers of styrene and other materials, polypropylene, polyethylene, polybutylene, polyurethanes and Teflon™. Specific types of exemplary silica-based materials include silicon and various forms of modified silicon.

The term “microsphere,” “bead” or “particle” refers to a small discrete particle as a solid support of the invention. Populations of microspheres can be used for attachment of populations of capture probes, amplicons, DNA balls or other nucleic acids. The composition of a microsphere can vary, depending for example, on the format, chemistry and/or method of attachment and/or on the method of nucleic acid synthesis. Exemplary microsphere compositions include solid supports, and chemical functionalities imparted thereto, used in polypeptide, polynucleotide and/or organic moiety synthesis. Such compositions include, for example, plastics, ceramics, glass, polystyrene, melamine, methylstyrene, acrylic polymers, paramagnetic materials, thoria sol, carbon graphite, titanium dioxide, latex or cross-linked dextrans such as Sepharose™, cellulose, nylon, cross-linked micelles and Teflon™, as well as any other materials which can be found described in, for example, “Microsphere Detection Guide” from Bangs Laboratories, Fishers Ind., which is incorporated herein by reference.

The geometry of a particle, bead or microsphere also can correspond to a wide variety of different forms and shapes. For example, microspheres used as solid supports of the invention can be spherical, cylindrical or any other geometrical shape and/or irregularly shaped particles. In addition, microspheres can be, for example, porous, thus increasing the surface area of the microsphere available for capture probe or other nucleic acid attachment. Exemplary sizes for microspheres used as solid supports in the methods and compositions of the invention can range from nanometers to millimeters or from about 10 nm-1 mm. Particularly useful sizes include microspheres from about 0.2 μm to about 200 μm and from about 0.5 μm to about 5 μm being particularly useful.

In particular embodiments, microspheres or beads can be arrayed or otherwise spatially distinguished. Exemplary bead-based arrays that can be used in the invention include, without limitation, those in which beads are associated with a solid support such as those described in U.S. Pat. No. 6,355,431 B1, US 2002/0102578 and PCT Publication No. WO 00/63437, each of which is incorporated herein by reference. Beads can be located at discrete locations, such as wells, on a solid-phase support, whereby each location accommodates a single bead. Alternatively to embodiments wherein the discrete locations are configured to accommodate no more than a single bead, discrete locations where beads reside can each include a plurality of beads as described, for example, in U.S. patent application Nos. US 2004/0263923, US 2004/0233485, US 2004/0132205, or US 2004/0125424, each of which is incorporated herein by reference. Beads can be associated with discrete locations via covalent bonds or other non-covalent interactions such as gravity, magnetism, ionic forces, van der Waals forces, hydrophobicity, receptor-ligand affinity or hydrophilicity. However, the sites of an array of the invention need not be discrete sites. For example, it is possible to use a uniform surface of adhesive or chemical functionalities that allows the attachment of particles at any position. Thus, the surface of an array substrate can be modified to allow attachment or association of microspheres at individual sites, whether or not those sites are contiguous or non-contiguous with other sites. Thus, the surface of a substrate can be modified to form discrete sites such that only a single bead is associated with the site or, alternatively, the surface can be modified such that a plurality of beads populates each site. It will be understood that the configurations exemplified above can be achieved using DNA balls in place of the beads or microspheres.

Beads, DNA balls or other particles can be loaded onto array supports using methods known in the art such as those described, for example, in U.S. Pat. No. 6,355,431, which is incorporated herein by reference. In some embodiments, for example when chemical attachment is done, particles can be attached to a support in a non-random or ordered process. For example, using photoactivatible attachment linkers or photoactivatible adhesives or masks, selected sites on an array support can be sequentially activated for attachment, such that defined populations of particles are laid down at defined positions when exposed to the activated array substrate. Alternatively, particles can be randomly deposited on a substrate. In embodiments where the placement of particles is random, a coding or decoding system can be used to localize and/or identify the probes at each location in the array. This can be done in any of a variety of ways, for example, as described in U.S. Pat. No. 6,355,431 or WO 03/002979, each of which is incorporated herein by reference. A further encoding system that is useful in the invention is the use of diffraction gratings as described, for example, in US Pat. App. Nos. US 2004/0263923, US 2004/0233485, US 2004/0132205, or US 2004/0125424, each of which is incorporated herein by reference.

An array of beads or DNA balls useful in the invention can also be in a fluid format such as a fluid stream of a flow cytometer or similar device. Exemplary formats that can be used in the invention to distinguish beads in a fluid sample using microfluidic devices are described, for example, in U.S. Pat. No. 6,524,793, which is incorporated herein by reference. Commercially available fluid formats for distinguishing beads include, for example, those used in XMAP™ technologies from Luminex or MPSS™ methods from Lynx Therapeutics. It is contemplated that such methods can be used for DNA balls as well.

Any of a variety of arrays known in the art can be used in the present invention. For example, arrays that are useful in the invention can be non-bead-based. A particularly useful array is an Affymetrix™ GeneChip™ array. GeneChip™ arrays can be synthesized in accordance with techniques sometimes referred to as VLSIPS™ (Very Large Scale Immobilized Polymer Synthesis) technologies. Some aspects of VLSIPS™ and other microarray and polymer (including protein) array manufacturing methods and techniques have been described in U.S. patent Ser. No. 09/536,841, International Publication No. WO 00/58516; U.S. Pat. Nos. 5,143,854, 5,242,974, 5,252,743, 5,324,633, 5,445,934, 5,744,305, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846, 6,022,963, 6,083,697, 6,291,183, 6,309,831 and 6,428,752; and in PCT Applications Nos. PCT/US99/00730 (International Publication No. WO 99/36760) and PCT/US01/04285, each of which is incorporated herein by reference. Such arrays can hold over 500,000 probe locations, or features, within a mere 1.28 square centimeters. The resulting probes are typically 25 nucleotides in length. If desired, a highly efficient synthesis in which substantially all of the probes are full length can be used.

A spotted array can also be used in a method of the invention. An exemplary spotted array is a CodeLink™ Array available from Amersham Biosciences CodeLink™ Activated Slides are coated with a long-chain, hydrophilic polymer containing amine-reactive groups. This polymer is covalently crosslinked to itself and to the surface of the slide. Probe attachment can be accomplished through covalent interaction between the amine-modified 5′ end of the oligonucleotide probe and the amine reactive groups present in the polymer. Probes can be attached at discrete locations using spotting pens. Such pens can be used to create features having a spot diameter of, for example, about 140-160 microns. In a particular embodiment, nucleic acid probes at each spotted feature can be 30 nucleotides long.

Another array that is useful in the invention is one manufactured using inkjet printing methods such as SurePrint™ Technology available from Agilent Technologies. Such methods can be used to synthesize oligonucleotide probes in situ or to attach presynthesized probes having moieties that are reactive with a substrate surface. A printed microarray can contain 22,575 features on a surface having standard slide dimensions (about 1 inch by 3 inches). Typically, the printed probes are 25 or 60 nucleotides in length.

It will be understood that the specific synthetic methods and probe lengths described above for different commercially available arrays are merely exemplary. Similar arrays can be made using modifications of the methods and probes having other lengths such as those set forth elsewhere herein can also be placed at each feature of the array.

Those skilled in the art will know or understand that the composition and geometry of a solid support of the invention can vary depending on the intended use and preferences of the user. Therefore, although microspheres and chips are exemplified herein for illustration, given the teachings and guidance provided herein, those skilled in the art will understand that a wide variety of other solid supports exemplified for other embodiments herein or well known in the art also can be used in the methods and/or compositions of the invention. Furthermore, materials and methods used in the manufacture of the arrays set forth above can also be used to produce a patterned substrate to which an amplicon, such as a DNA ball, is attached.

Several of the methods set forth herein can be carried out in a multiplex format in which several different reactions are carried out simultaneously and in the same vessel or on the same substrate. As exemplified above, several methods such as primer extension methods, ligation methods or sequencing methods can be carried out in multiplex formats, for example, using arrays. Methods set forth herein can be carried out at multiplex levels in which at least 10, 100, 1000, 1×10⁴, 1×10⁵, 1×10⁶, 1×10⁷ or more different reactions occur simultaneously in the same vessel or on the same substrate.

The invention additionally provides an array comprising a plurality of amplified sample nucleic acid sequences, that is, an array of clonal nucleic acid “balls.” Such an array can be generated by any of the methods disclosed herein. In a particular embodiment, the amplified sample nucleic acid sequences are targeted nucleic acid sequences. Such targeted nucleic acid sequences can be obtained or targeted using any of the methods disclosed herein.

The invention further provides a kit containing an array of the invention comprising a plurality of amplified sample nucleic acid sequences. If desired, the kit can further comprise reagents for analysis of sequences on the array, in particular, reagents for carrying out a sequencing reaction, including but not limited to desired nucleotides, optionally labeled with a detectable label such as a fluorophore, enzymes such as a polymerase, ligase, or other desired enzymes, appropriate buffers, and the like. The invention additionally provides a kit for generating an array comprising a plurality of amplified nucleic acid sequences. Such a kit can include, for example, a solid support, for example, a support modified for binding of nucleic acids at discrete locations, as disclosed herein, reagents for generating amplified nucleic acid sequences, as disclosed herein, reagents for obtaining targeted nucleic acids, as disclosed herein, appropriate enzymes, labeling agents, buffers, and the like, suitable for generating an array of amplified sample nucleic acid sequences, as disclosed herein. Additional kits are also provided, for example, to perform rolling circle amplification (RCA) using a guide linker to select for full length cDNA. Such a kit can include, for example, suitable buffers and reagents and a description of reaction conditions for generating cDNA with a string of at least 3 C's on the 3′ end of the cDNA from a sample containing one or more mRNAs, as disclosed herein, including, for example, divalent cations such as manganese and magnesium. Additional components of such a kit can include a guide linker containing at least 3 consecutive G's and at least 3 consecutive A's, wherein the G's occur 5′ to the A's. In particular embodiments, the sequence of G's is at the 5′ end of the guide linker and the sequence of A's is at the 3′ end of the guide linker. Such a kit can also include appropriate enzymes, for example, a ligase such as a DNA ligase suitable to generate covalently closed circular cDNA. Additionally, the kit can include a polymerase such as a DNA polymerase and nucleotides to perform the RCA reaction. Such nucleotides can optionally be labeled so as to generate labeled amplified product. The contents of the kit of the invention, for example are contained in packaging material, and, if desired, a sterile, contaminant-free environment. In addition, the packaging material contains instructions indicating how the materials within the kit can be employed. The instructions for use typically include a tangible expression describing the reagent concentration or at least one assay method parameter, such as the relative amounts of reagent and sample to be admixed, maintenance time periods for reagent/sample admixtures, temperature, buffer conditions, and the like.

It is understood that modifications which do not substantially affect the activity of the various embodiments of this invention are also provided within the definition of the invention provided herein. Accordingly, the following examples are intended to illustrate but not limit the present invention.

### EXAMPLE I

### Generation of Clonal DNA Particles (Balls)

This example describes the generation of clonal DNA balls.

Preliminary data was obtained on assembling clonal DNA balls onto a patterned slide substrate. The DNA balls were created by rolling circle amplification (RCA) of synthetic circles generated by CircLigase™-mediated ligation of phosphorylated oligonucleotides. CircLigase™ is a single stranded DNA ligase capable of circular ligation of ssDNA. The DNA strands were condensed into DNA balls by isopropanol precipitation from 2.5 M ammonium acetate solution. A biotin moiety was incorporated into the DNA balls during the RCA step. After precipitation, the DNA balls were resuspended in 1 M 6×SSPE (1M NaCl, 100 mM phosphate buffer, pH 7.5) buffer. A patterned slide was created from a BeadChip™ (Illumina) by assembly of 0.85 μm streptavidin beads into 1 μm wells. The DNA balls were incubated on the surface of the BeadChip™ for 10 minutes and excess balls were washed away. The DNA balls were detected on the array by hybridization of a Cy3-labeled complementary oligo. Only regions of BeadChip™ with loaded streptavidin (SA) beads exhibited detector-oligo dependent signal. Stripes without DNA balls showed no signal in the presence of the detector oligo.

After establishing the ability to create, assemble, hybridize and polymerase extend on DNA balls immobilized on an array, the clonality and singularity of the features were tested by mixing two different DNA circles together in the RCA reaction. The goal was to employ differentially-labeled detector oligos (Cy3 and Cy5) to detect each DNA ball independently. If the DNA balls are clonal and singular on the array (no two balls co-localized), distinct spots of green and red, but no yellow, should be seen. The data show primarily distinct singular clones on the array with an occasional mixed feature. Optimization of feature size and assembly conditions is performed to limit the assembly of multiple DNA balls per feature.

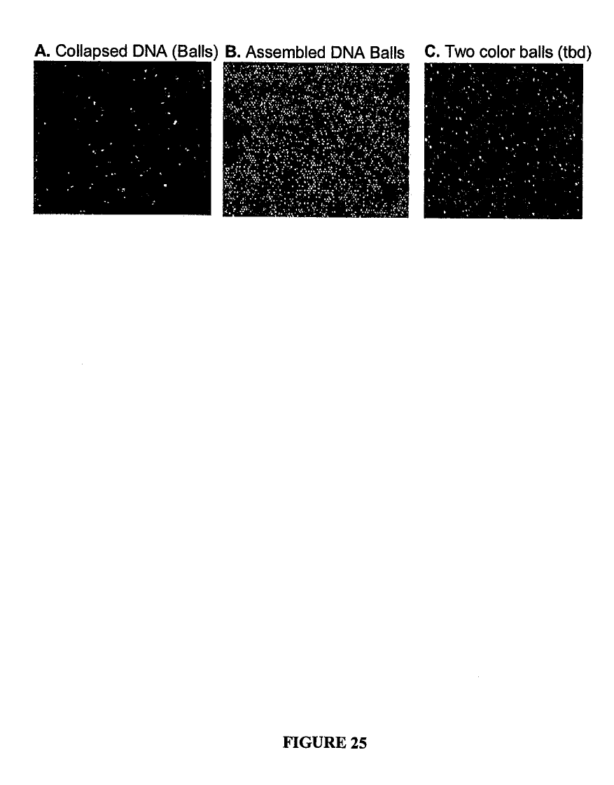

FIG. 25 shows clonal arrays of DNA balls. In FIG. 25A, high molecular weight RCA DNA with hybridized Cy3 detector probes was collapsed to submicron point objects (“balls”) by incubation with 12 mM spermidine in 100 mM HEPES buffer, pH 8.0. Biotin was incorporated into the DNA balls during the RCA step. In FIG. 25B, these biotinylated DNA balls were assembled onto BeadChip™s pre-loaded with streptavidin beads.

### EXAMPLE II

### Generating Type IIS and III gDNA Libraries

This example describes a method for creating a full complexity genomic DNA library using ligation of adapters with built-in TypeIIS or Type III restriction enzyme sites. This can be used for a number of applications including DNA sequencing.

One method for generating gDNA libraries uses digestion with EcoP15I, a type II restriction enzyme, that has the longest “reach” into a nascent sequence ( 25/27 bp). An EcoP15I gDNA library, or similar type IIS and III restriction enzyme library, has the following strengths: (1) the method is relatively insensitive to fragmentation of gDNA by nebulization or DNAseI (since only approximately 26 bp is cut from either end of the fragments, the protocol can tolerate fragment sizes from 50 bp to several thousand bp); (2) the approximately 26 base insert of the library is sufficient for most sequence assembly tasks resulting from sequencing of the library; (3) the method is compatible with short sequence reads generated by array-based highly-parallel sequencing; (4) the method does not affect sequence throughput since shorter sequence reads can be mitigated by reading more beads.

A schematic outline of one embodiment of the method of generating type IIS and type III gDNA libraries is shown in FIG. 15A. In step 1, gDNA is fragmented using nebulization or DNAseI. The use of Mn²⁺ leads to blunt end fragments. A particularly useful fragment size is from about 50 bp to about 1000 bp. The fragments can be end-polished to create blunt ends with T4 DNA polymerase if needed.

In step 2 as depicted in FIG. 15A, a blunt-end “A” adapter containing a TypeIIS or TypeIII restriction enzyme (RE) site is ligated to the digested product. An example of such a restriction enzyme is EcoP15I, which has a 25/27 bp nascent cleavage profile. The blunt-end adapter can be designed to directionally ligate by including an incompatible overhang at the non-ligatable terminus. The adapters can be ligated with or without phosphorylation. If not phosphorylated, a polymerase “run-off” extension reaction is performed after the ligation step to remove the nick. A 5′ biotin or other affinity label can be included in the adapter for subsequent purification.

In step 3 as depicted in FIG. 15A, the fragments with ligated adaptors are digested with TypeIIS/TypeIII RE, such as EcoP15I. The fragments are digested to completion, and such conditions can be optimized. In step 4, the digested products are captured on affinity beads. For example, if the affinity ligand is biotin, the fragments can be captured on streptavidin (SA) beads. In step 5, a second adaptor “B” is ligated, where the “B” adapter is compatible for ligation with the overhang generated by the TypeIIS/TypeIII RE. Alternatively, overhang can be polished to create blunt ends and ligated to a blunt-end B adapter. If desired, captured product can be dephosphorylated to eliminate ligation between products immobilized to the same bead. Phosphorylated adapters are used to ligate to the fragments. A polymerase “run-off” extension can be performed after ligation to remove nicks. TA cloning can also be used for ligating the adapters.

In step 6 depicted in FIG. 15A, the ssDNA gDNA library product is eluted from the beads. For example, ssDNA can be eluted from streptavidin beads using heat or denaturants such as alkaline conditions (0.1-0.2 N NaOH). The ssDNA product can be quantified before use, for example, in a subsequent emulsion PCR reaction.

### EXAMPLE III

### Targeted Amplification and Sequencing

This example describes methods for targeted amplification and sequencing of the resultant amplified library. It has particular relevance for highly-parallel sequencing methodologies.

One method for targeting nucleic acid sequences utilizes whole genome targeted representation. A universal biotinylated primer is incorporated using random primer amplification (RPA) (see FIG. 19). FIG. 19 shows creation of a locus-specific reduced representation. FIG. 19A shows random-primed labeling (RPL) of gDNA. gDNA is labeled using a standard RPL protocol employing random N-mers (N=6-18) with universal priming tail (U1 sequence or A) and biotin label. FIG. 19B shows locus-specific primer extension on immobilized RPL product. The biotinylated RPL product is immobilized on a streptavidin solid-phase surface, and locus-specific primers (L1, L2, L3, etc) containing a second universal tail (U2 or B), for example, on the 5′ end, are annealed to the product. A washing step is performed to remove mis-annealed and excess primers. Primer extension is used to extend the annealed primers through the U1 primer site, creating a product with two universal tails that can be amplified by universal PCR. After extension, the product is eluted and spiked into a universal PCR reaction containing U1 and U2 primers. The eluted extended product can be amplified by PCR or emulsion PCR and subsequently sequenced.

A second method for targeting nucleic acid sequences utilizes solid-phase bridge PCR (see FIG. 26). Briefly, locus-specific upstream and downstream PCR primers containing concatenated universal sequences are immobilized on beads. gDNA or cDNA is hybridized, for example, overnight recommended. The beads are washed, and PCR amplification is performed. One universal primer or the other universal primer is cleaved to allow sequencing of either strand. This cleavage can be affected with peptides targeted by specific proteases or restriction enzyme sites (see FIG. 26). Rolling circle amplification is performed on the product on the beads and then sequenced.

In more detail, FIG. 26 shows design of solid phase bridge PCR beads. In FIG. 26A, two locus-specific PCR primers containing concatenated universal priming sequences are immobilized on “PCR” beads. A cleavable linker is created using a peptide cleaved by a specific protease or by using restriction enzymes. In FIG. 26B, after an initial overnight hybridization of gDNA target to the PCR beads, the beads are washed and undergo a solid-phase PCR reaction as shown. FIG. 26C shows sequences used for the test system. Restriction enzyme sites for PstI and MfeI were incorporated into the upstream and downstream primers, respectively. As shown in FIG. 26D, the beads can be treated with a cleaving reagent that allows either strand to be retained on the bead or released into solution. Cleavage with restriction enzyme 1 (RE1) or protease I leaves one strand attached to the bead, and cleavage with restriction enzyme 2 (RE2) or protease 2 leaves the opposite strand attached to the bead. This process allows sequencing of either strand.

Another method for targeting nucleic acid sequences utilizes Type IIS restriction enzyme targeted digestion. Briefly, oligonucleotides are engineered with a hairpin TypeIIS recognition site. A cleavage oligonucleotide is designed upstream and downstream of a locus of interest. Cleavage oligos are annealed to denatured target. The target nucleic acids are cleaved with Fok1. Oligo adapters are annealed to ssDNA with RNA ligase.

Site-directed restriction enzyme digestion using a type IIS restriction enzyme such as FokI can be used. An oligonucleotide is designed with a Fok1 hairpin motif inserted in target-specific sequence. As a type IIS restriction enzyme, it cleaves outside its recognition site as shown. In certain cases, methylation-sensitive type IIS restriction enzymes, such as HgaI, EciI, BceAI, BtgZI, and the like, can be employed in conjunction with Sss1 methylase methylation of target DNA to prevent digestion of target DNA at native restriction sites. Only sites annealed with a locus-specific oligonucleotide will be digested. Two site-directed cleavage oligos can be created to excise a locus of interest (see FIG. 17).

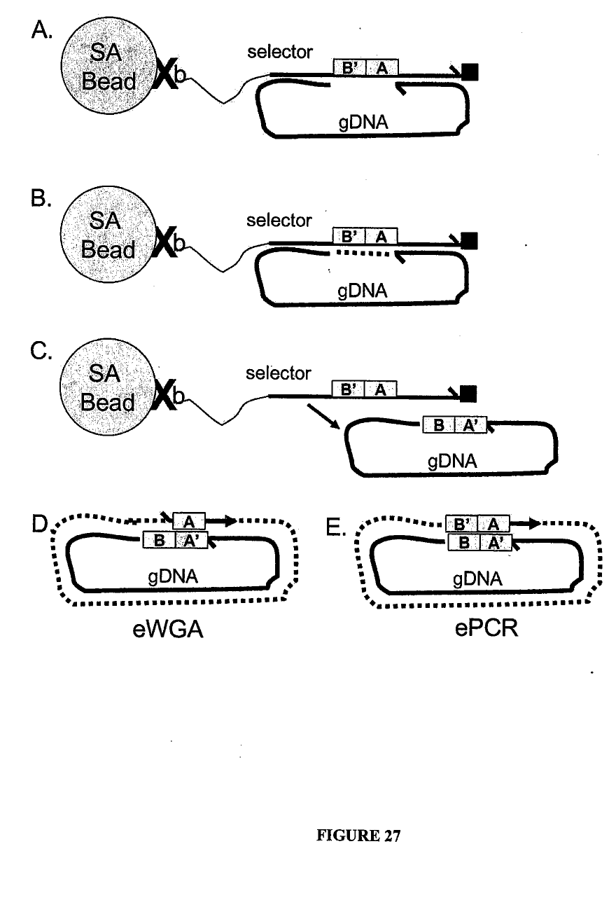

Another method of targeting nucleic acids utilizes selector probes. The design of the selector probes is flexible and enables selection of defined lengths of targeted loci, for example about 150 bases for exon resequencing. Briefly, gDNA is fragmented or random primer amplification (RPA) is used to generate a size consistent with selector probe binding sites. The fragmented products are annealed to selector probes (see FIG. 27A). Selector probes can be in solution or attached to a solid-phase. Selector probes are captured on streptavidin (SA) beads. The captured probes and annealed fragments are treated with a single-stranded nuclease. The target nucleic acids are extended and ligated to form circles (FIG. 27B). The circularized target is eluted from the beads (FIG. 27C). The samples are treated with exonuclease I to remove non-circular DNA. The product is amplified by emulsion whole genome amplification (WGA), which preferentially amplifies circles, using random primers or A and B primers. Alternatively, products are amplified by emulsion PCR with A and B primers (FIG. 27D). The product is sequenced on the beads.

Another method to target nucleic acid sequences utilizes solid-phase amplification and direct sequencing on beads. The method can be used to create sequencing templates. For the method, two locus specific primers are used. Locus specific PCR primer 1 and locus specific PCR primer 2 define a region in the genome or other sample nucleic acids that is desired for amplification. These two primers hybridize to opposite strands at the 5′ and 3′ ends of the region that is desired to be amplified. The primers are designed in a similar way as the design of PCR primers.

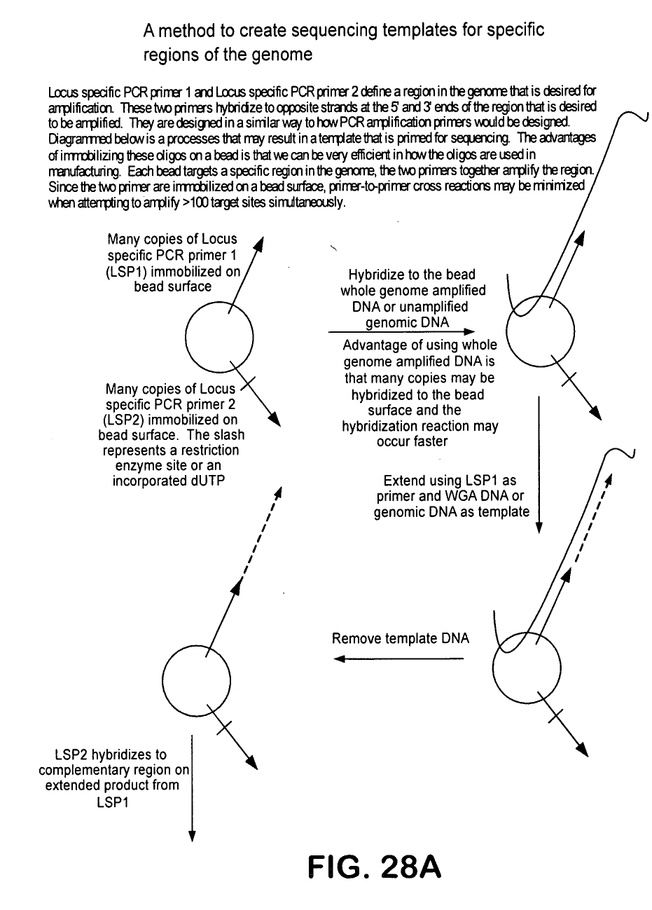

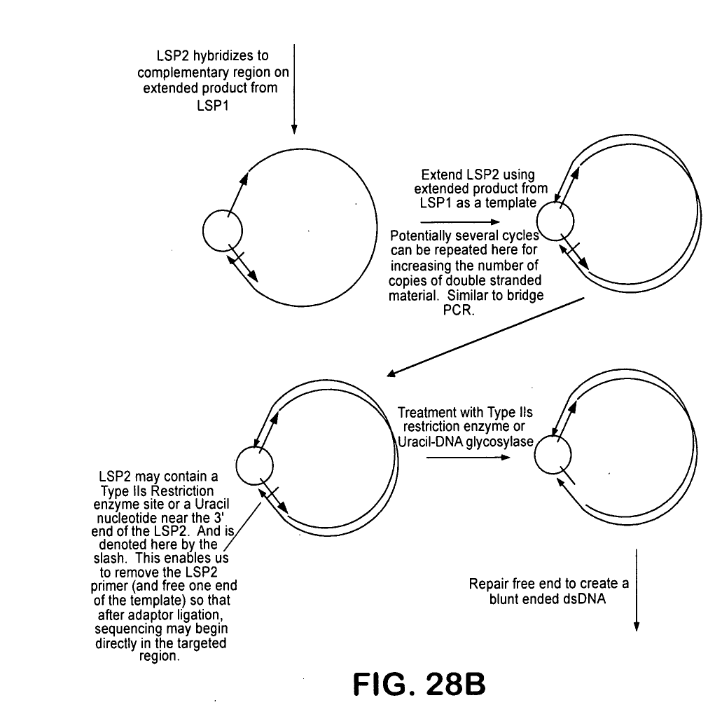

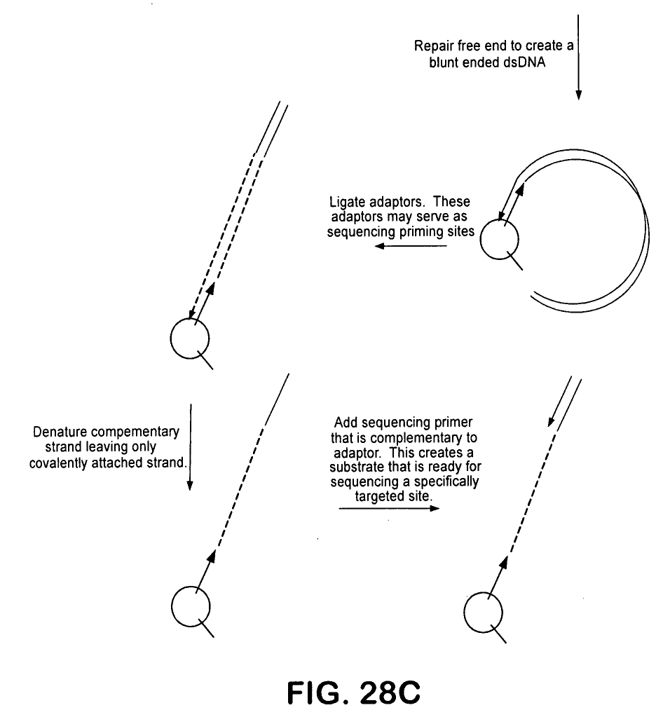

FIG. 28 is a schematic showing the generation of a template primed for sequencing. The advantages of immobilizing the oligonucleotide primers on a bead is that it allows efficient use of the oligonucleotides, conserving costs on oligonucleotide primer synthesis, which is particularly useful when a large number of targeted sequences are desired to be sequenced, requiring large numbers of oligonucleotide primers. As shown in FIG. 28, many copies of locus specific primer 1 (LSP1) and locus specific primer 2 (LSP2) are immobilized on a bead surface. The slash on LSP2 (green) represents a restriction enzyme site or an incorporated dUTP. The beads are hybridized with the sample nucleic acids containing the target of the LSP1 and LSP2 primers, which can be amplified or unamplified. An advantage of using whole genome amplified DNA is that many copies can be hybridized to the bead surface and the hybridization reaction can occur faster. An extension reaction is carried out using LSP1 as the primer and the target nucleic acid is amplified using WGA with the hybridized nucleic acid molecule as template. The template nucleic acid is then removed.

The LSP2 primer hybridizes to a complementary region on the product extended from LSP1. LSP2 is used as a primer to generate a complementary sequence extended using the LSP1 extended product as a template. Potentially, several cycles can be repeated to increase the number of copies of double stranded material, similar to bridge PCR. LSP2 is designed to contain a cleavage site, for example, a Type IIS restriction enzyme site or a uracil nucleotide near the 3′ end of the LSP2 (denoted by slash in FIG. 28). This allows removal of the LSP2 primer, and free one end of the template, so that after ligation, sequencing can be done directly in the targeted region. The beads are treated with a corresponding Type IIS restriction enzyme or uracil-DNA glycosylase. The free end is repaired to generate a blunt ended ssDNA. Adaptors containing sequencing priming sites are ligated onto the free ends. The complementary strands are denatured, leaving only the covalently attached strands. A sequencing primer that is complementary to the adaptor is added. The substrate is then ready for sequencing a specifically targeted site.

### EXAMPLE IV

### cDNA Amplification by Rolling Circle Extension of Guide Linkers

This example describes the use of guide linkers for rolling circle amplification (RCA).

The method is based on performing a splint ligation reaction utilizing a guide linker that takes advantage of the natural occurrence of the poly A tail on the 3′ end of mRNA, transcribed into a poly T string on the 5′ end of cDNA, and the ability of a reverse transcriptase to add a string of three or more C's onto the 3′ end of a reverse transcribed cDNA sequence. A schematic diagram of the procedure is shown in FIG. 30.

Briefly, cDNA is synthesized from a desired mRNA such as a desired mRNA population. cDNA synthesis is carried out under conditions suitable for the addition of at least 3 C's on the 3′ end of the cDNA. Conditions for adding a string of C's to the 3′ end of cDNA are well known, such as those taught by Schmidt et al., Nucl. Acids Res. 27:e31, i-iv (1999), which is incorporated herein by reference (see also Clontech SMART PCR; Clontech, Palo Alto Calif.). In particular, the reverse transcriptase reaction is carried out in the presence of divalent cations that promote the addition of 3 or more C's onto the 3′ end of the cDNA. For example, increasing magnesium concentrations to 6 mM or, more efficiently, using manganese as an additional divalent cation, promoted the addition of 3 or 4 C's (see Schmidt et al., supra, 1999). Particularly useful conditions include, for example, incubation of reverse transcriptase in the presence of about 2 mM MnCl₂, optionally additionally MgCl₂ such as about 2 mM MgCl₂, and optionally additionally a stabilizer such as bovine serum albumin (BSA) (see Schmidt et al., supra, 1999). These and variations on these conditions suitable for sufficient incorporation of 3 or more C's onto the 3′ end of cDNA can be used.

As shown in FIG. 30, a primer complementary to the C's on the 3′ end of the cDNA and the T's on the 5′ end of the cDNA, that is, a primer containing at least 3 G's and at least 3 A's, is used as a guide to circularize the cDNA. The guide linker brings the two ends of each cDNA together due to the poly A tail on the 3′ end of mRNA, which is reversed transcribed into a poly T string on the 5′ end of the cDNA, and the string of 3 or more C's such as 3 or 4 C's added to the 3′ end of the cDNA in an untemplated fashion by reverse transcriptase during the generation of cDNA. The guide linker shown in FIG. 30 has 3 G's and 4 A's as an exemplary guide linker. However, other guide linkers with different numbers of G's or A's within the guide linker, particularly on the respective ends of the guide linker, can also be used, for example, 4 G's and 5 or more A's, and the like. Generally, a guide linker will have at least 3 G's and 3 A's on the 5′ and 3′ ends, respectively.

After the guide linker has been incubated under conditions allowing hybridization to the cDNA, thereby circularizing the cDNA, a splint ligation reaction is carried out using an appropriate ligase such as a double stranded DNA ligase to generate a covalently closed circle of cDNA. An extension reaction is performed such as rolling circle amplification (see, for example, Baner et al., Nucl. Acids Res. 26:5073-5078 (1998)). The extension reaction can be performed, for example, using labeled nucleotides, which are incorporated into the extended product. The extension goes in a rolling circle, and the incorporation of labeled nucleotides results in the incorporation of many labels into each transcript, thereby serving as a linear amplification of signal.

A single cDNA species in a dilution series is amplified to optimize sensitivity and the degree of amplification. Further studies are carried out on cDNAs from a pool of mRNAs. A mixed pool of mRNAs can be hybridized on microarrays to determine repeatability and ability to amplify different transcripts in an unbiased fashion.

The guide linker serves to both select full-length cDNAs from a population and act as a primer for rolling circle amplification. The addition of C's onto the cDNA occurs as the 5′-CAP-dependent addition of generally 3 or 4 non-templated C's to the 3′ end of full length cDNAs by reverse transcriptase, for example, in the presence of manganese. Because the addition of C's on the 3′ end is mRNA CAP dependent, only full length cDNAs that are synthesized through to the 3′ end and therefore through the 5′ CAP of the template mRNA are amplified using the guide linker. Truncated cDNAs resulting from incomplete reverse transcription are generally not amplified. This enriches for full length cDNAs in the amplification step based on the presence of both poly T on the 5′ end and C's on the 3′ end that can bind to the guide linker. The use of RCA that amplifies in a linear fashion can also be advantageous since the amplification results in less distortion of mRNA profiles than exponential amplification techniques such as those using PCR, as described in Eberwine, Biotechniques 20:584-592 (1996)).

### EXAMPLE V

### Solution Phase Hybridization-Extension Enrichment Assay for Targeted Enrichment

This example describes a method for obtaining an enriched pool of amplicons from a whole genome sample.

An enrichment pool of 3072 assay probes was designed to a subset of single nucleotide polymorphisms (SNPs) from Pool 10 of the HumanHap300 product (Illumina, Inc., San Diego, Calif.). Both sense and antisense capture probes, relative to arrayed probes, were designed. A set of mismatch probes was also designed to test specificity.

Annealing assay probes to gDNA in solution and removal of excess probes by filtration over MWCO filters. The pool of assay probes (at 1 nM final concentration per species) were annealed to 500 ng-5 ug of nebulized, heat-denatured gDNA or circularized DNA in 1× hybridization buffer (1 M NaCl; 100 mM potassium phosphate, pH 7.5, 0.1% Tween-20) supplemented with 20% formamide for 1-2 hrs at 48° C. The assay probes were 35-50 bases in length, the gDNA fragments were about 500 to 1000 bases in length, and the circularized DNA was about 300-600 bp in length. After annealing, excess assay probes were removed by spinning at 1000× gravity for 10-15 min. through a molecular weight cut-off filter unit (MWCO=100 k, PALL). The filter was washed once with 50 μl extension buffer (67 mM Tris-HCl (pH 9.1), 16 mM (NH₄)₂SO₄, 3.5 mM MgCl₂, 0.15 mg/ml BSA).

Extension of annealed probes to incorporate biotinylated ddCTP. The annealed product was resuspended in 30 μl extension buffer by shaking at 1000 rpm for 10 min on a Shuttler MTS4 rotary shaker. After resuspension, 30 μl of extension buffer supplemented with KlenThermase polymerase (0.01 U/μl) and 5 PM ddNTPs (biotin-ddCTP, ddATP, ddGTP, and ddTTP) was added to the filter unit and briefly mixed. The reaction was incubated at 48° C. for 30 min. directly in the filter unit.

Removal of excess nucleotides and capture of labeled extension products on streptavidin (SA) beads. The polymerase extension reaction was quenched by addition of 60 μl of 1× hybridization buffer supplemented with 20 mM EDTA. The filter unit was spun down as described above, washed with 50 μl 1× hybridization buffer, and spun down again. The sample was resuspended in 50 μl 1× hybridization buffer by shaking as described above. Binding to magnetic SA beads was accomplished by adding 10 μl washed beads (1% solids, 4500 μmol/mg biotin binding capacity) and shaking for 1 hr. at room temperature.

Washing of solid-phase bound extension products followed by elution of the extension product. After binding, the SA bead solution was transferred to strip tubes and the beads separated from supernatant by magnetization on a magnetic separator. For assays employing the captured gDNA, the SA beads were washed twice in 1× hybridization buffer, once in 0.03× hybridization buffer, and once in 0.03× hybridization buffer at 48° C. for 15 min. The captured gDNA strand was eluted in 0.1 M NaOH.

Detection of eluted extension products on arrays. The eluted extension products were amplified and detected using the standard Infinium™ Whole Genome Genotyping assay (Illumina, Inc., San Diego, Calif.).

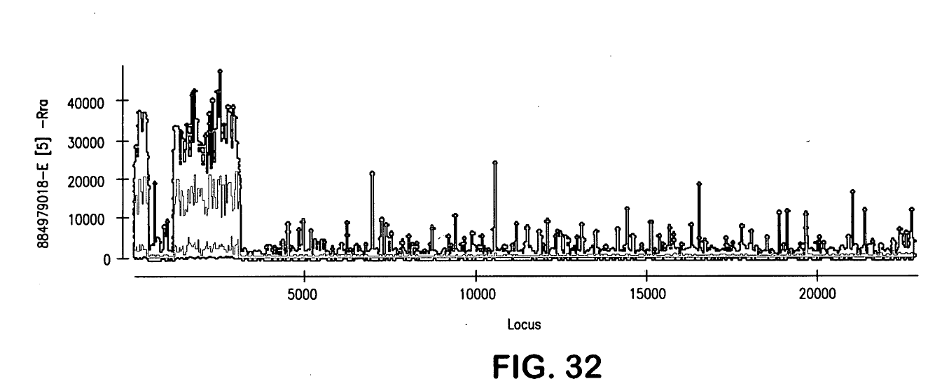

FIG. 32 shows the signal intensities (Y-axis) for individual probes of the Infinium array, each probe identified as a locus on the X-axis. As shown in FIG. 32, the 3072 enriched loci (under the shaded bar) showed greatly increased signal compared to the remainder of 33,000 loci in HumanHap Pool 10. The intensity enrichment factor was at least 50-fold which should translate into a tag sequence enrichment factor of several hundred fold. The low intensity data in the enriched set (darker portion of the shaded bar) is the mismatch probes.

Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

What is claimed is:

1. A method of making an array, comprising
(a) providing a genomic DNA sample comprising a plurality of annealed capture probes having different sequences that are complementary to different target regions of said genomic DNA sample;
(b) sequentially treating said annealed capture probes with nucleotide analogs comprising reversible blocking groups under a first polymerase extension condition and then treating said annealed capture probes with nucleotide analogs comprising second blocking groups under a second condition, thereby producing a modified probe set comprising reversible blocking groups on a first plurality of said annealed capture probes and second blocking groups on a second plurality of said annealed capture probes,
wherein said first polymerase extension condition has higher extension fidelity than said second polymerase extension condition;
(c) removing said reversible blocking groups from said modified probe set and then adding at least one nucleotide to deblocked probes of said modified probe set, thereby forming a plurality of different extension products comprising said target regions; and
(d) attaching said different extension products to an array.

2. The method of claim 1, wherein said target regions attached to said array consist essentially of transcribed genomic regions.

3. The method of claim 1, wherein said target regions attached to said array consist essentially of exons.

4. The method of claim 1, wherein said at least one nucleotide that is added to said deblocked probes comprises a secondary label.

5. The method of claim 4, further comprising a step of isolating said plurality of different extension products via said secondary label prior to attaching said different extension products to said array.

6. The method of claim 1, further comprising circularizing said different extension products to generate a plurality of circularized nucleic acid molecules.

7. The method of claim 6, further comprising amplifying said circularized nucleic acid molecules to generate amplicons, wherein each of said amplicons comprises multiple copies of said extension products.

8. The method of claim 7, wherein said amplicons are compacted prior to attachment to said array.

9. The method of claim 8, wherein said compacted amplicons have an average diameter selected from about 0.1 μm, about 0.2 μm, about 0.5 μm, about 1 μm, 2 μm, about 3 μm, about 4 μm and about 5 μm.

10. The method of claim 9, wherein said amplicons are opened after distribution on said array.

11. A method of sequencing different target regions of a genomic DNA sample comprising making an array according to the method of claim 1 and sequencing one or more of said extension products attached to said array.

12. The method of claim 11, wherein said sequencing comprises a method selected from the group consisting of sequencing by synthesis, sequencing by ligation and sequencing by hybridization.

13. The method of claim 1, wherein said genomic DNA sample comprises an amplified product of genomic DNA comprising an exogenous bases and the method further comprises a step of cleaving said genomic DNA comprising said exogenous bases prior to step (d).

14. The method of claim 1, wherein said at least one nucleotide that is added to said deblocked probes comprises a nuclease resistant nucleotide and the method further comprises a step of cleaving said genomic DNA with said nuclease prior to step (d).

15. The method of claim 1, wherein said second condition comprises treatment with terminal deoxynucleotide transferase to produce said second blocking groups on said second plurality of said annealed capture probes.


SEQUENCE LISTING (7 sequences)

SEQ ID NO: 1 - DNA, 14 bp, Artificial Sequence
  Description of Artificial Sequence Synthetic oligonucleotide
actccgtacggagt

SEQ ID NO: 2 - DNA, 183 bp, Artificial Sequence
  Description of Artificial Sequence Synthetic polynucleotide
ttttctgcagggttttcccagtcacgacagttctgtttcaaacttgcatgtggagccatgtggcacaaatactcatgccagctcattacagcatgagaacagcagtttattactcactaaagacagaatgaatgtagaaaaggctgaattccattaccagttggtctggtgtcaattgaaaaa

SEQ ID NO: 3 - protein, 6 aa, Artificial Sequence
  Description of Artificial Sequence Synthetic consensus sequence
LVPRGS

SEQ ID NO: 4 - protein, 5 aa, Artificial Sequence
  Description of Artificial Sequence Synthetic consensus sequence
IEGRX

SEQ ID NO: 5 - protein, 6 aa, Artificial Sequence
  Description of Artificial Sequence Synthetic consensus sequence
DDDDKX

SEQ ID NO: 6 - protein, 7 aa, Artificial Sequence
  Description of Artificial Sequence Synthetic consensus sequence
ENLYFQG

SEQ ID NO: 7 - protein, 8 aa, Artificial Sequence
  Description of Artificial Sequence Synthetic consensus sequence
LEVLFQGP